(19) United States
(12) Patent Application Publication
(10) Pub. No.: US 2009/0070087 A1
(43) Pub. Date: Mar. 12, 2009

(54) Virtual tissue with emergent behavior and modeling method for producing the tissue

(76) Inventors: Richard D. Newman, Meridian, ID (US); Timothy L. Anderson, Boise, ID (US); Ullysses A. Eoff, Nampa, ID (US); Marc G. Footen, Nampa, ID (US); Timothy Otter, Caldwell, ID (US); Cap Petschulat, Boise, ID (US); Mason E. Vail, Nampa, ID (US); David G. Zuercher, Boise, ID (US)

Correspondence Address: PERKINS COIE LLP, P.O. BOX 1208, SEATTLE, WA, 98111-1208, US

(21) Appl. No.: 11/899,927

(22) Filed: Sep. 7, 2007

(51) Int. Cl. G06G 7/48

(52) U.S. Cl. 703/11

(57) ABSTRACT

A multi-cellular virtual tissue having the emergent properties of self-repair, adaptive response to an altered environment, or tissue differentiation, and a method of generating the tissue by computer modeling are disclosed. The tissue is formed of a plurality of virtual cells, each having a heritable virtual genome containing a set of virtual genes relating to each of (a1) intercellular adhesion, (a2) cell division, (a3) cell growth, (a4) intercellular signaling, and (a5) the state of one cell relative to an adjacent cell. In forming the tissue, the sequential operation and actions of the genes are guided by (1) chemical-interaction rules that govern the extra-genetic behavior of one or more molecules placed or produced in the environment, (2) action rules that specify a cell's adhesion, growth, or cell-division condition, in response to molecules produced by a cell's genes relating to intercellular adhesion, cell growth, or cell division, respectively, and (3) physical-interaction rules that govern how a cell will move in response to its own growth or division or the growth or division of neighboring cells.

The U.S. Government has a paid-up license in this invention and the right in limited circumstances to require the patent owner to license others on reasonable terms as provided for by the terms of Contract DAMD17-02-2-0049 as awarded by the US Army Medical Research Acquisition Activity (USAMRAA).

### FIELD OF THE INVENTION

The present invention relates to tissue modeling methods and virtual tissue produced thereby, where the tissue preferably includes integral stem cell features.

### REFERENCES

Alberts, B., A. Johnson, J. Lewis, M. Raff, K. Roberts, and P. Walter (2002). Molecular Biology of the Cell, Fourth Edition, pp 1027-1125. Garland Science, New York.
Andersen, T., Newman, R., and Otter, T. (2006). “Development of virtual embryos with emergent self-repair.” Technical Report FS-06-03, Proceedings of the AAAI Fall 2006 Symposium on Developmental Systems (pp. 16-23), Arlington, Va.
Barnhart, R. (1986). Hammond Barnhart Dictionary of Science, Barnhart Books, New York.
Brenner, S. (1999). Theoretical biology in the third millennium. Phil. Trans. R. Soc. Lond. B, 354, 1963-1965.
Eggenberger Hotz, P. (2003). “Combining developmental processes and heir physics in an artificial evolutionary system to evolve shapes” In On Growth, Form and Computers. S. Kumar and P. Bentley, eds. Elsevier Academic Press, London.
Hales, T. C. (2005). A proof of the Kepler conjecture. Annals of Mathematics, 162, 1063-1183.
Harris, A. K. (1987). Cell motility and the problem of anatomical homeostasis. J. Cell Sci. Suppl., 8, 121-140.
Kumar, S. and P. J. Bentley (2003). Computational Embryology: Past, Present and Future, In Ghosh and Tsutsui, eds, Advances in Evolutionary Computation: Theory and Applications (pp. 461-478). New York, N.Y.: Springer.
Morowitz, H (2002). The Emergence of Everything. Oxford Univ. Press, Oxford UK. 209 pp.
Stanley, K. O., and Miikkulainen, R. (2003). A taxonomy for artificial embryogeny. Artificial Life, 9, 93-130.
Steels, L. (1994) The artificial life roots of artificial intelligence. Artificial Life I, (no. 1, 2):75-110.

### BACKGROUND OF THE INVENTION

In vivo and in vitro biological research methods are indispensable for understanding the response of biological systems to various experimental conditions or challenges such as cell growth conditions, stress, or exposure to drugs. However, the complexity of biological systems obstructs interpretation from experimental results of particular biological pathways or mechanisms. In vitro studies may help in resolving experimental results from in vivo studies, but only by removing biological response from an in vivo context.

In silico simulation of biological systems has the potential to keep subject processes and structures within a reasonably complete and detailed context, but still allow a researcher to target data of specific interest and origin. That is, in silico simulation allows dissection without separation. When used as a complementary and adjunct tool, in silico simulation can immediately make in vitro and in vivo research far more effective and reduce ethical issues.

However, current state of the art for in silico simulations suffer from limited applicability, rigid top-down designs, and static forms that provide only superficial mimicry of biological form and function, prevent open investigation of perturbations, mutations, and dynamic processes, and require complete knowledge of input pathways, states, or structures.

### SUMMARY OF THE INVENTION

The invention includes, in one aspect, a method for computer modeling, in a virtual environment, a virtual multicellular tissue having the emergent properties of self-repair, adaptive response to an altered environment, or cellular differentiation. The method includes the steps of:

(a) assigning to a virtual biological cell, a heritable virtual genome containing a set of virtual genes, where each gene has a gene-control region that specifies the activity of the gene in response to virtual molecules in the virtual environment, and a structural region that specifies the type of molecule or molecules produced by the gene, and where the molecules produced by the genes include at least one related to each of (a1) intercellular adhesion, (a2) cell division, (a3) cell growth, (a4) intercellular signaling, and (a5) cell differentiation;

(b) assigning (b1) chemical-interaction rules that govern the extra-genetic behavior of molecules contained in the environment or produced by the cell's genes, (b2) action rules that specify a cell's adhesion, growth, or cell-division condition, in response to molecules produced by a cell's gene relating to intercellular adhesion, cell growth, or cell division, respectively, and (b3) physical-interaction rules that govern how a cell will move in response to its own growth or division or the growth or division of neighboring cells;

(c) placing at least one such virtual cell in an environment optionally containing at least one molecule capable of activating a gene within the cell, through interaction with the control region of that gene;

(d) updating the state of each virtual cell in said environment, by (d1) updating the status of molecules produced by the genes in the cell, (d2) applying said chemical-interaction rules to update the status of the molecules present in the cell and, optionally, in the environment, (d3) applying said action rules to update the actions taken on or by each cell relating to cellular adhesions, growth, and division, and (d4) applying said physical-interaction rules to update the positions of the cell; and

(e) repeating step (d) until a virtual tissue having one or more desired emergent properties develops.

The virtual genes in the cell's genome may contain genes whose gene products, either by themselves or acting through a chemical-interaction rule, function to: (a1) trigger an action rule relating to intercellular adhesion properties of the cell; (a2) trigger an action rules relating to cellular division (a3) trigger an action rule relating to cell growth, (a4) produce molecules that are transmitted and received, to support intercellular signaling between cells, and/or (a5) trigger cell differentiation.

The action rules assigned in step (b) may include rules relating to the plasticity, elasticity, and rigidity of a cell adhesion, and at least one gene whose gene product triggers the action rules relating to intercellular adhesion properties includes at least one of (a1i) a single gene that produces multiple molecules relating to plasticity, elasticity, and rigidity, and (a1ii) multiple genes that produce a single molecule relating plasticity, elasticity, and rigidity.

The genome may include (a4i) at least one gene whose gene product is a signaling molecule capable of being transported by the chemical-interaction rules to the extracellular environment and (a4ii) at least one gene whose gene product is a receptor capable of being transported by the chemical-interaction rules to the cell surface, where it can interact with signaling molecules in the extracellular environment through the chemical-interaction rules.

The genome may include (a5i) at least one gene that produces a molecule transported by the chemical-interaction rules to the extracellular environment and (a5ii) at least one gene that produces a molecule transported by the chemical-interaction rules to the cell surface to act as a receptor, where it can interact with molecules in the extracellular environment, through the chemical-interaction rules, to further promote the production of additional molecules to act as similar receptors and optionally inhibit the production of molecules that act as dissimilar receptors and so promote cell differentiation.

A cell containing the gene may be specialized through cell differentiation such that it can no longer revert to a non-specialized state even without the continued reception of molecules from the extracellular environment.

The action rules may include a rule relating to cell death, and each cell's genome may also include a gene whose gene product can, either by itself or acting through a chemical-interaction rule, trigger the action rules relating to cell death.

Where the cells are not constrained to occupy specific coordinates in space, the physical interaction rules may include rules for calculating intercellular forces, based on the degree of overlap between or among the cells or the extent of separation of cells and the properties of the adhesion connections between or among the cells, and step (d) may include, for each updating step, performing a selected number of cell-movement steps designed to resolve intercellular overlaps or separations.

Each cell may be assigned a spherical shape that is preserved through cell growth and cell division, and the intercellular forces may be applied between the centers of cells having intercellular adhesions.

Alternatively, and where the cells are not constrained to occupy specific coordinates in space, each cell may be treated as a bag of spherical subcells that have intracellular adhesions between or among adjacent subcells of the same cell, and intercellular adhesions between or among subcells contained in different cells, and the physical interaction rules may include rules for calculating intracellular and intercellular forces between or among subcells that are connected by intracellular or intercellular adhesions, respectively, based on the degree of overlap between the subcells or the extent of separation of the subcells, and the properties of the adhesion connections between or among the subcells, and step (d) may include, for each updating, performing a selected number of subcell-movement steps designed to resolve intersubcell overlaps or separations.

The action rules that govern cell division may function to (i) divide the subcells making up a cell into non-interadhering sets of one or more subcells each, and (ii) separate the sets into separate cells, each composed of one or more subcells where any multiple subcells have intracellular adhesions.

A cell may be predisposed toward adopting a new cell differentiation state in accordance with the spatial arrangement or location of subcells making up the cell.

The method may further include employing a visualization module to allow user visualization of a developing tissue and adjustment of the model by changing one of more inputs selected from the group consisting of: (i) the types or gradients of molecules in the environment; (ii) one or more chemical-interaction rules; (iii) one or more action rules, (iv) one or more physical-interaction rules, and (v) a change in the control or molecule(s) produced by a gene.

The method may be employed to generate a multi-cellular tissue at a state of maturity, analogous to biological homeostasis, in which (i) the status of the cells is invariant over time, (ii) the condition of at least some of the cells is oscillating around a stable cell condition, or (iii) cells that are dying are being replaced by newly dividing cells.

The method may further include one of the following activities:

(a) perturbing the shape of the tissue at homeostasis, and applying steps (d) and (e) until the tissue returns to its state of homeostasis;

(b) changing the signals present in the environment, with the tissue at homeostasis, and applying step (d) and (e) until the tissue return to its state of homeostasis; and

(c) with the tissue at homeostasis, killing or removing cells from the tissue and applying steps (d) and (e) until the tissue return to its state of homeostasis;

(d) with the tissue not having yet attained homeostasis, killing or removing cells from the tissue and applying steps (d) and (e) until the tissue attains homeostasis;

In another aspect, the invention includes a multi-cellular virtual tissue having the emergent properties of self-repair, adaptive response to an altered environment, or tissue differentiation. The virtual tissue includes the following features:

(a) a plurality of virtual cells, each having a heritable virtual genome containing a set of virtual genes, each gene having a gene-control region that specifies the activity of the gene in response to virtual molecules in the virtual environment, and a structural region that specifies the type of molecule or molecules produced by the gene, where the molecules produced by the genes include at least one related to each of (a1) intercellular adhesion, (a2) cell division, (a3) cell growth, (a4) intercellular signaling, and (a5) cell differentiation, where

(b) the operation and actions of the genes are guided by (b1) chemical-interaction rules that govern the extra-genetic behavior of one or more molecules placed or produced in the virtual cells or in the extra-cellular environment of the cells, (b2) action rules that specify a cell's adhesion, growth, or division condition, in response to one or more molecules produced by a cell's gene(s) relating to intercellular adhesion, cell growth, or cell division, respectively, and (b3) physical-interaction rules that govern how a cell will move in response to its own growth or division or the growth or division of neighboring cells, and where

(c) the tissue is produced by iteratively updating the state of each cell by applying the gene control and molecule production, chemical-interaction rules, action rules, and physical-interaction rules to the existing state of each said cell.

The tissue may be formed by the steps of placing at least one such virtual cell in an environment optionally containing at least one molecule capable of activating a gene within the cell; updating the state of each virtual cell in the environment, by (c1) updating the status of products produced by the genes in the cell, (c2) applying the chemical-interaction rules to update the status of the molecules present in the cell and, optionally, in the environment, (c3) applying the action rules to update the actions taken on or by each cell relating to cellular adhesions, growth, and division, and (c4) applying the physical-interaction rules to update the positions of the cell; and repeatedly updating until a virtual tissue having one or more desired emergent properties develops.

The tissue may contain at least one pluripotent cell capable of division and differentiation toward non-pluripotent cell types, and at least one or more non-pluripotent cell types.

The tissue may be composed of different layers of cells, where the cells in a given layer are specialized differently than those in another layer of the tissue.

These and other objects and features of the present invention will become more fully apparent when the following detailed description of the invention is read in conjunction with the accompanying drawings.

### BRIEF DESCRIPTION OF THE DRAWINGS

FIG. 1A shows essential elements of an ontogeny engine in accordance with the invention that guides the processes by which the subject tissue or phenotype is constructed, including a virtual genome, physical interactions, and an environment;

FIG. 1B illustrates major functional components in the system of the invention;

FIG. 2 is an overview of the integrated model for ontogeny, showing the relationship between gene expression, metabolism, cell signaling, sensory processes and gene regulation;

FIG. 3 is a high-level flow chart of the operation of the system;

FIG. 4 shows a pair of virtual genes within a virtual cell, including a gene dedicated to intracellular adhesions, cell growth or cell division;

FIG. 5 shows genes and gene products dedicated to intercellular signaling among a pair of cells;

FIG. 6 shows genes and gene products dedicated to establishing cell state between a pair of signaling cells;

FIGS. 7A-7C illustrate an initial cell division with differentiation into two cell types (7A), a second doubling (7B) to produce two cells of each type, and reversion of one of the cells of the lightly-shaded type to a cell of the darker-shaded type (7C);

FIGS. 8A and 8B provide a legend for interpreting molecules and actions in a signaling and gene regulatory network (SGRN);

FIG. 9 shows an SGRN for a simple tissue model with cells committed to differentiation;

FIG. 10 is a flow diagram of stepPhysics operations in a simple egg-carton model for cell placement in the system operation shown in FIG. 3;

FIGS. 11A-11C show an array of nine cells in a planar egg-carton model (11A), and the configurations after addition of a new cell (11B), or removal of one cell (11C);

FIG. 12 is a flow diagram of stepPhysics operations in a free-space model for cell placement in the system operation shown in FIG. 3;

FIGS. 13A-13C illustrate cell division and growth in a “solid sphere” free-space model;

FIGS. 14A-14C illustrate growth and spatial resolution of a group of solid-spheres in a free-space model;

FIG. 15 is a flow diagram of steps in box 182 of FIG. 12 for resolving cell overlaps and overshoot;

FIGS. 16A-16D illustrate the distribution of forces among solid-spheres upon application of force to one of a group of connecting solid-spheres, in the absence (16A and 16B) and presence (16C and 16D) of end-to-end sphere connections;

FIGS. 17A and 17B illustrate two cells represented as bags of marbles (17A) and the fully visualized cells without the internal marbles being visible (17B);

FIG. 18 illustrates two cells adhered by an intercellular adhesion patch;

FIG. 19 illustrates determining cell orientation from intracellular sphere relations;

FIG. 20 shows the promotion curve for a single model interacting with a single regulatory gene that is an exact match where the Affinity between the molecule and gene is equal to one;

FIG. 21 illustrates a virtual cellular sheet with virtual stem cells, in accordance with the simulation of Example 2, described in section G2;

FIG. 22 illustrates the role of transient amplifying cells in the development of epithelial tissue;

FIGS. 23A-23D represent a virtual epithelial tissue, with the basement membrane highlighted (23A), the tissue's stem cells highlighted (23B), with the cells near the stem cells highlighted (23C), and with a population of lipid-producing virtual cells highlighted (23D); and

FIGS. 24A-240 illustrate various gene components used in constructing the genome and chemical-interaction rules for a simple tissue model having cells committed to differentiation, in accordance with the simulation of Example 1, described in sections C and G1, and consolidated in the SGRN of FIG. 9;

FIGS. 25-A-25K illustrate various gene components used in constructing the genome and chemical-interaction rules for a tissue sheet with stem-cell niches, in accordance with the simulation of Example 2, described in section G2, and consolidated in the SGRN shown in FIG. 26;

FIG. 26 shows the SGRN for a tissue sheet with stem-cell niches, in accordance with the simulation of Example 2, described in section G2; and

FIGS. 27A-27JJ illustrate various gene components used in constructing the genome and chemical-interaction rules for a virtual epithelial tissue, in accordance with the simulation of Example 3, described in section G3

### DETAILED DESCRIPTION OF THE INVENTION

### A. Definitions

The terms below have the following definitions herein, unless indicated otherwise:

In biology, a “cell” is the basic unit of living matter in all organisms. A cell is a self-maintaining system with the chemical and physical mechanisms for obtaining energy or materials to satisfy nutritional and energy requirements. A cell represents the simplest level of biological organization that manifests all the features of the phenomenon of life with the capacity to make themselves autonomously and to multiply by division. A “virtual cell” is a computer-simulated analogue of a biological cell, and contains a virtual genome having a plurality of virtual genes or gene units that confer on the cell, at least four basic cellular functions; (1) gene expression, (2) cell metabolism, (33) cell division, and (4) cell growth. Typically, the cells will also have a “death” gene product to effect cell death and a gene or genes that give rise to different states of cell differentiation.

“Environment” refers to both extracellular and intracellular environment, and encompasses the entirety of the space or volume occupied by the one or more virtual cells in the system and the extracellular environment in which the cells exist.

A “molecule” refers to a virtual compound or agent that is produced by virtual gene, or introduced into the environment or converted by a chemical-interaction rule, and which functions to affect the state of each cell, through its interaction with cell receptors and the control regions of virtual genes in a cell.

“Virtual genes” are computer simulation analogues, possibly abstracted, of biological genes. Each virtual gene has a gene-control region that specifies the activity of the gene in response to molecules in the environment, and a structural region that specifies the type of molecule or molecules produced by the gene. For example, a growth gene may have the form [DiffuseNutrient 0.18, NeighborPresent −3] [Growth], specifying that cell growth is promoted moderately (0.18) by DiffuseNutrient, and strongly inhibited (−3.00) by NeighborPresent.

The collection of virtual genes in a virtual cell forms the cell's “virtual genome,” described in terms of the constituent genes' control and production characteristics. The genome allows cells to develop, maintain themselves, grow, and reproduce, and typically includes genes whose products support cell death or cell differentiation.

“Chemistry equations” or “chemical-interaction rules” refer to a set of equations that indicate the extragenomic behavior and interactions between or among cellular or environmental molecules, such as gene products, receptors, and cell transporters. The chemical-interaction rules govern the extra-genetic behavior of one or more molecules placed or produced in the virtual cells or in the extra-cellular environment of the cells.

“Action rules that specify a cell's adhesion, growth, or division condition,” are rules that govern a cell's intercellular adhesion with adjacent cells, cell growth, and cell division, in response to one or more a molecules produced by a cell's gene relating to intercellular adhesion, cell growth, or cell division, respectively.

“Physical-interaction rules” are rules that govern how a cell will move in response to its own growth or division or the growth or division of neighboring cells, or response to physical constraints or perturbations imposed by the environment.

A gene is said to “produce molecules related to a particular cellular function or activity,” such as intercellular adhesion, cell division, cell growth, intercellular signaling, or the state or states of adjacent cells, if the molecules produced are acted on directly, or through the chemical-interaction rules, alone or in combination with other molecules, by the action or physical-interaction rules, to produce or effect the specified function or activity. It will be recognized that the molecule(s) produced by a gene may be related to more than one function.

“Cell primitives” refer to the simplest operations or behaviors that a virtual cell can perform. All other operations of a cell are combinations of such cell primitives.

A “virtual tissue” is a collection of virtual cells making up a tissue having desired shape and functional characteristics. In biology, tissue is a mass of similar cells and their intercellular substance, working together to perform a particular function or set of functions.

“Cell signaling” refers to an event in which signaling molecules produced by a gene in one cell interact with receptors in or on another cell, to signal one or more genes within the other cell.

An “signal” refers to a nutrient or other molecule outside of a cell that, directly or indirectly, affects the cell's genome by transport into the cell or by interaction with a cell surface receptor.

A “receptor” is a molecule produced by a gene or present within a cell and that becomes localized on cell's surface. Binding of an external molecule with the cell receptor may then directly or indirectly affect one or more genes within the cell.

An “adjacent cell,” as applied to a given cell, means all other cells that are in contact with or are an immediate neighbor of that cell.

The “phenotype” of an organism or tissue refers to the observable traits, appearance, properties, function, and behavior of the subject organism or tissue.

“Physical constraints” refer to constraints imposed upon the position or growth of a cell due to the presence of adjacent cells or size limits of the tissue.

A “totipotent cell” refers to a cell having the capability to form, by one or more rounds of cell division, other totipotent cells, pluripotent cells, or differentiated cell types allowed in the virtual tissue. In biology, totipotent cells can give rise to any of the various cell types in an organism.

A “pluripotent cell” is a cell that produces daughter cells of a few different cell types. For instance, dermal stem cells produce cells of a variety of dermal cell types, but do not produce cells for non-dermal cell types; such dermal stem cells are pluripotent, but not totipotent.

A “stem cell” refers to a totipotent or pluripotent cell and is a relatively undifferentiated cell that can continue dividing indefinitely, producing a daughter cell that can undergo terminal differentiation into particular cell types, and a stem cell that retains its proliferative capacity and relatively undifferentiated state.

A “virtual stem cell”, “virtual totipotent cell”, or “virtual pluripotent cell” refer to virtual cells having analogous characteristics to their biological cell counterparts.

“Homeostasis” refers to the ability or tendency of an organism or cell to maintain a relatively constant shape, temperature, fluid content, etc., by the regulation of its physiological processes in response to its environment.

“Emergent properties” or “emergent behavior” refers to a process or capability that exists at one level of organization, but not at any lower level and that depends on a specific arrangement, organization, or interaction of the lower level components. Two emergent behaviors of the virtual tissue of the invention are (i) self-repair, induced response whereby cells are replaced when they have been killed, damaged, or removed, and (ii) adaptation, meaning a change in structure, function, or habits as appropriate for different conditions, enabling an organism to survive and reproduce in a certain environment or situation.

An “interval” refers to a time period, typically but not necessarily a discrete time period, at which the state or status of the cells making up a virtual tissue in the system of the invention are updated.

“Cell differentiation” is the process by which cells change during development toward a more specialized form or function. Cell differentiation is in part described along various stages toward a specialized form or function: committed or specified describes a strong propensity to differentiate, determined describes inexorable commitment to differentiation. The living cells of an animal in its early embryonic phase, for example, are identical at first but develop by differentiation into specific tissues, such as bone, heart muscle, and skin. See also pluripotent and totipotent.

### B. Overview of the System and Operation

The method, system, and apparatus of this invention include a computational approach and platform that incorporates principles of biology, particularly those primitive features of living systems that are fundamental to their construction and operation and that distinguish them from non-living systems. The goal of such incorporation is to identify, extract, and capture in algorithmic form the essential logic by which a living system self-organizes and self-constructs. The strategy includes a perspective based on the properties of cells, embedded within the developing system.

The computational engine used in the method, system and apparatus of this invention simulates models of tissue phenotypes from a developmental process starting from a single cell and its genome or similarly from initial cells with genes. Properties such as tissue shape and self-repair arise from the interaction of gene-like elements as the multicellular virtual tissue develops. The engine defines and controls all parameters of the virtual environment necessary for development, including placement of nutrients, allocating space for cells to grow, sequencing of actions, and rules that govern the physics of the virtual environment. To make the simulation and modeling more flexible, all of the environmental parameters, including rules governing the calculation of molecular affinity and the placement and concentration of nutrients or other molecules, are configurable.

The core concept for the invention is biological development, or ontogeny, the process by which an initial cell becomes a many-celled organism. The computational model focuses on the cellular primitives that are necessary to produce an integrated multicellular state, such as differentiation (specialization) of cell clusters, communication and feedback between specialized clusters, and metabolism.

Specifically, the main features of the ontogeny engine are as follows:
from one cell, many cells develop by cell growth, division, and death;
cells descend from parent cells and so develop with lineage and sequential order;
cells as semi-autonomous units, each with its own set of genes;
context-dependent, cell-by-cell control of gene expression via signaling;
construction and monitoring of an extracellular environment; and
higher order, emergent properties (e.g., self-repair).

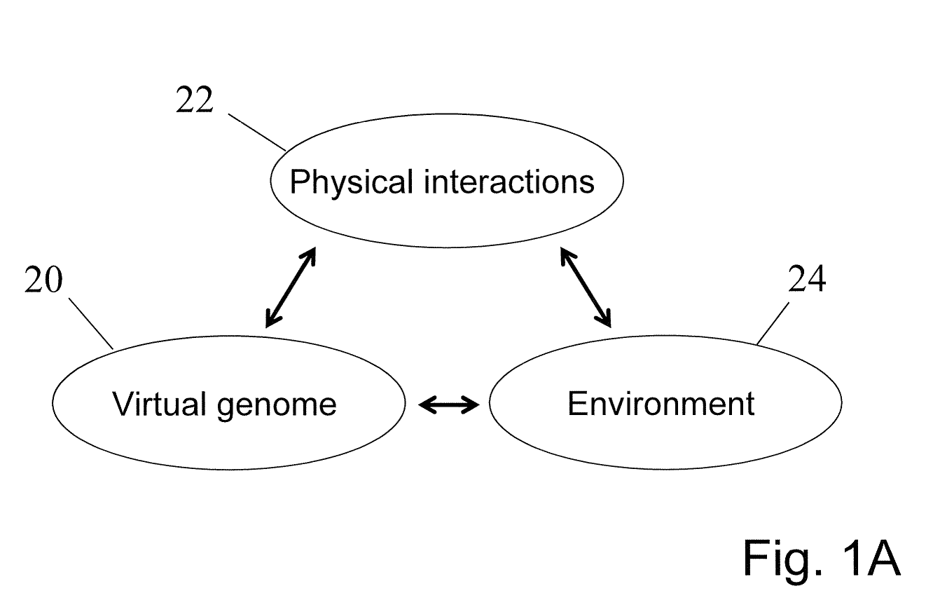

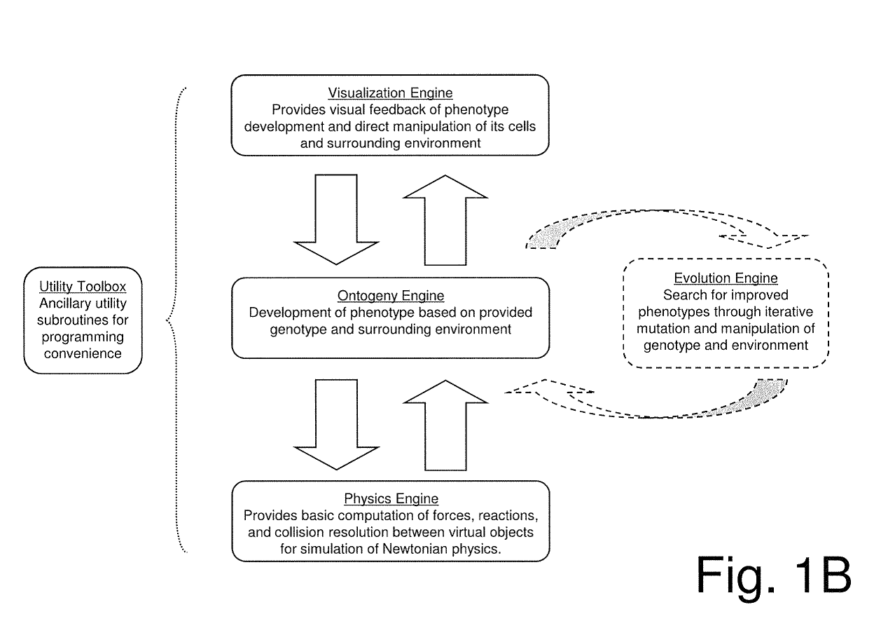

FIG. 1B depicts the distribution of function in the computational engine, where the visualization engine provides a user input and output interface, the ontogeny engine computes biological development, the physics engine provides foundations for physical interaction simulation, with adjunct utilities and an optional evolution engine.

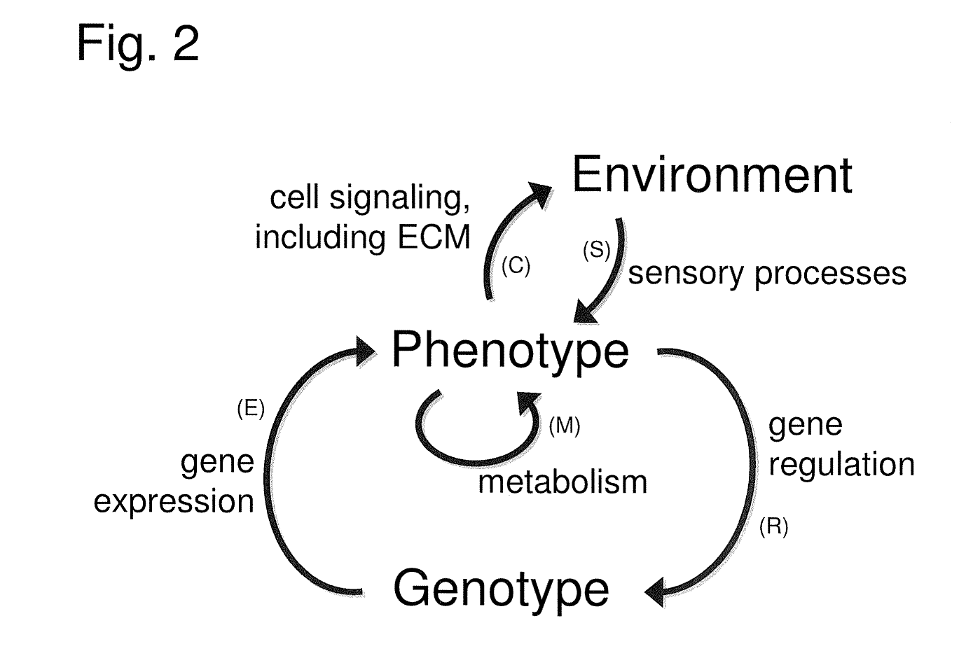

FIG. 2 illustrates the essential biologically derived interaction of an ontogeny engine to include genetic encoding, a process of self-construction analogous to biological development, and environmental influences of the processes by which the organism is so constructed. Although the figure depicts genotype, phenotype, and environment as separate domains, the arrows indicate that they are interdependent and overlapping.

As seen in FIG. 1A, the ontogeny engine includes the following elements: (i) a virtual genome 20 which specifies the genes present in a cell and their signal and response characteristics which will determine how the genes in each cell respond to signals from the environment and from gene signals within the same cell or a different cell; (ii) physical interactions 22, which govern how the cells move and occupy space during cell growth, division, or death, within a tissue, and (iii) an environment 24 in which the cells will grow. In addition, the system may contain chemistry equations that specify the extragenetic activity of molecules, including gene products and molecules from the environment. The chemistry equations may be thought of as the molecular interactions that occur normally within cells, including the rate of turnover of the molecules, and molecular binding or reaction effects—in other words, how the molecules behave independent of the cell genome.

Although the three components are shown separately, they are linked in complex, intricate ways. In principle, any of these components can be adjusted to devise the generation of a given tissue or a given tissue's response to a perturbation.

The ontogeny is accompanied by criteria for suitability, a basis for evaluating the outcomes of many schemes for development—different gene interactions, physical constraints, and environmental conditions. This criteria, analogous to evolutionary processes of selection and descent with modification from ancestral forms, may be provided through the visualization engine or, alternatively, by a genetic algorithm method in the evolution engine for optimizing the method for tissue fitness. The genetic algorithm operates to generate and evaluate various virtual genomes, where the fitness factor, which forms the basis of selecting preferred genomes, is an overall match of the developed tissue with a desired target tissue. This method is particularly useful where the developed tissue and target tissue can be specified with precise coordinates, such as an “egg carton” model where each cell is assigned to a specified bin. In a model where the cells are allowed to adopt positions in free space, and assume a variety of sizes or shapes, it may be more practical to manually use the visualization model to compare the developed tissue visually with the target tissue, and make empirical adjustments to the genome or environmental conditions, to achieve a closer match between the developed and the target tissues.

Genes are an essential part of the invention's computational design. Genes provide an important resource for the developing tissue: each cell contains a genome, a set of templates for producing proteins and other molecules needed to build and coordinate the multicellular aggregate. For genes to function as units of development, there must be a means to control how, where and when particular genes are expressed. To represent these features faithfully in the invention's computational model, each virtual gene contains both regulatory (control region) and structural (gene product) regions, and gene activity is controlled by the interaction of molecules (transcription factors) with the regulatory region, in a manner analogous with gene regulatory networks in vivo.

Genes account for a good deal of the biological potential of scale whereby complexity arises from a relatively simple set of encodings. Yet for this potential to be realized, genetic information must be rendered by a process of self-construction, by development. Self-construction by living systems is driven in a manner that harnesses the power of genetic encodings to ensure heritability of traits, while packaging them in an encoded form that is compact enough to place into a single cell, the smallest living unit.

Integration of genes into the context of development requires that each gene's encoded product be understood in the manner that it contributes to cellular function or its coordination in the growing multicellular tissue. For instance, some genes encode sensor molecules that allow cells to detect signals from neighboring cells. However, while genes determine the types of sensors a cell can make, genes do not specify the patterns of information that the cell receives. As seen in FIG. 2, genotype can influence phenotype through gene expression (E) and internal cellular metabolism (M), while phenotype acts on the genome by regulating overall gene activity (R). The phenotype influences the local environment of adjacent cells by cell signaling (C), for example, by release of cellular products into the environment. In turn, the phenotype is acted upon by the local environment through sensory processing (S), for example, extracellular molecules acting on cell receptors. Accordingly, phenotype represents a higher ontological category than genotype, since the phenotype has access to genetically encoded information and information in its environment that is not so encoded. Furthermore, cells control which genes are expressed and so the patterns of gene expression across the entire tissue or organism derive from controls each cell applies according to the signals it receives.

Signals are locally defined, by the position a cell occupies in gradients in the developmental field, by signal molecules produced by the cell's neighbors, and by signal molecules retained in extracellular matrix (ECM) produced by cells. Microenvironments and control of gene expression are the basis for differentiation.

In addition to their role in development, genes serve a passive role as units of inheritance, the units for transfer of information across generations. For genes to serve as units of inheritance they must have a stable, but not completely unchangeable, structure.

Emergence is of fundamental importance to the current invention. Emergence is a term that carries many special meanings, and accordingly, a broad range of phenomena have been classified as emergent [Steels, 1994; Morowitz, 2002]. With regard to this invention, emergence refers to a special relationship among primitives or agents in a multi-agent system. Only a specific arrangement or interaction among primitives produces the emergent behavior, and such behavior is not a property of any single primitive. Usually, emergence refers to behaviors or dynamic states rather than static shapes or structures. In living systems, emergence carries one or more additional meanings: 1) that the property of interest appears only at some higher level of hierarchical organization than the elements that give rise to it; 2) that the emergent behavior is adaptive, that it carries survival value, or increases fitness. For instance, homeostasis among vertebrates (maintenance of blood composition within narrow limits) satisfies both conditions. It is adaptive, and it is a whole organism property that involves organs in several different body systems (primarily kidneys, heart, brain, and in some animals, skin or salt glands).

The emergent functionalities of interest for the present invention concern those properties that serve requirements of the multicellular state produced by ontogeny. Embodiments of the present invention have demonstrated utility for producing emergent self-repair, cell communication that leads to the desired form, adaptability to a changed environment, and a feedback network that produces regular oscillations of state that propagate through the simulated tissue.

Specifically, the emergent functions of living multicellular phenotypes simulated by the present invention include the following:
differentiation from cell specialization and terminal state;
communication by sensory functions and exchange of signals;
homeostasis by regulatory processes and metabolic feedback;
metabolism of fuels, energy, and molecular synthesis;
self-repair through cell turnover, regeneration, and replication; and
adaption by phenotypic plasticity.

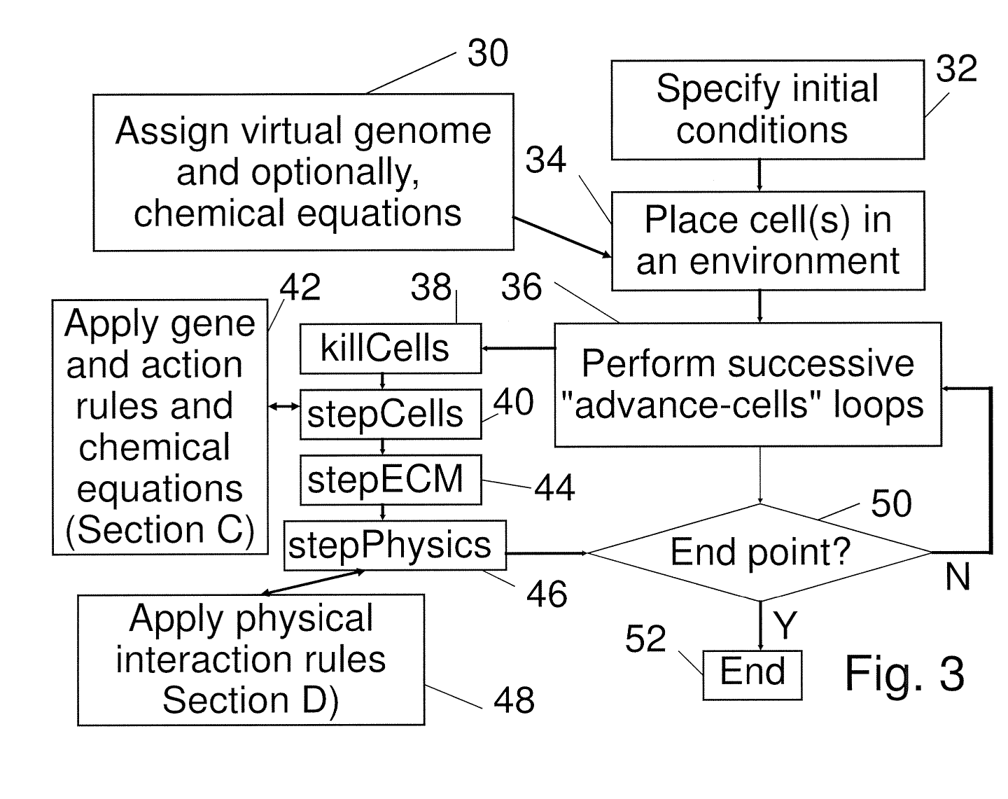

FIG. 3 depicts a high-level flow chart of the operation of the system, described briefly here and in more detail in the sections below. Initially, a cell or cells is assigned a virtual genome, that is, a set of virtual genes, each with specified gene control and gene product characteristics, as indicated at 30 and as detailed in Section C below. In addition, a set of chemistry equations that govern the extra-genetic behavior of the molecules present in the environment or produced by the genes may be specified, also as will be described below in Section C. Development is initiated by placing a single virtual cell having a genome into that environment, at 34, and specifying initial conditions, e.g., environmental molecules (external signals) and signal density and gradient, at 32. The state of the cell or cells is then advanced in discrete steps, at 36, by applying at each step, each of the four separate functions indicated at 38, 40, 44 and 46. The “killCells” function acts at 38 to instruct any cell to die if the cell has previously been identified as a “next cell to die.”

The “stepCells” function at 40 carries out all cell activity functions that are poised to be effected at that cycle, including gene activity, gene response, and intracellular and intercellular signaling, as detailed below. The module uses the gene rules and chemistry equations to determine the step-by-step change in each cell, based on changes in the state of function of the cell's genes and molecules acting within or on the cells, as indicated at 42 in the figure. In this mode, the cell's genome and, if present, the chemistry equations, are applied to produce a new state for each cell governed by the molecules within a cell and the response of each gene to signaling from within the cell. Depending upon these interactions, each gene within the cell may be turned on (or off). When a gene is turned on, the transcription apparatus of the cell produces the molecules defined by the gene's structural region. These newly produced molecules may in turn interact with the cell's genome, affecting rates of transcription at the next time step. Development is thus governed, at each stage of tissue development, by inputs from the virtual environment external to the cell, and also by internal feedback mechanisms of the cell. In addition to environmental factors and internally produced molecules, a cell may also receive information from neighboring cells. The simplest neighborhood of a cell consists of those cells that are spatially adjacent to (touching) the cell of interest. However, a cell's neighborhood may be configured as any arbitrary group of cells. For example, a neighborhood (the cells to/from which it will send/receive signals) could include cells that are not adjacent, as occurs in vivo with cells that are able to signal non-local cells via hormones.

“stepECM” at 44 acts, based on simulation adhesions, to break overextended cell adhesions, make new cell adhesions between adjacent cells, and decay cell adhesions over time, as discussed below.

In addition to transcription, two primary actions—cell growth and cell division and optionally, cell death—are available to each cell. The genome of a cell may include genes that encode death molecules (or growth molecules), and as these genes are transcribed, the concentration of encoded molecules in the cell's cytoplasm increases. Growth or death is a function of the concentration of these two types of molecules. When a cell dies, it is removed from the environment. If a cell grows, its overall size, e.g., spherical diameter in the case of the spherical cell, is increased, and if a cell divides, a new cell is placed in a location adjacent to the parent cell. If all adjacent positions are already occupied, that cell may not divide, even if the growth potential exceeds the threshold. “stepPhysics” at 46 moves cells according to forces calculated to act upon them from other cells, adhesions, or other virtual structures, and resolves any overlaps between cells that arise from cell growth, division, or motion, including motion from prior calculations in resolution of cell overlap. The “stepPhysics” function draws on physical interaction rules, 48, which specify cell adhesions and rules for physics and mechanics of moving cells apart from one another in resolution of cell overlap, or toward one another to resolve excessive cell motion, as discussed further below.

The stepPhysics function may utilize any of three different models described further: (1) a fixed-coordinate, discrete-coordinate, or egg-carton model in which cells are assigned to predetermined two- or three-dimensional coordinates in space, similar to the bins of an egg carton; (2) a free-space or continuous-coordinate model in which each cell is represented by a solid sphere which is free to assume arbitrary coordinates in two- or three-dimensional space; and (3) a free-space model in which the cells themselves are treated as a “bag of marbles” and therefore free to assume arbitrary non-spherical shapes, e.g., flattened shapes. In general, a free-space model gives a much closer approximation to real-cell behavior, and may be required for certain tissue behavior. Typically, in each “advance-cells” loop, 36, the stepPhysics function is run over several cycles, usually 20 or more, to iteratively resolve cell movement and overlap.

As indicated in FIG. 3, the “advance-cells” loop is repeated until a desired end point is reached, at 50, terminating the run at 52. This end point may be defined by a pre-selected number of loops, or when the tissue reaches a stable or steady state.

### C. Virtual Genes and Chemical-Interaction Rules

Each virtual cell in the system is assigned a virtual genome containing a plurality of genes, each of which has a control region that determines what combination of signals (e.g., molecules or conditions) will signal gene activity and at what level, and a gene product region that specifies the gene product or action produced by the gene. Below is shown a group of six genes that represent a “basic” set of virtual genes in a variety of tissue development applications.

| GENE # | Gene specification |
|---|---|
| 1. | [DiffuseNutrients .3] [Plasticity, Elasticity, Rigidity], |
| 2. | [DiffuseNutrients 5] [ExistanceSignal, |
| | ExistanceSignalReceiver], |
| 3. | [DiffuseNutrients .18, NeighborPresent −3] [Growth], |
| 4. | [DiffuseNutrients .18, NeighborPresent −3] [Division], |
| 5. | [DiffuseNutrients 5, Dominator −10, Dominated 5] |
| | [DominationSignalReceiver], |
| 6. | [NeighborPresent 3, Dominated −10, Dominator 3] |
| | [Dominator, DominationSignal] |

As seen, each gene contains a paired control region and a gene product region. For example, the third gene (GENE 3) above “[DiffuseNutrients 0.18, NeighborPresent −3] [Growth]” indicates that cell growth is promoted at (+)0.18 by DiffuseNutrients (a configured designation for molecules, in this case placed in the environment and transported into the cell) and, given its negative coefficient is inhibited at −3.0 by NeighborPresent. The actions of these six example genes—cell growth, division, death, and adhesion—are described in greater detail below.

Molecules present in the environment or made within cells are governed by extragenetic rules, referred herein as chemical-interaction rules or chemistry equations, which determine how molecules will be transformed or transported as they interact with other molecules in the system. For the above example of six genes, a corresponding set of chemistry equations could include the nine equations listed below:

| EQ # | Chemistry equation |
|---|---|
| 1. | {DiffuseNutrients} + (NutrientTransport) = |
| | .1 DiffuseNutrients + (1.11111111111111 NutrientTransport); |
| 2. | (NutrientTransport) = (1.111111111111111111 NutrientTransport); |
| 3. | (GenericExporter) = (1.111111111111111111 GenericExporter); |
| 4. | ExistanceSignal + (GenericExporter) = |
| | (1.1111111111111 GenericExporter) + {ExistanceSignal}; |
| 5. | ExistanceSignalReceiver = (ExistanceSignalReceiver); |
| 6. | {ExistanceSignal} + (ExistanceSignalReceiver) = |
| | 20 NeighborPresent; |
| 7. | DominationSignal + (GenericExporter) = |
| | (1.1111111111111 GenericExporter) + {DominationSignal}; |
| 8. | DominationSignalReceiver = (DominationSignalReceiver); |
| 9. | {DominationSignal} + (DominationSignalReceiver) = |
| | 20 Dominated + 20 GrowABit; |

The left side of the equal sign in each chemistry equation lists the reactants, or substrates, while the right side describes the products of their interaction. For instance, EQ 4 is read as follows: when ExistanceSignal is internal to the cell and GenericExporter is on the cell surface, as denoted by parentheses about the molecule name, the equation will produce 1+1/9 GenericExporter for every one GenericExporter in the reaction and produce ExistanceSignal molecule outside of the cell, as denoted by the braces about the molecule name. Since reactants are “consumed” in the execution of an interaction equation, the net effect is to replenish the GenericExporter and move ExistanceSignal from inside the cell to outside of it.

Chemistry equations designate how internal or surface substrate molecules are converted to other internal or surface molecules, how molecules are transported across the cell membrane by surface molecules, and how molecules are relocated between a cell's interior and surface. Chemistry equations can also be used to consume molecules to inhibit their involvement in other interactions.

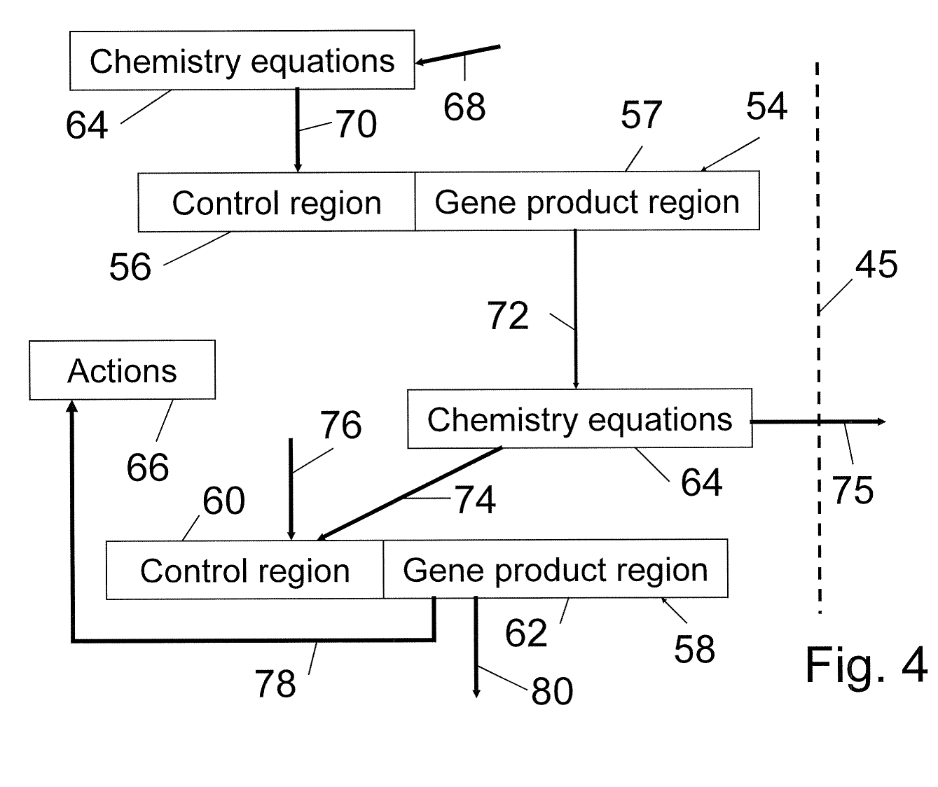

With this background, the gene functions and interactions illustrated in FIGS. 4-6 can be readily understood. FIG. 4 shows two genes within a cell, whose “outer membrane” (i.e., separation between the interior and exterior of a cell), is indicated at 45. The first gene, indicated at 54, has a gene control region 56 and a gene-product region 57 [change figure]. As will be seen, the gene produces a gene-product that in turn can act on a second gene, shown at 58, and having a control region 60 and a gene-product region 62 whose gene product acts through a specified “action” 66 to potentially trigger a cell behavior such as cell growth or cell division.

To further explain this figure, assume a cell encounters an intracellular signal 68 which is transformed through chemistry equations 64 to produce an interior molecule 70 that has an affinity with the control region, 56, of gene 54 to output a product molecule 72. This product, 72, then reacts in chemistry equation at 64 to produce another molecule 74 corresponding to the control region, 60, of gene 58. As will be appreciated from the next figure, molecule 74 indicates a gene-driven interaction between two nearby cells that signals the presence of a neighboring cell to the gene being considered. Thus, if gene 58 in FIG. 4 corresponds to GENE 3 above, the gene control region responds to the presence of both DiffuseNutrients, indicated by directly presented molecule 76, and NeighborPresent, indicated by molecule 74, to produce a gene product, 78, which is accumulated in accordance with cell behavior actions, 66, to cause the cell to grow. The same mechanism of gene control and gene action applies to GENE 4 for cell division. GENE 1 which controls adhesions has a similar mechanism, but does not depend on the presence of NeighborPresent.

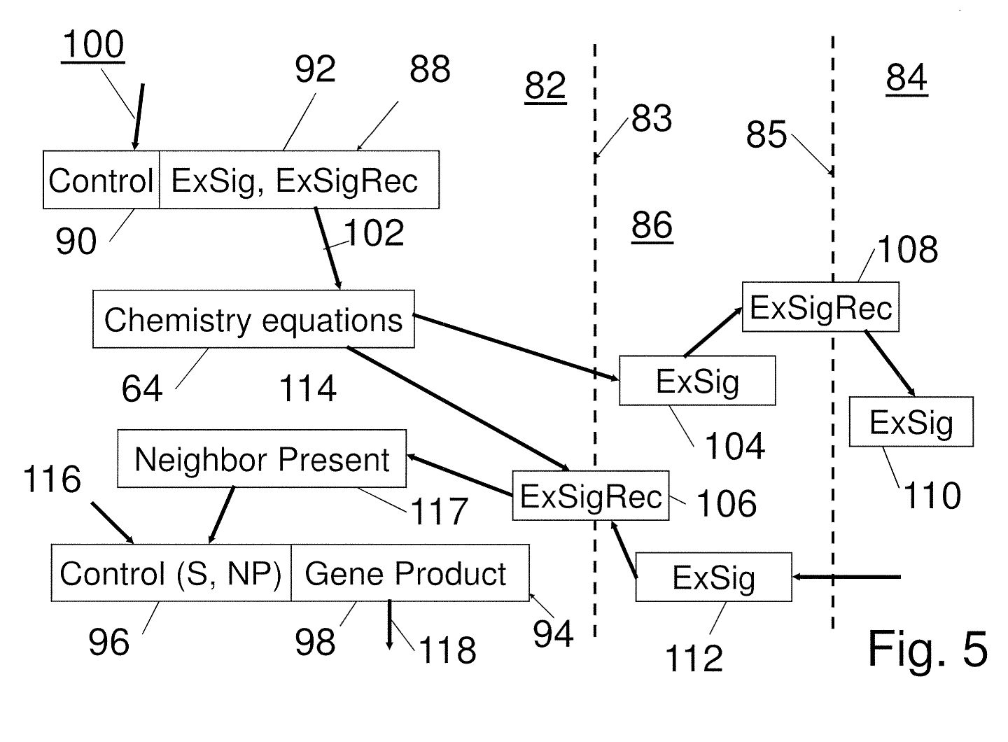

FIG. 5 illustrates how GENE 2 present in neighboring cells leads to intercellular signaling. The two cells, with their interior environments, are indicated at 82 and 84 and separated by outer “membranes”, 83 and 85, to define an intercellular space, 86, between the two cells.

Beginning with cell 82 of this figure, GENE2 may be represented by gene 88 to illustrate how its products reach neighboring cell 84, and how products from a respective GENE 2 in cell 84 act on at least one gene in cell 82 that is responsive to NeighborPresent signals. Gene 88 includes a control region, 90, which is responsive to DiffuseNutrients, as seen above for GENE 2, and a gene-product region 92. Upon its promotion with DiffuseNutrients, indicated at 100 in the figure, GENE 2 simultaneously expresses ExistanceSignalReceiver and ExistanceSignal as internal molecules, shown at 102. Chemistry equation 5 (EQ 5) transports the ExistanceSignalReceiver onto the surface of the cell, 83, as 106, where it can react by chemistry equation 6 (EQ 6) with external ExistanceSignals, 112, from one or more neighboring cells. Chemistry equation 4 (EQ 4) moves the ExistanceSignal, in the presence of a GenericExporter, from inside cell 82 to outside the cell (as indicated by the shift from parentheses to brackets in EQ 4), as shown at 104 in the figure. Activation of the respective GENE 2 in neighboring cell 84 similarly produces an ExistenceSignalReceiver, 108, on the surface of cell 84 and extracellular ExistanceSignal 112.

The reaction of ExistenceSignal 112 from cell 84 with ExistanceSignalReceiver 106 in cell 82 produces, through chemistry equation 6 (EQ 6), a NeighborPresent molecule, 117, that can act on a gene, such as GENE 3, indicated at 94, having a gene-control region 96 and a gene-product region 98. As described for GENE 3 in FIG. 4, this gene is responsive to NeighborPresent, 117, and DiffuseNutrient, 116, molecules to trigger cell growth or division, through produced molecules, 118. This description demonstrates that GENE 2, with chemistry equations 4 through 6, provides intercellular signaling to inhibit cell growth and division in the presence of neighboring cells.

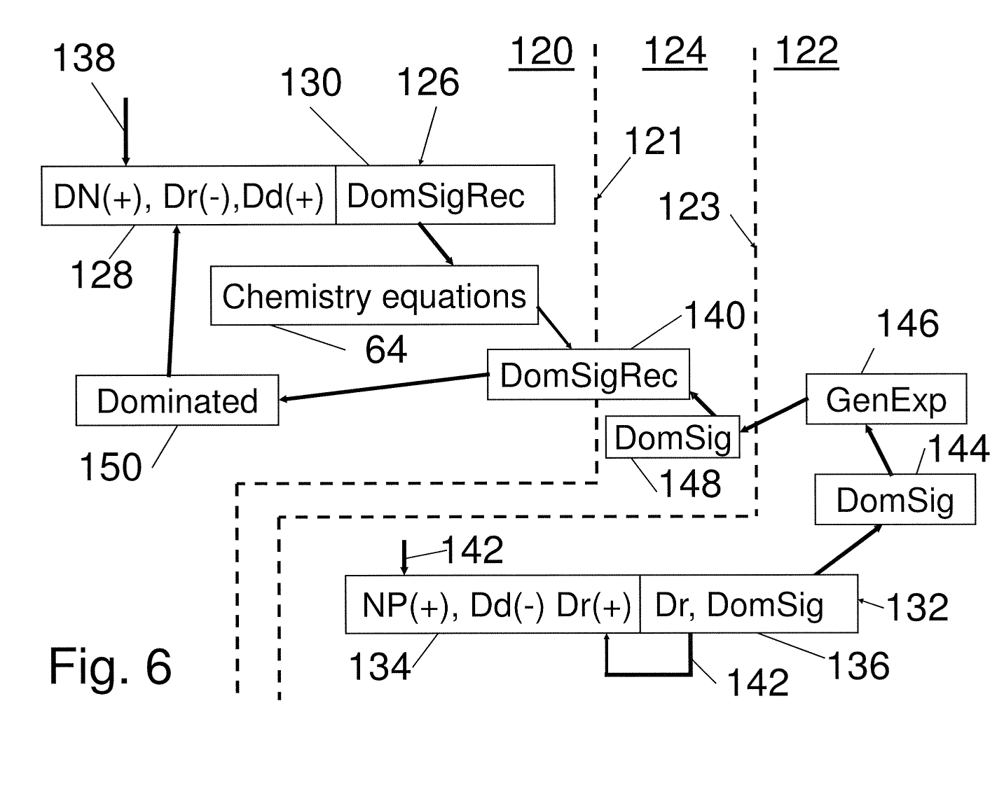

FIG. 6 illustrates how GENES 5 and 6 above of neighboring cells produce a change in the relative status of the two cells. The mechanism illustrated in FIG. 6 is self-reinforcing, so that a cell tends to remain in a given state, analogous to a state of differentiation in biological tissue. Among a group of differentiated cells, only one or a few remain in a totipotent or pluripotent state. Cells of a group of similarly situated cells tend to retain similar states, indicating similar differentiation: for example, cells forming a layer within multi-layered tissues.

The two cells, or their intracellular environments, in FIG. 6 at 120 and 122, are separated by outer “membranes”, 121 and 123, respectively, that define an intercellular space, 124. As GENE 5 of cell 120, the gene, 126, has a control region, 128, that responds positively to DiffuseNutrients, negatively to Dominator molecules, and positively to Dominated molecules, collectively indicated at 138. The gene's product region, 130, produces DominationSignalReceiver, 132, which is placed at the surface of the cell, 121, as 140 by chemistry equation 8 (EQ8), from 64.

As GENE 6 in a neighboring cell, 122, the gene, 132, has a control region, 134, that responds positively to NeighborPresent molecules, negatively to Dominated molecules, and positively to Dominator molecules, collectively indicated at 142. The gene product's region, 136, produces Dominator and DominationSignal. The Dominator molecules so produced repress GENE 5 and stimulate GENE 6, shown by loop 142 in the figure.

To appreciate how the two cells can develop to a condition of unequal status, assume that conditions at some point favor increased activity of GENE 6 in cell 122, causing a further activation of the gene through feedback loop 142, and thus production of DominationSignal, 144, which is transported out of the cells by a GeneralExporter, 146, as specified by chemistry equation 7 (EQ 7). Assume also that GENE 5 in cell 120, through the presence of DiffuseNutrients acting on GENE 5 and chemistry equation 8 (EQ 8), has produced DominationSignalReceiver onto the cell surface. When extracellular DominationSignal, 148, from cell 122 then interacts with DominationSignalReceiver, 140, on the surface of cell 120, equation 9 (EQ 9) will produce Dominated molecules, 150, and GrowABit molecules within cell 120. In turn, the Dominated molecules will stimulate GENE 5 and inhibit GENE 6 of cell 120, causing an increased accumulation of DominationSignalReceiver on the cell's surface and reduce Dominator and Domination molecules. Conversely, cell 122, through its initial activation of GENE 6, will produce increasing amounts of Dominator and DominationSignal, which will inhibit GENE 5 and the corresponding production of DominationSignalReceiver in cell 122. Thus GENE 5 and GENE 6 in each of the two cells will be activated in opposing directions to create opposite, self-sustained states. In this example, their relative status is typically only reversed when one of the two cells is disrupted, say, by cell death.

As a starting point to consider the modeling of stem cells in a virtual cellular tissue simulation, a first example is now described. The virtual cells in this example do not, per se, differentiate, but instead become committed to a context supporting differentiation without possibility of reversion. The tendency of virtual cells in this example to commit to differentiation arises as a change in the relative status of neighboring cells that supports differentiation without possibility of reversion.

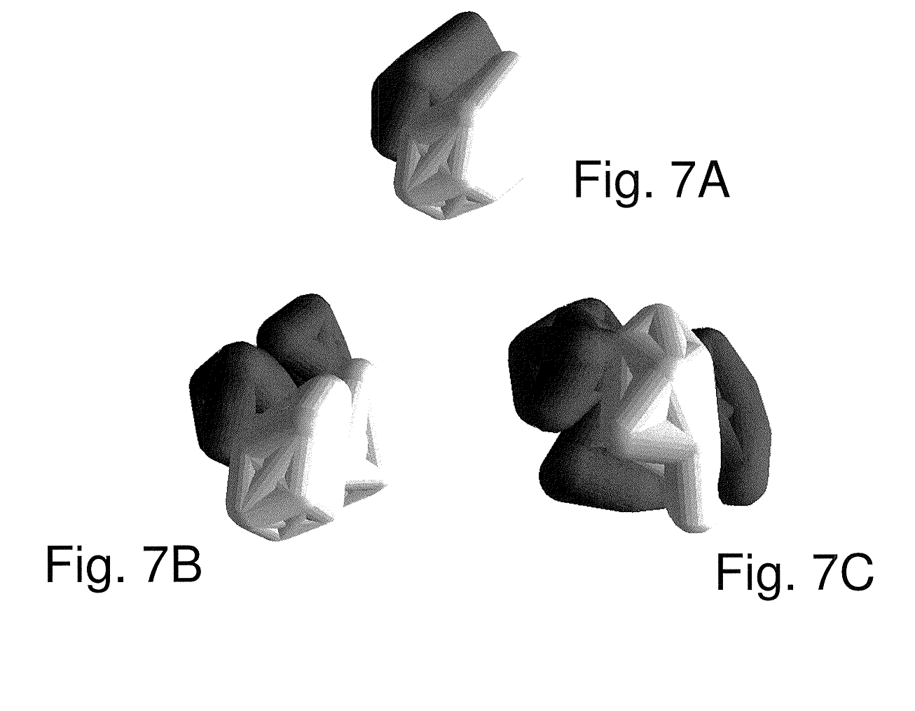

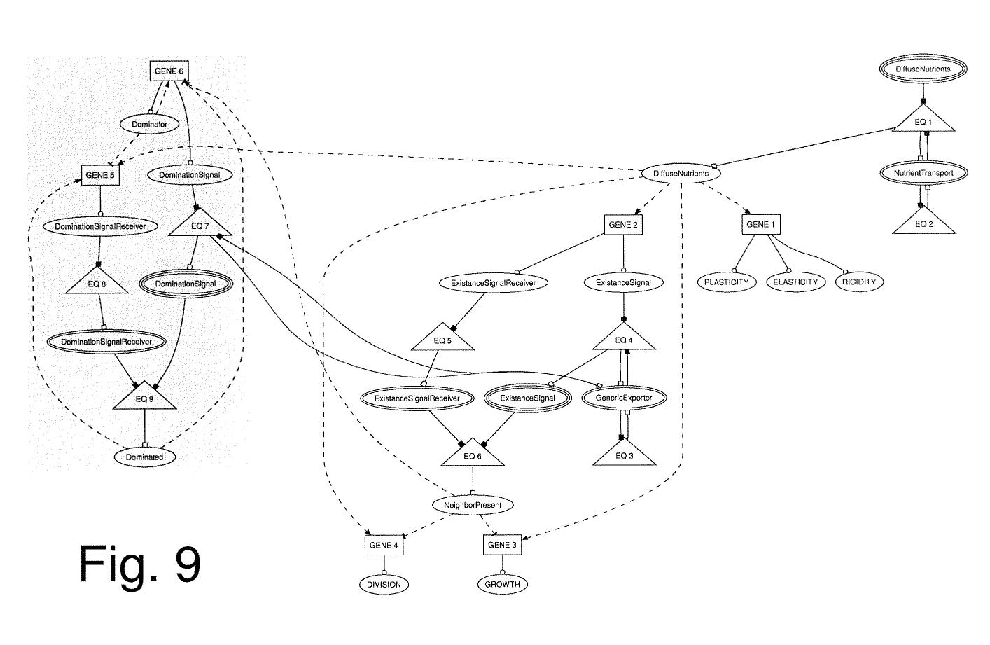

In the two- and four-cell clusters shown in FIGS. 7A, 7B, and 7C, the initial virtual cell with a prescribed genome is placed into a virtual environment that has specific molecular interactions defined, where the emergent signaling and gene regulatory network (SGRN) for this model is discussed below with respect to FIG. 9.

In FIG. 7A, the initial cell has divided. After division, signaling between the two cells results in one, light-colored cell establishing a state where it could retain a difference from the other, dark-colored cell and prevent that other cell from also attaining this same factor. In this model, then, each cell is influenced by the other to stay in a particular state, in this case illustrated by the cells' color. As the simulation of this simple model progresses, FIG. 7B shows each of the two cells divide separately resulting in two cells of each type. Continual cell signaling results in the new light colored cell committing to dark colored so that there remains only one light-colored cell, as seen in FIG. 7C.

This mechanism for differentiation is not complete with regard to biological stem cell maintenance in living tissue, but it does illustrate a simple starting mechanism from which to create such a stem cell model. In this way, some basic pathways for abstracted virtual molecular interactions can be studied to better appreciate the dynamics of such a precursor model.

The dynamics of the system having the genome and chemistry equations can be analyzed using the SGRN diagram in FIG. 9.

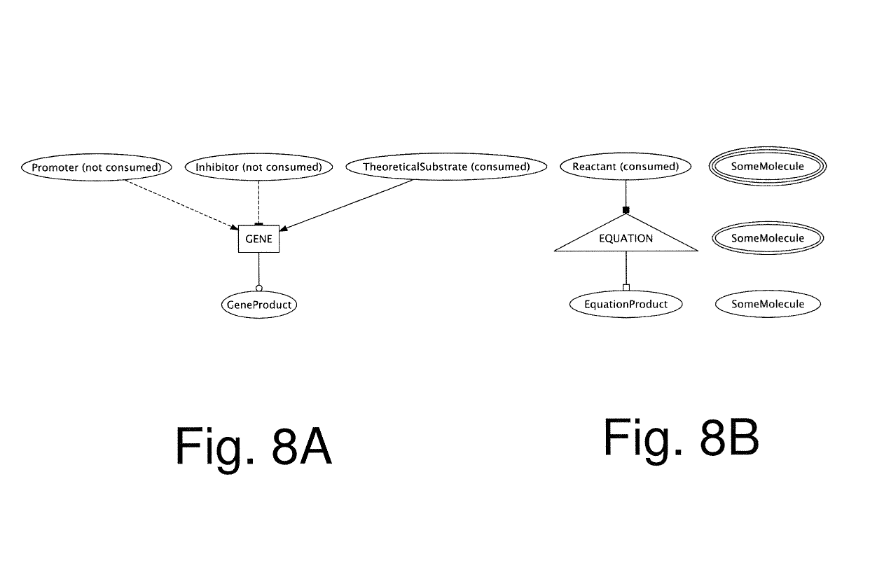

The key for interpreting the SGRN diagram is illustrated in FIGS. 8A and 8B: As seen in FIG. 8A, a gene, represented by a square box in the SGRN diagram, may be acted upon by a variety of molecules, indicated by single-line ovals. A dashed line with an arrow indicates a promoter that is consumed, a dashed line with a tee indicates an inhibitor that is not consumed, and a solid line with an arrow indicates a substrate that is consumed. The gene product is indicated by a solid line terminating at an open circle.

The legend in FIG. 8B represents a chemistry equation. Reactants consumed by the chemistry equation are indicated by solid lines terminating in solid boxes. Products of the chemistry equation are indicated by solid lines ending in an unfilled box. FIG. 8B also shows three ovals representing molecules: those with a three-line perimeter are extracellular molecules, two-line perimeters are molecules considered to be on the cell surface, and single-line perimeters are for molecules internal to a cell.

With continued reference to the example system under discussion and its SGRN diagrammed in FIG. 9, extracellular DiffuseNutrients are available in the environment from a molecular source describe in the <Shade> section of the configuration file given below. In this example and indicated in the upper right of FIG. 9, the shade produces DiffuseNutrients into the extracellular environment and so are external to any cell. The molecular interaction equation “EQ 2” will move the NutrientTransport already in the initial cell (as part of its initial chemistry; see configuration) to the cell's surface, where they can react in “EQ 1” with DiffuseNutrients to bring the external nutrients into the cell.

Once inside the cell, DiffuseNutrients (indicated in FIG. 9 with a single perimeter) interact in a variety of ways. They can promote “GENE 1” to produce internal adhesion factors RIGIDITY, PLASTICITY, and ELASTICITY to maintain the cell cohesion. Likewise, DiffuseNutrients also promote four other genes: “GENE 2”, “GENE 3”, “GENE 4”, and “GENE 5”.

Shown in the lower middle of FIG. 9, surface GenericExporter, continually replenished by “EQ 3”, is a reactant in “EQ 4” with the ExistanceSignal, expressed by “GENE 2”, to move the ExistanceSignal outside the cell. That is, GenericExporter serves as a catalyst for transport of the molecule to become a signal to other cells. Once outside, it can be used in reactions with other cells via “EQ 6”.

This description so far covers basic cell metabolism (growth, division, etc.) and broadcasts a signal to other cells of a given cell's presence, all details ancillary to achieving a differentiation context. The shaded portion of the SGRN diagram in FIG. 9 is focused on this differentiation context. Its development supports a negotiation via signaling between cells such that one cell takes on a specific state and resists later differentiation while surrounding cells maintain their differentiated context.

The presence of neighbor cells, determined through “EQ 6”, promotes “GENE 6” to express both Dominator and DominationSignal molecules. Dominator both amplifies the promotion of “GENE 6”, and so creates a self-reinforcing signal loop, while inhibiting “GENE 5”.

With surface GenericExporter, “EQ 7” moves the DominationSignal expressed by “GENE 6” outside the cell. For cells receiving external DominationSignal, “EQ 9” will produce internal Dominated molecules. These Dominated molecules both inhibit “GENE 6” and promote “GENE 5”. “GENE 5” is also promoted by DiffuseNutrients. If not sufficiently inhibited by Dominator molecule, “GENE 5” will express DominationSignalReceiver which, by “EQ 8”, will be moved to the cell surface, interacting in “EQ 9” to receive DominationSignal from other cells.

Therefore, the more a given cell produces Dominator, the more it will influence other cells via DominationSignal. The more DominationSignal a cell receives, the more Dominated it will have internally and so inhibit its production of Dominator molecule. In the case of two cells, as one cell progressively sends more DominationSignal to the other cell, they will settle into their opposing states, thus having separate propensities to differentiate and to maintain these differences.

Daughter cells from cells producing high DominationSignal amounts begin with some accumulated Dominator and DominatorSignal molecule and remain predisposed to continue producing high DominationSignal. Likewise, daughter cells from cells with high Dominated amounts will also continue with high Dominated amounts. As between the first two cells, new cells with high Dominated amounts negotiate until one begins producing high amounts of DominatorSignal, again leaving only one cell with high Dominated amounts.

The resulting cell with high Dominated amounts now lacks the context to later differentiate. Its surrounding cells have signaled that it should remain undifferentiated and that those surrounding cells will go on to differentiate if so stimulated.

The system may employ virtual cells with a variety of virtual genomes, as long as basic functions for cell actions, cell signaling and differentiation are available, where the GENES 1 through 6 above are representative of a basic genome. Similarly, chemistry equations 1 through 9 above are representative of a basic set of chemistry interactions associated with cellular transport, decay or renewal of molecules, and molecular interactions. Examples 1 through 3 below describe three different virtual tissue systems involving different genomes and chemistry equations, where the SGRN shown in FIG. 9 shows the interactions of genes and chemical-interaction rules in Example 1 for a simple tissue model having cells committed to differentiation.

### D. Physical Constraints

This section discusses the representation of virtual cells, as fixed spheres, free spheres or bags of marbles; and the calculation of adhesion forces applied between and among cells, and where cells are composed of multiple linked spheres, between and among the intracellular spheres.

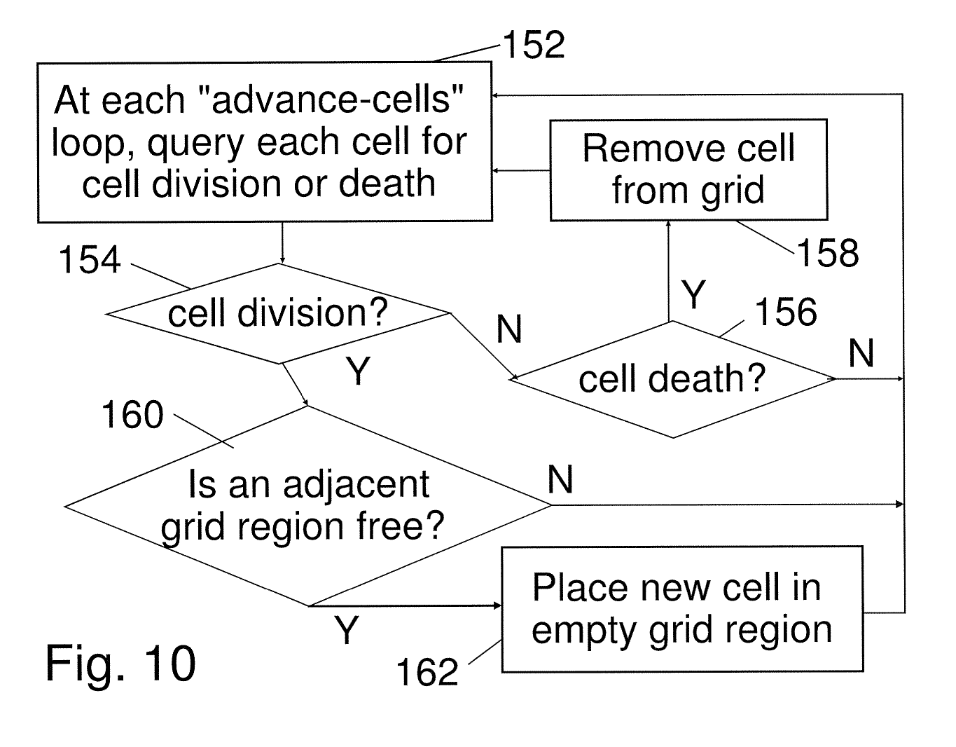

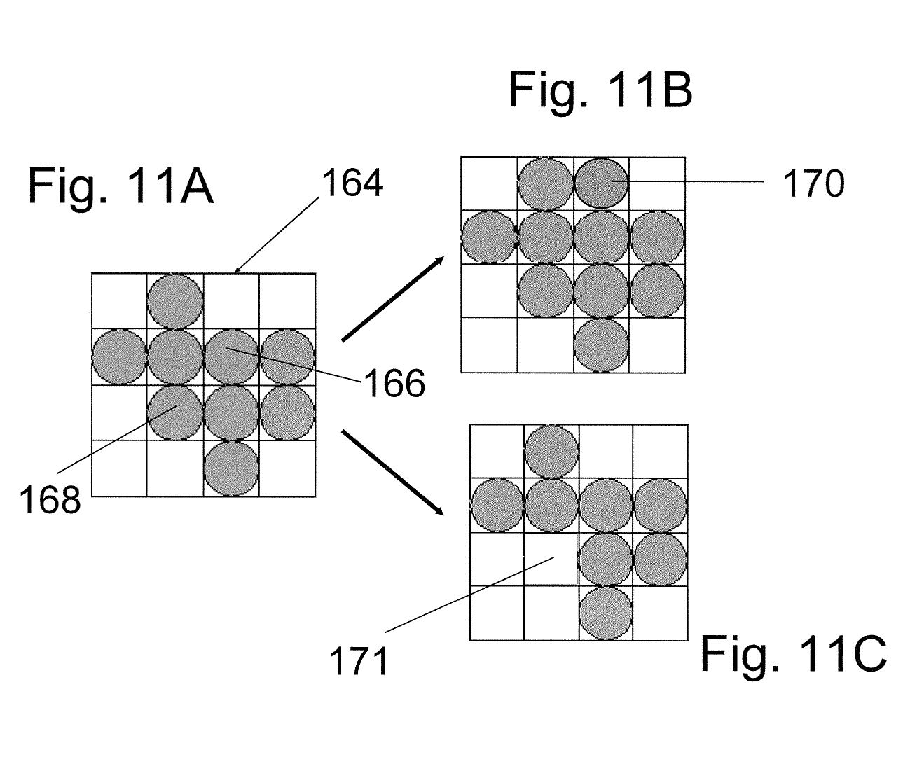

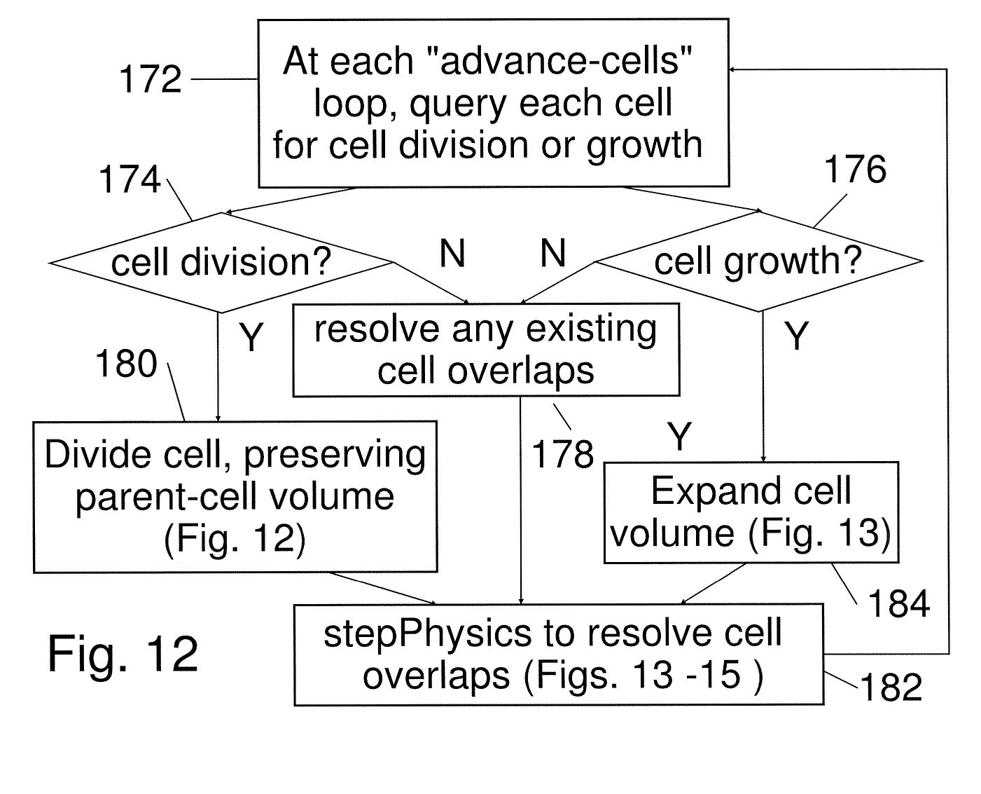

D1. Grid arrangement of cells. In one general approach, modeling of virtual phenotypes by the ontogeny engine may be performed using a discrete-based environment space organized as a three-dimensional, uniformly divided grid, called “Grid Space”. Uniform spherical shapes represent the cells, with one such spherical cell possible for each individual grid location. Therefore, adjacent cells of this kind are a fixed distance from a given cell and can only be in any of the 26 adjacent locations. An overview of the operation of Grid Space is given in FIG. 10, and illustrated in FIGS. 11A-11C. These steps are part of the “stepPhysics” routine shown at 46 in FIG. 3, and as part of each “advance-cells” loop, shown at 36 in FIG. 3 and, more specifically for this representation, at 152 in FIG. 10. As seen in FIG. 10, the program queries each cell during an “advance-cells” loop, at 152, for a cell-division or cell-death event. If a cell-division event has occurred during the loop, at 154, the program then asks whether an adjacent grid location is empty and so available, at 160. If an adjacent location is available, a new cell is placed in that previously empty location, at 162.

For example, with the configuration of cells in the 4×4 grid shown at 164 in FIG. 11A, assume that the cell marked 166 is to divide. The location identified at 170 in FIG. 11B is identified as an empty, adjacent location which can accommodate a new cell from the division. As all cells in this approach are of uniform size and in fixed locations, daughter cells are immediately equal in size and mass as parent cells. If there is no empty adjacent location available, the program takes no action, and returns to the top of the loop. If, say, the cell marked 168 in FIG. 11A is marked for death, the program removes that cell from the grid, as indicated at 171 in FIG. 10C.

The Grid Space approach allows basic cellular ontogeny simulation without the increased complexity of a more realistic environment space. Basic cellular division, cell signaling, and phenotype evolution can rely on simplified calculations such as space available for division or discovery of cellular neighbors. However, Grid Space is limiting with respect to certain features found in living systems. For instance, if a cell is smaller than the fixed grid location volume, that cell can not be in contact with other cells as it would in a more flexible model. Since cell size obviously varies in vivo, a living cell may have more than eight smaller adjacent cells or fewer than eight larger neighbors when considered in two dimensions: such configurations are not possible with such a simple Grid Space approach.

It is also feasible to consider other discrete space variations than the Grid Space description above. Grid locations can be made more granular allowing an individual cell to cover multiple locations but with each location allocated to at most one cell, or the shape of the grid organization can be changed from cubical locations to allow greater sphere packing and so potentially vary adjacency. Further, non-spherical shapes can exhibit different patterns of adjacency than are possible with simple spheres. However, these variations reduce the approach's simplicity.

D2. Free arrangement of cells. The next level of multicellular tissue development simulated by the ontogeny engine is more accurate with regard to living biological cell groups. In the “Free Space” approach, cell positions are not constrained to a fixed grid using discrete coordinates, but can be instead specified in real numbers and so can move throughout a general space.

For Free Space, the following consideration must be answered: (i) locating vacant, adjacent positions where cell division can place daughter cells; (ii) detecting cell boundaries so that cell bodies do not simultaneously occupy the same space; (iii) moving cells within Free Space, (iv) adhering cells to one another so that some cells are considered attached; (v) locating neighboring cells for exchange of cell signals; and (vi) shaping cells, where Free Space allows for non-spherical cell shapes.

In one embodiment of the ontogeny engine, when cells divide as in biological cell cytokinesis, the mass of the resulting divided cells equals that of the original cell. If division is symmetric, each daughter cell is approximately half the size of the parent and the two new cells occupy roughly the same space as the original cell [Alberts 2002]. Since the division halves the mass into two new cells, these cells must subsequently grow to reach the size of their parent cell.

By dividing virtual cells in the same way as living cells, cell placement can be realistically achieved in Free Space. To improve fidelity to biological cell division, growth and division are separated as cell actions and computational issues arising in Grid Space regarding adjacency and vacancy are circumnavigated. Most of the space for daughter cells is immediately available since it was occupied by the pre-division parent cell. To resolve adjacency, cells are placed such that adjoining point of the daughter cells is on the parent cell's previous center.

Though partially solving adjacency and vacancy, it is the cell mass, and thus its volume, that is halved (assuming constant density). A spherical cell's radius is not likewise halved. Since the volume of a uniform sphere is

$$V = \frac{4}{3} π {R}^{3}$$

where V is the volume and R is the radius, the radius of the new sphere is

$$r = \sqrt[3]{\frac{1}{2}} R \approx 0.79 R$$

which is quite larger than

$$\frac{1}{2} R .$$

A Free Space model with realistic cell division must either accept that new cells overlap by more than 25% of their radii and so simultaneously occupy the same space or they must push away from one another (possibly pushing on other adjacent cells) to resolve this overlap.

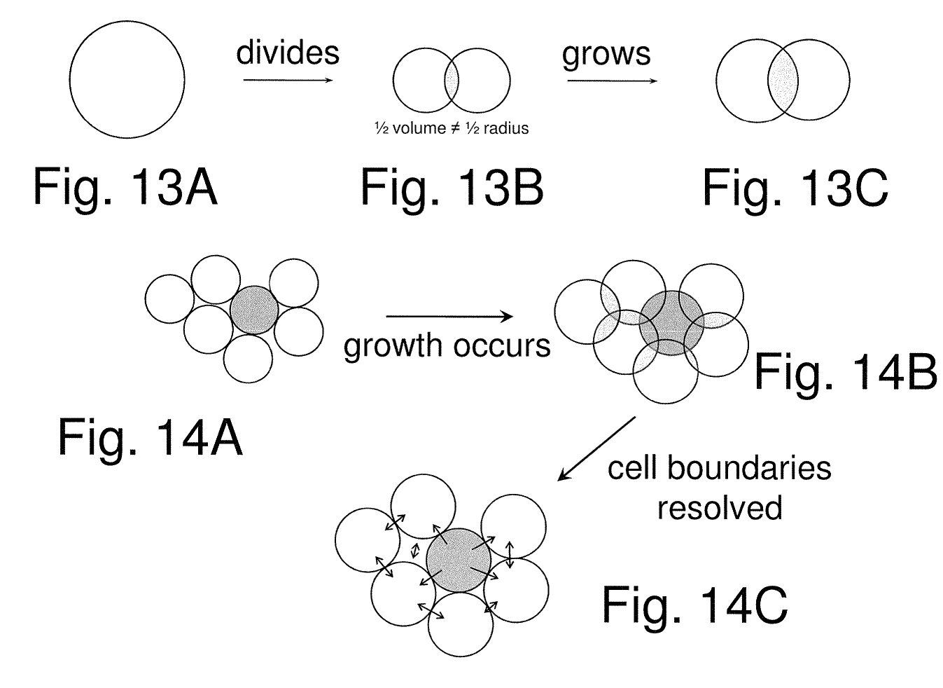

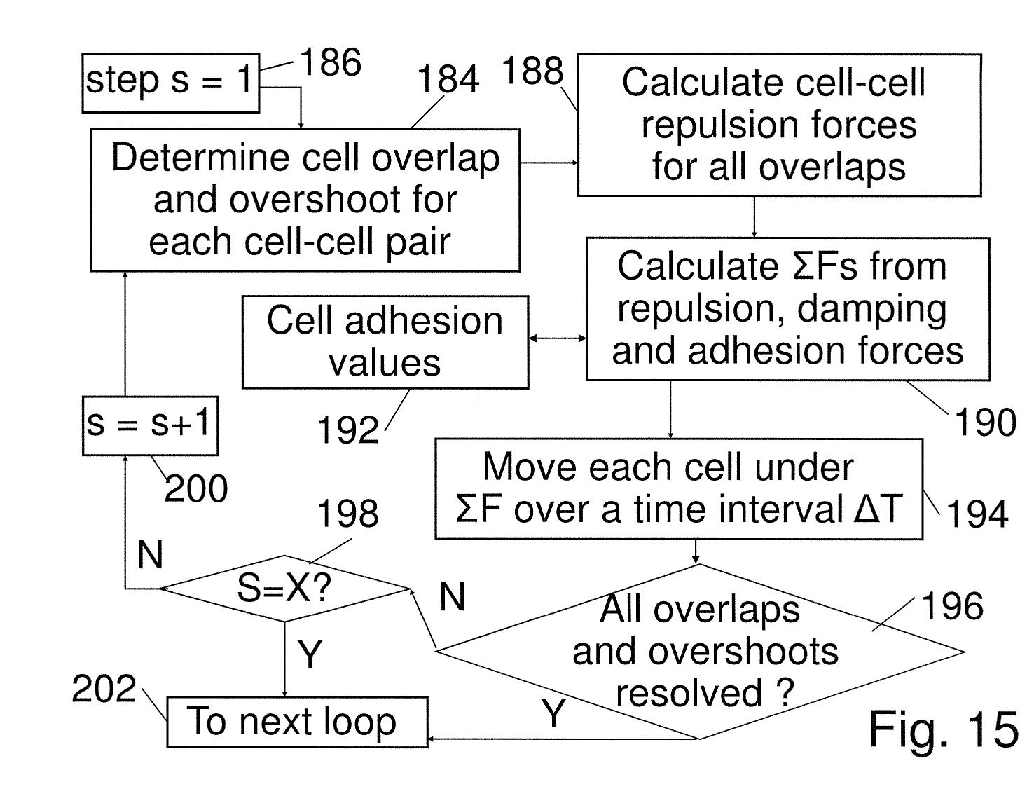

FIGS. 13A-13C illustrate cell division into two cells of equal volume, but with radii that are substantially greater than half of the parent cell's radius. As the daughter cells grow (FIG. 13C), there is progressively greater cell overlap that must be accommodated by movement of the cells away from one another, as illustrated in the FIGS. 14A-14C. FIG. 14A assumes a cluster of cells that have not been positioned to accommodate cell growth. As the cells grow, there is increasing overlap among adjacent cells (FIG. 14B), exerting mutual repulsion forces on each pair of overlapping cells. FIG. 14C illustrates how these repulsion forces are resolved by movement of the cells in the direction of the indicated arrows.

FIG. 15 shows an overview of the operation of the “stepPhysics” routine, from 46 in FIG. 3, as applied to the Free Space model. As will be more completely described below, these steps are part of a single “successive loop” operation of the system, shown at 36 in FIG. 3. In particular, in each cycle of this loop, the stepPhysics routine will carry out a predetermined number of cell position adjustments designed to reduce the extent of overlap or overshoot, so that changes in volume and position from division, growth, or death preserve overall cell shape and intercellular contact.

In the first stage, and with the step number set to 1 at 186, the routine determines the extent of cell overlap or overshoot for each pair of cells in the tissue, at 184, and calculates intercellular repulsion forces for all cell-pair overlaps, at 188. Using cell adhesion values from 192, the routine then computes the total forces acting on each cell, at 190. Each cell is then moved under the calculated forces over a given time interval, ΔT, at 194. After this position adjustment, the routine evaluates, at 196, whether the cell movement was effective to resolve all overlaps and overshoots. If not, the steps described above are repeated, through the logic of 198 and 200. The process is reiterated until all of the overlaps and overshoots are resolved, as indicated at 196 and 202, or until a given number of iterations X, e.g., X=20, has been performed, as indicated at 198 and 202. Individual aspects of the routine and its logic are detailed below.

D3. Cell movement in Free Space. In biology, cell motion may be loosely categorized as below:
translocation: passive displacement where the cell is moved across space by forces external to the cell; also called translation
locomotion: active displacement when the cell moves itself or travels across space
reshaping: modification of the cell shape, regardless of whether it remains in place

Regardless of its cause, cell overlap may be resolved by considering an opposing cell to apply an external force on the subject cell such that the subject cell is translocated. Cell translocation may also occur due to forces applied outside the phenotype. For instance, pressure from a blunt instrument such as a probe may push on cells and so motion is one effect on a cell from an external force. From a cell's frame of reference, whether the force is from an external probe or from another cell is irrelevant, it is pushed and so may be translocated.

Therefore, computational support of cell translocation is required for Free Space. Complicating a simple change in the cell's location is the ontogeny engine's application of discrete time through simulation step where each time step causes a series of operations to be applied in order (e.g., transcription, signaling). As a continuous process, cell motion must occur across discrete time steps.

Consider a path that cell A might travel. If the boundary for cell A overlaps at any point with the boundary of another cell B along that path, then the path of cell A may be altered and cell B may be displaced. Using discrete time steps, such movement of cell A might be seen as a series of jumps. A collision between cells A and B will only be noticed as long as jumps end where cells A and B overlap. One solution is to graduate the time steps such that the smallest possible translocation that might precede a collision is taken and make the effect of the time step proportionate in relation to other cells' processes (e.g., transcription). In the preferred embodiment, a fixed number of movements, say 20 (indicated as X at 198 in FIG. 15), are arbitrarily applied for every time step in the simulation. This proportion of movements to simulation steps may be refined in practice.

Cell translocation is also critical to simulation the effect on a phenotype when external forces are applied. Possible effects include rotation, deformation, displacement of the whole cellular mass, or separation of cells. The motion of a cell and the forces upon a cell must be transmitted to other cells according to the structure of the phenotype.

D4. Cell adhesion through connections. The transmission of force between cells is ignored in Grid Space since those cells did not move from one grid location to another. However, in most tissues [Alberts, 2002], cells are connected to each other in a network of physical attachments. These connections determine how cells transmit force to other cells. From the cell translocation example above, if cell A moves, another cell might be pushed because of boundary collisions. Further, if cell A moves, a connected cell B may be dragged along to stay in contact with cell A.

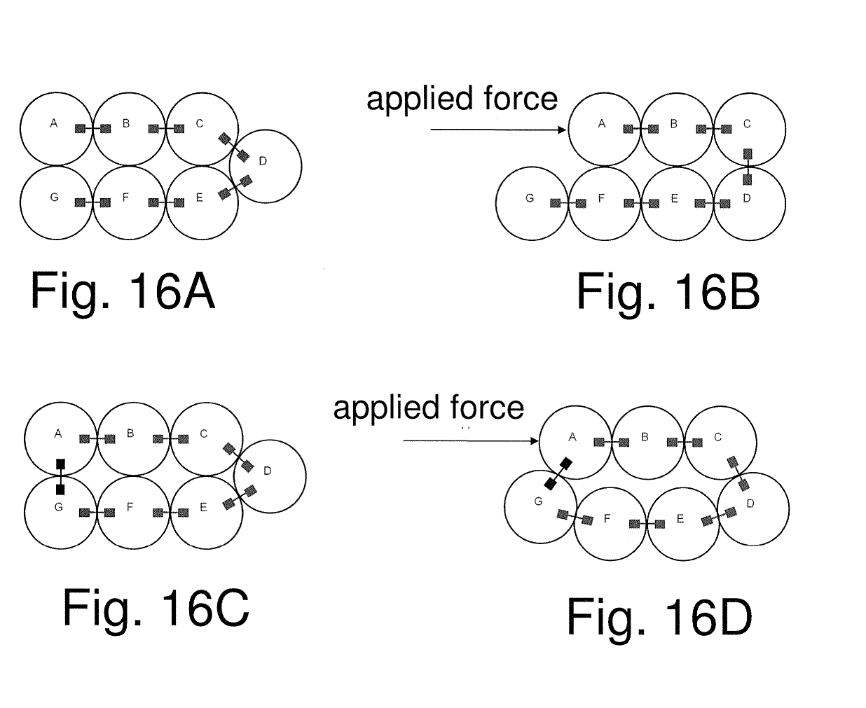

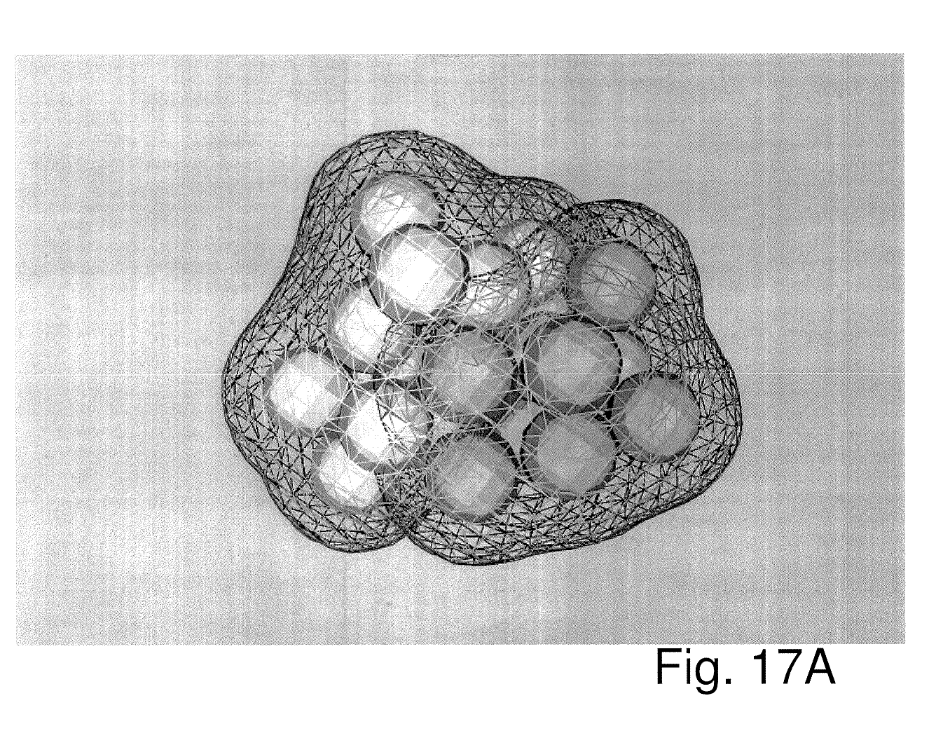

The notion of cell adhesion helps when considering the transmission of force between some cells while not applying it to others. Consider the first scenario depicted in FIGS. 16A and 16B: if a string of cells, labeled A through G are connected, but the string of cells is bent such that A and G have immediate physical proximity but are not directly connected, then pushing A away from G will not directly affect G. Instead A would drag B along with it and B would drag C and so on. Eventually G might be dragged along, but only when F pulled on it.

In a second scenario depicted in FIG. 16C and FIG. 16D, adding adhesion between A and G changes that behavior and how the other cells are affected by the same applied force. Such adhesion connections can be applied from one cell to many cells. Cell A might be directly connected to other adjacent cells B, C, and D, and so it may take more force to pull on A now that three other cells would also have to be dragged.

Connected cells may also have other connections, increasing the resistance to translocate. In an undepicted scenario, pairs of cells may have multiple connections between them rather than just one large connection. This is analogous to some adhesion found biologically where cells zipper themselves together with several connections, each added as the cells strengthen their mutual bond [Alberts, 2002].

During cell division, adhesion connections need to be resolved. This is supported by considering the proximity of the associated cell's surface to the surfaces of the new daughter cells. Upon division, if the previously associated cell is closer to the surface of one of the daughters than the other, that daughter is assigned the connection. In the case where the proximity is approximately equal, both daughters are assigned a connection to the associated cell.

Adhesion connections can be rigid like metal rods or flexible like bungee cords. If the connection is rigid and there is no inertia or other applied forces, pushing a cell also transfers that force to any adhered cells. Thus pushing a peripheral cell might cause the whole phenotype to rotate. Pushing a center cell might move the phenotype across the space intact and otherwise unchanged. However, if the adhesion is flexible, then the phenotype might only deform with some of its cells unaffected and it would take a much larger force to affect cells further away from the point of contact.

D5. Generalizing connections. This approach to connection can model a phenotype as a mathematical graph where the cells are vertices and the connections are edges. Thus, a cyclic undirected graph can then be considered, allowing operations upon cells using graph theory techniques such as shortest-path algorithms.

Other cell associations can be modeled as connections separate from adhesion connections. Cell signaling can be modeled as traveling along signal paths where a signal connection exists. As in biological cell arrangements, signals can be transmitted to cells that are not immediately physically adjacent. Such a graph is a cyclic directed graph separate from the adhesion graph: the vertices would be the same cells, but the edges would be the applied signal connections instead of adhesion connections.

Another use of these abstracted connections is the calculation of cell position. If a cell tracks its absolute position in the general environment space and then moves, its location must be recalculated as a function of that translocation across the total space. Since the cells in a phenotype move as part of that phenotype, their frame of reference is that of a component of that phenotype.

Rather than having each cell track an absolute location, the connections that associate cells can record the relative position between the cells. For instance, if two cells are connected by a positional connection, that connection can store the distance and direction that the cells are from one another. In this way, all cells can have a position relative to other cells. By treating one cell as anchored to an absolute position, absolute positions can be calculated for the remaining cells. Thus, if a single cell is moved such that the whole phenotype moves with it, only the absolute anchor position need be recalculated; the relative connections need no adjustment.

D6. Cell signaling and neighboring cells. A cell in the ontogeny engine sends a signal by releasing virtual molecules to its neighbors. If the neighbor has receptors for the molecules it is presented with, it absorbs the signal and processes it. In Grid Space, such signals are simply applied within a specific radius from the cell's center: individual grid locations within this radius are readily calculated. In Free Space, a cell's neighbors cannot be determined with a simple check of enumerated adjoining spaces. Instead the same approach used for cell overlap resolution is applied: each cell in the phenotype is checked to see if it is a neighbor based on the distance of its surface from that of the other cell. If this separation of the two cells is within the configurable threshold, then they are neighbors and can share signals.

D7. Cell shaping. To further improve fidelity with living multicellular tissues and cultures, it is critical that the ontogeny engine support cell shaping. If two rigid, uniform spheres are positioned such that their shapes overlap, it is reasonable to treat this as a collision and resolve the overlap. However, most living cells do not have rigid shells, but have some plasticity and can deform. Further, through differentiation, cells adopt shapes that best fit the function they serve.

The various approaches to computing the shape of cells may be categorized as follows:

| | |
|---|---|
| externally | a cell's shape is a function for its surface such as a sphere or |
| specified: | complex equation; shape is imposed upon the cell. |
| calculated | the cell has no prescribed shape, but rather is calculated when |
| ad-hoc: | needed. An example might be the rendering of two cells close |
| | together: from an assumption of spheres, choose a midpoint |
| | between the centers of the cells against which to flatten the |
| | sides of the cells. |
| internally | the cell's shape is maintained through internal data storage |
| derived: | as a function of its own behavior |

External specification of cell shape requires that known shapes be catalogued and defined rigorously. Such cataloguing inherently limits the range of cell shapes possible and removes the possibility that unconsidered or unrecognized cell shapes might better solve a phenotype development challenge.

Ad hoc shape calculation treats shape as completely dynamic, existing only as long as the influences on it continue. Cells then do not have their own shape but instead adopt whatever shape is most immediately useful. While some living cells may be very plastic, many cells (e.g., bone, skin) have a shape that, while deformable, are essentially static and continue for the duration of the cell's existence [Alberts, 2002].

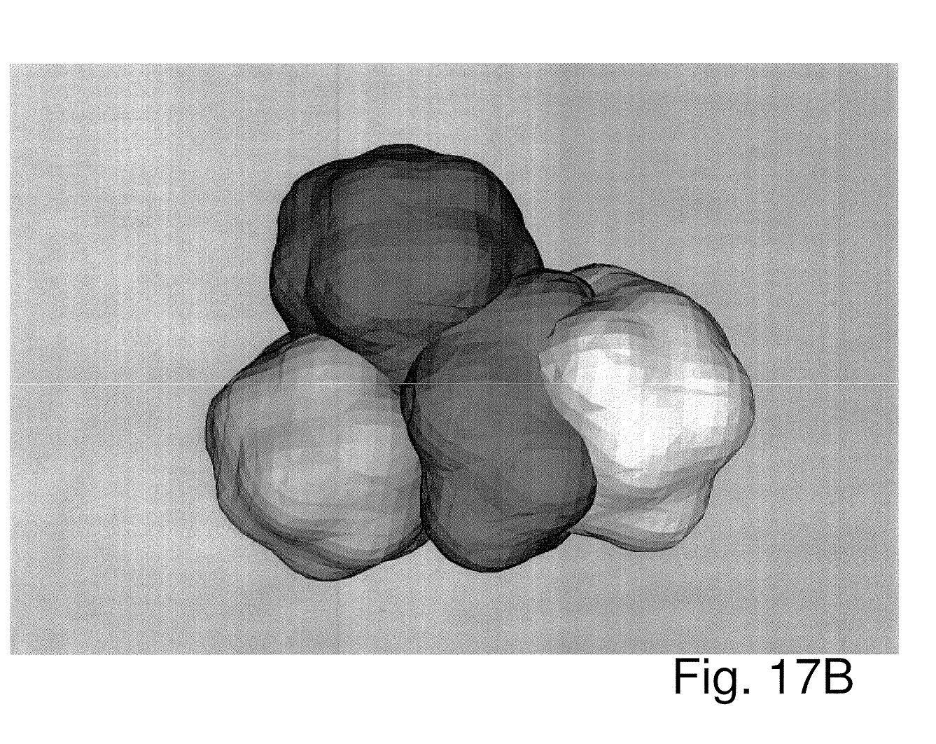

Internally derived shapes promise the most fidelity with living cells. Cell shape can be modeled as collection of hard spheres held together with varying cohesion in the same way. FIGS. 17A and 17B show such hard spheres as if bags of marbles. FIG. 17A depicts the bags as wire-framed envelopes representing adjacent cells. The shapes of these cells are determined, as will be detailed below, by intracellular interactions among the marbles in each cell, and by extracellular interactions among marbles of adjacent cells. FIG. 17B depicts fully visualized bags without the internal marbles directly visible.

As an analogy, shifting a closed bag of marbles around moves the marbles around each other: the enclosing bag's shape is given from the arrangement of the enclosed marbles. Depending on forces imposed externally onto the bag (and thus the enclosed marbles) and how tight the bag holds the marbles together, the bag may become roughly spherical, fairly flat, or some arbitrary shape. For a pile of many such bags, each bag takes a form based on the surrounding bags and how each bag holds its marbles as cohesive collections. Forcing rigid connections between some of the marbles, such as with glue, constrains the potential shapes the bag can take.

This bag-of-marbles model is abstracted to remove the enclosing bag as a design construct, instead holding the marbles together in cohesive collections via virtual adhesions. The resulting shape of the marble collection is derived from whichever marbles are then exposed at the collection's surface. As before, forces applied to such collections cause the contained marbles to shift around until equilibrium is reached.

As in the previously described Free Space adhesion implementation, adhesions exist between sphere centers, but instead of uniform spheres representing whole cells, the spheres represent the proverbial marbles bound together to shape cells. These constituent spheres are referred to as subspheres. For each step of ontogenous simulation, adhesions influence the arrangement of the subspheres.

Two methods of adhesion creations have been considered: completely-connected and proximity-based. When subspheres in a cell are completely connected, cell shapes tend to be spherical and highly coherent. When adhesions are created only between subspheres within a proximity threshold, cell shapes are frequently irregular and less coherent. Each of a cell's subspheres must be connected to at least one other intracellular subsphere, unless the cell is made up of only one subsphere.

Unlike adhesions between cells, these intracellular adhesions are not intended to faithfully model physical forces and constraints but more as a design mechanism from which to derive cell shape.

Again as described above in D5, the bag-of-marbles approach may be further abstracted as a graph with subsphere centers as vertices and center-to-center bonds as edges.

Biologically, cell size is constrained by the physical characteristics of the cell membrane and other necessary structures. In the bag-of-marbles model, the minimum cell size is that of a single subsphere. For multi-subsphere cells, a single subsphere determines minimum cell thickness. Single-subsphere cells grow to multi-subsphere cells by the addition of subspheres. The cell's mass is taken as the sum of the contained spheres' given mass. In general, the cell size can be controlled by the number of subspheres and by the size of those spheres: many smaller spheres allow more resolution of shape while fewer, larger spheres reduce computational cost and range of shape variety. The preferred embodiment keeps subsphere size uniform across all cells, but this is not necessary, although calculations will be eased if all of a given cell's subspheres are of uniform size with or without regard to those of other cells.

All collisions of subspheres, whether within or between cells, are simply between the involved spheres and so are handled identically. The effect on the shape of the cell is derived then from the resulting arrangements. This approach simplifies the simulation.

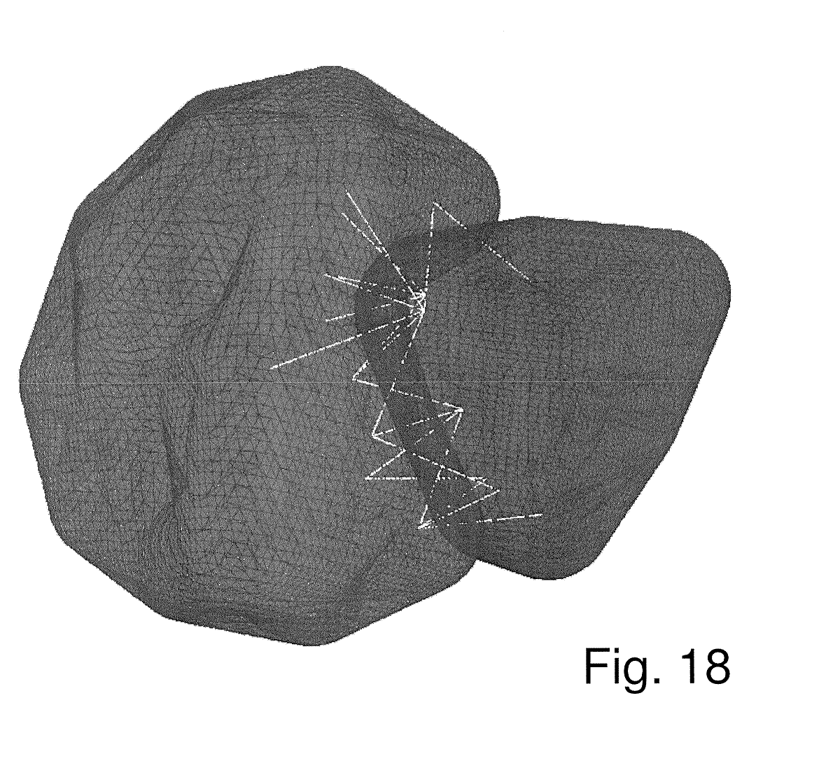

Although intracellular adhesions need not be faithful to real physical behavior for realistic modeling, fidelity is required with regard to adhesion between cells. Therefore, intercellular adhesions follow separate, though similar, logic than adhesions within cells. Nonetheless, intercellular adhesions are still anchored to cell subspheres. Cells pressed together are thus capable of forming many adhesions, creating an adhesion “contact patch”, depending on how many of their contained spheres come into contact. Such a contact patch is shown in FIG. 18 for two cells that are each shaped using the bag-of-marbles model, where the contact lines in the figure represent lines connecting the centers of each adjacent pair of spheres.

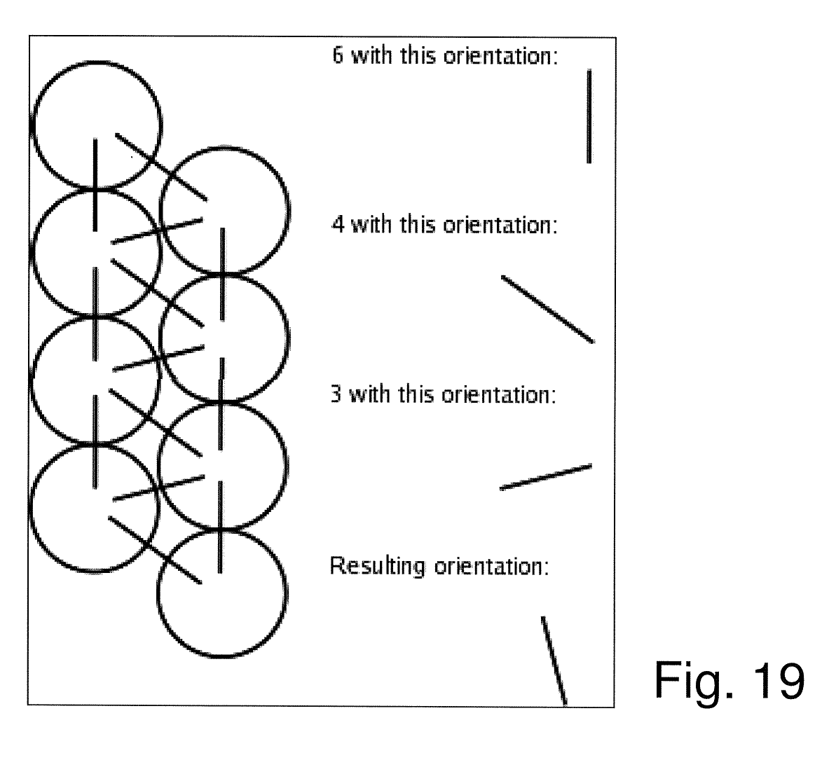

Similarly, lines connecting subcells as shown in FIG. 19, can help determine cell orientation. The right side of the figure summarizes the orientations of these connecting lines. From this summary, the cell's overall spatial orientation can be evaluated for later application, analysis or reporting, such as determining a direction for cell division.

Without an internally maintained skeleton, there is no need for cells to have a separate coordinate system from that of the overall simulation context (i.e., environment). Rotation and translation of cells are simple derivatives of the interactions between the subspheres. A cell's orientation need only be calculated for specific actions such as cell division.

When a cell is to divide, its center of mass is determined. A partitioning plane is chosen to intersect the center of mass with a random orientation. Based on their relation to the dividing plane, the parent cell's subspheres are then allocated to the daughter cells. Any existing intracellular adhesions that cross the dividing plane are removed. Therefore, if division is to take place, the cell must have at least two subspheres.

Until visualization, the only constructs are the subspheres and their associating bonds: simulation of ontogeny involving cell shape is complete with only these elements. However, this is not satisfactory for visualization. To represent cells visually, an envelope is rendered around each cell's collection of subspheres. Thus, this expensive computation for the rendering of an arbitrary shape is deferred until necessary. Using various calculations for this visual envelope, cells may be made to appear more lumpy or smooth as aesthetics warrant.

An embodiment including a bag-of-marbles approach can support the following refinements:
Differences in intracellular adhesions can indicate cellular differentiation as cells undergo continuing development.
Cell energy levels can be integrated with intracellular adhesions: intracellular adhesions can lengthen (i.e., loosen) as cell energy increases. High-energy cells will be more malleable and become more rigid as they lose energy.
Bond stability, the likelihood of two subspheres to continue to adhere, can be treated as a separate factor from energy and so independently control cell cohesion. The higher the cohesion, the more spherical it may tend to be. Stability and adhesion strength (or lengthening) will combine to determine cell rigidity. Further, a cell might be easily deformable (via lower adhesion strength) while retaining a shape memory (via stability) while another cell could resist deformation but readily accept the new shape when deformed.
If subspheres are considered as having mass at uniform density, then the density at which the spheres are held to one another by adhesions allows for varying density of the overall cell.
Cell orientation may be derived from the orientation of the vectors between all subspheres' centers (i.e., a fully connected graph of the marbles). Such orientation may be applied to influence the cell's plane of division. FIG. 19 depicts the determination of cell orientation from intracellular sphere relations.

### E. CellSim Configuration File

To illustrate how the virtual genes, chemistry equations, environmental parameters, and other settings are specified to the ontogeny system, it is useful to consider a configuration hierarchy.

In the preferred embodiment, configurations are written XML. An XML file consists of nested pairs of bracketed tags. Each opening tag has a matching closing tag. A closing tag has the same name as the opening tag but the name is preceded by a forward slash (“/”):

<SomeTag>
more nested tags or data
</SomeTag>

Tags without nested content can be opened and closed with separate tags or in a single tag:

### <SomeTag/>.

Comments for the reader of the configuration file are ignored by the ontogeny engine. These are introduced with double forward slashes (“//”):

// The following tag indicates something interesting.
<SomeTag>
more nested tags or data
</SomeTag>

Where periods of ellipsis (“ . . . ”) appear in the following description within opening and closing tags, subordinate tags may be nested. That is, the tags surrounding the ellipsis may contain subordinate tags, whose detail is not relevant to the immediate description but may be described elsewhere as appropriate.

Editing of the XML configuration file is conventionally done with an ASCII text editor as is commonly done for computer configuration files.

In the preferred embodiment, all configuration files have <CsIndividual> . . . </CsIndividual> as the root tag The tags detailed below are subordinate to the <CsIndividual> tags.

E1. DevelopmentEngine options cue the server to watch for certain events and pause when they are reached. Each stopping condition is used only once. The user has the option to continue the simulation after a stopping condition has occurred. In the example below, the simulation will run until the earlier of 2000 simulation steps or until the phenotype has been stable for 1,000 steps.

```
<DevelopmentEngine>
  <MaxSteps>2000</MaxSteps>
  <StableSteps>1000</StableSteps>
</DevelopmentEngine>
```

E2. The MoleculeCatalog provides translations between named aliases and molecular signatures and properties. Each molecule has a name, a two-part signature, a decay rate, and an indivisible flag. The name is for ease of user reference during simulation or configuration; the signature is described in more detail below; and the decay rate describes a how quickly a molecule is reduced and removed from the simulation as a percentage (0.1=10% of the molecule per simulation step). If a molecule is indivisible, it cannot be divided between daughter cells during division, but must instead be allocated to only one of the two.

By default, the decay rate is set to an arbitrary value (“0.1” in the preferred embodiment for a 10% decay per step), and the indivisible flag is set to False. MoleculeA in the below example uses these defaults, so it only matches the alias ‘MoleculeA’ with its signature ‘[10, 10]’. MoleculeB specifies a decay rate of 0.2. MoleculeC does not decay and is indivisible: upon division, one daughter cell receives the entire amount of MoleculeC from the parent.

A molecular signature consists of an Indicant and a Sensitivity value. These values are used to calculate the Affinity between molecules and genes. The Indicant is the molecule's interactive identity and the Sensitivity affects how much Affinity the molecule has for other molecules or genes with different Indicants. An exact Indicant match between a molecule and gene yields a maximum Affinity of 1.0. As the difference between Indicants increases, Affinity decreases at a rate determined by the Sensitivity values of the molecule and gene. A molecule with a Sensitivity of 0.0 matches any gene; likewise, a gene with a Sensitivity of 0.0 matches any molecule. As Sensitivity increases, Indicants must match more closely for there to be significant interaction between molecules and genes. Molecules A, B, and C below have very high Sensitivities (10) and call for a nearly exact Indicant match with a gene to have any effect. MoleculeD, however, with a low sensitivity of 0.5, could interact significantly with genes having Indicants differing by as much as 5 from MoleculeD's Indicant.

```
<MoleculeCatalog>
  MoleculeA [10, 10];
  MoleculeB [20, 10] 0.2;
  MoleculeC [30, 10] 0.0 I;
  MoleculeD [40, 0.5];
</MoleculeCatalog>
```

E3. Simulation. The Simulation tag encloses parameters for simulation conditions, as described below in Subsections E.3.1 to E.3.7:

### <Simulation>

. . .

### </Simulation>

E3.1. Signal. The choice of Signal method and Signal settings determines how all signals originating in cells will be distributed between non-contacting cells. <FallOff> signaling allows signals to decrease in concentration in a smooth curve as distance increases. The meanings of settings for <FallOff> signaling are discussed under <Shade> below. <Local> signaling presents a fully concentrated signal across the specified separation distance, but none beyond. <Droplet> signaling diffuses signals through fluid droplets when fluid droplets are present in the simulation. <Linear> signaling decreases signal concentration linearly with distance.

```
<FallOff>
  <Exponent>0.5</Exponent>
  <Modifier>2.0</Modifier>
  <Radius>1.0</Radius>
  <Threshold>0.05</Threshold>
</FallOff>
<Local>
  <Separation>0.2</Separation>
</Local>
<Droplet>
  <Separation>0.1.25</Separation>
</Droplet>
<Linear>
  <Slope>2</Slope>
</Linear>
```

E3.2. MaxInterAdhesionLength. Adhesions between two cells break if they exceed the specified separation distance. The example below specifies a separation distance of 0.25. This parameter primarily accounts for small separations that potentially result from incomplete physics resolution rather than breaking of an adhesion. In general, cell flexibility via Rigidity determines when cell adhesions are broken.

### <MaxInterAdhesionLength>0.25</MaxInterAdhesionLength>

E3.3. SingleAdhesionRule. If the binary parameter <SingleAdhesionRule> is configured as 1, each sphere of a cell may adhere to only one sphere of one other cell, regardless of contact with other spheres of other cells. When it is configured as 0, the number of intercellular adhesions between spheres is limited only by physical contact constraints.

### <SingleAdhesionRule>0</SingleAdhesionRule>

E3.4. The Physics profile encompassed within the opening and closing tags below, addresses those parameters related to the operation of stepPhysics, and includes sections E.3.4.1 to E.3.4.7

<Physics>
...
</Physics>

E3.4.1. RepulsionMultiplier. When any two objects in the simulation overlap, a force is applied to separate them. This multiplier adjusts how strong the repulsion force will be. More significant than the absolute value of the specified <RepulsionMultiplier> is the ratio between <RepulsionMultiplier> and <DampingMultiplier>. For example, 1:2 and 100:200 ratios will result in similar collision physics. In the example below, the multiplier is set to 1.

### <RepulsionMultiplier>1</RepulsionMultiplier>

E3.4.2. DampingMultiplier. Any object has a resistance force applied opposite its direction of motion. This force is relative to the object's velocity rather than its mass or volume, so a lightweight object at a certain velocity will be slowed more rapidly than a heavier object at the same velocity. In the example, below, the multiplier is set to 2.

### <DampingMultiplier>2</DampingMultiplier>

E3.4.3. TimePerStep. <TimePerStep> relates time for physics resolution to the simulated metabolism. Smaller values specify faster metabolism relative to simulated physics resolution, and conversely for larger values. The value specified is in seconds, but has no relation to real time. Thus the reciprocal of the value specified is the number of metabolic steps per second. In this example, there are two (=1.0/0.5) metabolic steps per physics second.

### <TimePerStep>0.5</TimePerStep>

E3.4.4. MaxVelocityChange. All forces and collisions are attempted to be resolved within the simulation time allocated to each step in as few physics iterations as possible. To maintain smooth, realistic physics simulation, <MaxVelocityChange> specifies the largest velocity change (i.e., acceleration or deceleration) allowed per physics iteration before overlaps and other physics issues are rechecked. Small values improve physics fidelity at the expense of performance and conversely for large values.

### <MaxVelocityChange>0.5</MaxVelocityChange>

E3.4.5. NudgeMagnitude. This parameter specifies the force applied when a user nudges a cell during a simulation run.

### <NudgeMagnitude>3</NudgeMagnitude>

E3.4.6. Container. The growth of the phenotype can be physically constrained by specifying a container. A dish container places a virtual petri dish with the specified radius centered at the specified X, Y, Z coordinates. The dish container has infinitely high walls so the phenotype can never escape. In the example below, the “dish” is centered at coordinates 0, −3, 0 with a radius of 10.

<Container>
<Dish>[0, −3, 0] 10</Dish>
</Container>

E3.4.7. Gravity. The simulation has no gravity by default. Simulated gravity is added with the <Gravity> tag. Its value adjusts the gravitational force applied throughout the environment.

### <Gravity>0.2</Gravity>

E3.5. FixedSpheres. Fixed spheres are immovable, inert, uniform spheres placed in the environment as a physical constraint to phenotype development. Each fixed sphere is described with X, Y, and Z coordinates followed by a radius.

The example below describes two very large fixed spheres are placed above and below the center of the environment where the initial cell is placed. In effect, the cells are sandwiched between flat plates because the radius of these fixed spheres is much larger than the 0.5 radius of the cells.

```
<FixedSpheres>
  [0, −1000, 0] 1000,
  [0, 1001, 0] 1000
</FixedSpheres>
```

E3.6. Cell. The Cell tag encloses various virtual cell parameters, described below in E.3.6.1 to E.3.6.7:

<Cell>
...
</Cell>

E3.6.1. Chemistry. <Chemistry> determines how Affinity will be calculated between molecules and genes. <Default/> chemistry specifies that Affinity will follow a normally distributed bell curve.

### <Chemistry><Default/></Chemistry>

E3.6.2. Promoter. <Promoter> determines how Promotion will be calculated in gene transcription. Promotion is based on the Affinity of molecules for a regulatory gene and their concentrations.

One such <Promoter>, <Smoother> promotion, has a sigmoidal curve with 0.0 Promotion at 0.0 Affinity and Concentration, and approaches 1.0 Promotion as Affinity and Concentration increase.

```
<Promoter>
  <Smoother>
    <PromotionMidpoint>5</PromotionMidpoint>
    <Slope>3</Slope>
    <ActiveConcentration>1</ActiveConcentration>
  </Smoother>
</Promoter>
```

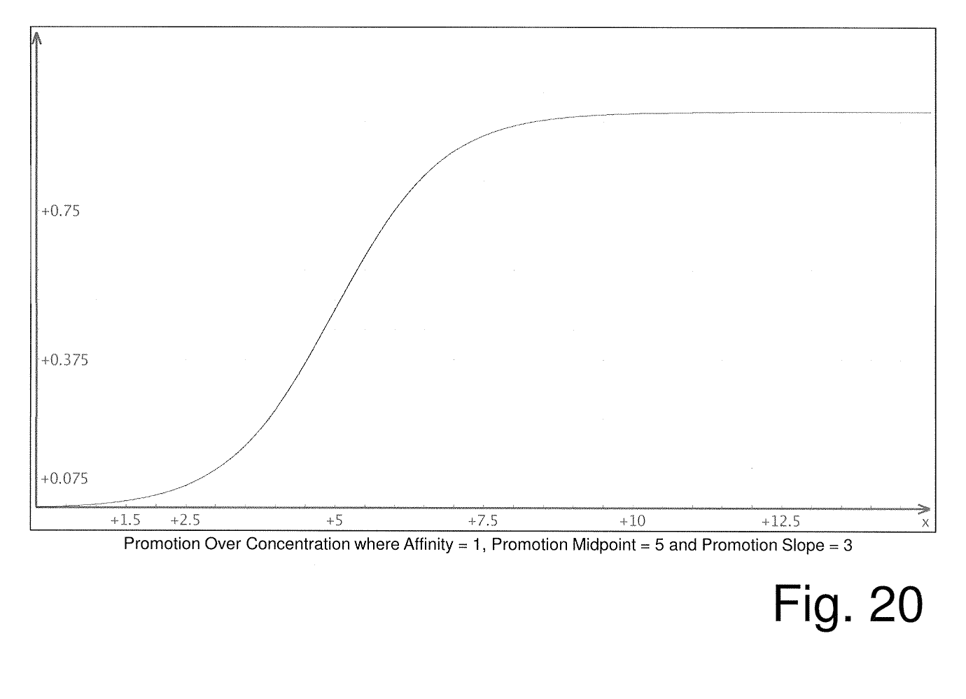

FIG. 20 depicts the promotion curve for a perfect match between a single molecule interacting with a single regulatory gene. In this case, the Affinity between the molecule and gene is 1.0. The promotion of the gene given the current concentration of the molecule is multiplied by the gene's Effect value to compute the partial promotion of the gene by that molecule. Total promotion of the gene is the sum of such partial promotions from all molecules. Where a regulatory region contains multiple genes, the promotion of the region is the sum of all constituent gene promotions.

Net positive promotion results in internal production of corresponding structural gene product equal to the net positive promotion. The volume of the cell determines how this amount affects concentration: smaller cells experience a greater increase in concentration through transcription than larger cells for the same gene promotion level.

From the example configuration above, the promotion curve in FIG. 20 has a midpoint of 5 and slope of 3. As a result, 50% promotion occurs at concentration 5 and ramps sharply from 25% to 75% between concentrations 4 and 7, with asymptotically approaching 100% at concentrations above 10. With consideration of the promotion curve, a researcher can develop intuition with practice from watching resulting molecular concentration levels to appreciate the influence any internal molecule is having on genes.

E3.6.3. InitialSize This option specifies the number of sub-spheres in the initial cell placed in the environment at the beginning of the simulation.

### <InitialSize>13</InitialSize>

E3.6.4. MaximumSize A cell may not grow to have more than the number of sub-spheres specified as the MaximumSize. The <InitialSize> may be specified as larger than <MaximumSize>: such a setting can result in zygote-like division.

### <MaximumSize>13</MaximumSize>

E3.6.5. MinimumSize. A cell may not divide if one of the equally sized daughter cells would have fewer than the MinimumSize number of spheres. The <InitialSize> may be specified as smaller than <MinimumSize>.

### <MinimumSize>6</MinimumSize>

E.3.6.6. InitialChemistry. By default, the initial cell in a simulation contains no molecules and so has no way to import molecules from the environment. <InitialChemistry> specifies the contents with which to initialize this cell. In the example below, the initial cell is primed with 80 units of Nutrient and 10 units of NutrientReceptor on its surface (as denoted by parentheses). The concentration of these molecules depends on the volume of the initial cell as specified by <InitialSize>.

```
<InitialChemistry>
  Nutrient 80
  ( NutrientReceptor ) 10
</InitialChemistry>
```

E3.6.7. Chemical-interaction rules, designated as ChemistryEquations,_are direct conversions of substrate molecules to produce molecules independent of gene transcription. The terms to the left of the equal side describe necessary reactants and must include at least one internal or surface molecule. The terms to the right of the equal side describe the products of the interaction. Any equation with external molecules as either reactants or products must have a surface molecule reactant. Refer to Section C for details on the role of chemical-interaction rules.

In the example below, the first equation specifies that internal NutrientReceptor is to be consumed to produce an equal amount of surface NutrientReceptor. The second equation specifies that external Nutrient is to be transported into the cell by surface NutrientReceptor. The surface NutrientReceptor is replaced on the product side and so acts as a catalyst in the equation. Coefficients can be specified for any reactants or products to describe proportion and amounts as demonstrated in the third example equation.

```
<ChemistryEquations>
  NutrientReceptor = ( NutrientReceptor );
  { Nutrient } + ( NutrientReceptor ) = Nutrient + ( NutrientReceptor );
  1.5 SubstrateA + 2 SubstrateB = SomeProduct;
</ChemistryEquations>
```

E3.6.7.8. DivisionRules By default, cell divisions have random directional orientation. By specifying DivisionRules, division can occur in a direction relative to the highest activity of a surface molecule. Rule choice depends on the concentration of internal or surface molecules, as modified by a positive, multiplier coefficient; single division rules must specify a positive coefficient. Directional keywords are “perpendicular”, “toward”, “away”, and “random”. For DivisionRules, “toward” and “away” are equivalent. Alternatively, directions may be specified as angles in real degrees from 0 to 180.

```
<DivisionRules>
  0.5 Nutrient perpendicular ( ContactReceptor );
  1 NeighborhoodMarker toward ( NeighborhoodReceptor );
  1 ContactMarker random;
</DivisionRules>
```

E3.7. AdhesionRules AdhesionRules are pairs of colon-separated surface molecules. When two cells contact one another, the list of adhesion rules and the molecules on the cells' surfaces are compared to determine if an adhesion is to be formed.

In the first example rule below, an adhesion is formed if each cell has CellAdhesion molecule on its surface. In the second example equation, one cell must have CellAdhesionA on its surface and the other cell must have CellAdhesionB. The strength of an adhesion depends on the concentrations of the adhering molecules.

```
<AdhesionRules>
  ( CellAdhesion ) : ( CellAdhesion );
  ( CellAdhesionA ) : ( CellAdhesionB );
</AdhesionRules>
```

E4. Genome. As discussed in Section D above, Genome consists of a bracketed, comma-separated set of Gene Assemblies. A Gene Assembly consists of a bracketed Regulatory Region and a bracketed Structural Region. A Regulatory Region consists of a comma-separated set of Regulatory Genes. Each Regulatory Gene has a molecule alias or an Indicant-Sensitivity pair, called a signature, and an Effect multiplier value. A Structural Region consists of a comma-separated set of Structural Genes, each of which is a molecule alias or signature.

Regulatory Genes either promote, with positive Effect values, or inhibit, with negative Effect values, transcription of the Structural Genes of the Gene Assembly. In each metabolic step, all internal molecules in a cell are compared to all Regulatory Genes and the promotion of the gene, based on the Affinity and concentration of each molecule, is multiplied by the gene's Effect value. If the net promotion of a Regulatory Region is positive, the molecules listed in the Structural Region are produced in the cell at a quantity matching the net positive promotion. If the net promotion of the Regulatory Region is zero or negative, no molecules are produced.

```
<Genome>
[
  [ Nutrient 0.9 ]
  [ NutrientReceptor ],
  [ Nutrient 1.0, SomeInhibitor −1.0 ]
  [ ProductA, ProductB, SomeInhibitor ]
]
</Genome>
```

E5. Shade. Shade is a bracketed collection of comma-separated molecular point sources, sometimes called gradient builders. In practice with the preferred embodiment, <UseRadius/> and <UseModifier/> are specified to designate a more complete description of the point sources.

Each point source description begins with an “S”, followed by a molecular alias or signature, an “@” (commercial-at) symbol, and completed with a sequence of floating-point values. The first three values of the numerical sequence are the X, Y, and Z coordinates of the point source. The fourth number is the concentration at the source location. To describe the shape of the gradient away from the source, the last three numbers are exponent, modifier, and radius values.

Setting the exponent value to 0 causes the gradient to be uniform at the full source concentration throughout the environment space. An exponent specified at greater than 1 describes a decrease in concentration at distance increases from the source.

```
<Shade><UseRadius/><UseModifier/>
[
  S Nutrient @ 0 0 0 1 0 1 1,
  S Morphogen @ 0 0 0 1 0.5 2 1
]
</Shade>
```

### F. Ontogony Engine

When a simulation is started, the configuration file is parsed and transmitted by the user interface to the ontogeny engine. In the present implementation, the ontogeny engine is driven one step at a time by an internal simulation server that supports user control of how many steps the simulation is to proceed without additional instruction.

For each step in the ontogeny engine, the following functions, detailed below, are performed in order until the user halts the simulation or a configured halting condition described in E1 is reached:

killCells

stepCells

stepECM

stepPhysics

F1. Narrative Pseudocode for the Function killCells:

As described under Section B and in FIG. 3 at 37, killCells removes virtual cells marked for death in a previous step. When first marked by a flag set in the source code controlling the cell, cell death is treated as no longer performing any metabolic or transcription algorithms.

Upon being marked for death, the cell begins a countdown to be removed entirely from the simulation and so will no longer be involved in any physical interactions. In the preferred embodiment, this countdown is satisfied immediately and so the cell will be removed immediately upon being marked for death.

```
function killCells
{
  while there are cells to kill
  {
    nextCellToDie ← the next cell to kill
    for each Cell in the simulation
    {
      if Cell == nextCellToDie
    {
        //internally, the cell simply flags itself as dead
        Cell.die
      }
    }
  }
}
```

F2. Narrative Pseudocode for the Function stepCells:

Described under Section B and in FIG. 3 at 38, as this function is called each simulation step, each cell in turn must be directed to perform its internal step logic. In summary, all dead cells are removed, signals from source cells are copied to target regions for detection by potential target cells, cells gather signals so placed, and cell then performs a step of metabolism, as described in F5.

```
// this function is called on the simulation itself
function stepCells
{
  remove all dead cells from simulation
  if there are any cell signals
  {
    for each cell's region
    // where region is an imaginary sphere about the cell
    {
      exchange signal molecules with overlapping regions
    }
  }
  // each cell's immediate region now recognizes external molecules
  // signaled to it from overlapping regions from other cells.
  for each Cell in the simulation
  {
    update Cell's region with external molecules
      from nutrient molecule source
    metabolizeCell // (see below)
  }
}
```

F3. Narrative Pseudocode for the Function stepCells:

As described under Section B and in FIG. 3 at 40, this function updates adhesions between the sub-spheres that represent extra cellular matrix (ECM).

```
function stepECM
{
  // based on simulation adhesions:
  breakOverextendedBindings between ECM subunits
  connectECM between subunits
  decayECM // over several steps, ECM subunits decay and are
  removed
}
```

F4. Narrative Pseudocode for the Function stepPhysics:

As described under Section B and in FIG. 3 at 41, physical interactions are processed separately after metabolism to update cells' location in response to cell death, division, growth, adhesion changes, or perturbation. For this, the unit spheres that represent the physical presence of cells or ECM are gathered to be treated with only limited regard to their cell (or ECM) membership. Then each sphere's location and velocity is updated iteratively based on forces calculated to be acting upon it.

```
// this function is called on the simulation itself
function stepPhysics
{
  Initialize Bag as an empty set of unit spheres
  Initialize Network as an empty set of general adhesions
  for each cell in the simulation
  {
    collect all cell sub-unit spheres into Bag
  }
  collect all ECM sub-unit spheres into Bag
  create inter-object adhesions if adhesion conditions met
  remove overextended adhesions between inter-object unit spheres
  update adhesion forces between collected inter-object unit spheres
  if projectile fired
  {
    for each cell touched by projectile
    {
      //internally, the cell simply flags itself as dead
      instruct cell to die
    }
  }
  for each cell to be nudged, collect forces from user nudges
  for each Iteration for configured-iterations-per-step
  {
    for each Sub-Unit-Sphere in Bag
    {
      accumulate force from all nudges onto Sub-Unit-Sphere
    }
    for each Sub-Unit-Sphere in Bag
    {
      accumulate forces from all adhesions in Network
        onto Sub-Unit-Sphere
    }
    for each Sub-Unit-Sphere in Bag
    {
      accumulate repulsion force onto Sub-Unit-Sphere
    }
    for each Sub-Unit-Sphere in Bag
    {
      accumulate damping of forces onto Sub-Unit-Sphere
    }
    for each Sub-Unit-Sphere in Bag
    {
      // translocation distance based on current velocity, net
      // forces adjusting that velocity & elapsed time per iteration
      translocate Sub-Unit-Sphere in Bag
    }
  }
}
```

F5. Narrative Pseudocode for the Function metabolizeCell:

The following function provides additional detail for stepCells described under F2. If a cell has not been marked for death, it will perform a unit of metabolic processing. In the preferred embodiment, a unit of metabolic processing is a single pass through applicable metabolic interactions and genetic transcription to update cell state. Each metabolic interaction is computed to assess the molecule amounts consumed and produced according to the configured chemistry equations and the genome is transcribed to calculate produced molecule amounts according to the virtual genes activated. The molecules produced from these virtual metabolism and genetic transcription calculations are then accumulated to the cell state. Over subsequent steps, the molecule amounts are reduced so as to simulate molecular decay. If the cell has not reached its death threshold (that is, has not accumulated enough death action molecules), growth, adhesion, and division actions are performed if the cell has reached those respective thresholds.

```
// this function is called on a given cell in simulation
function metabolizeCell
{
  if alive
  {
    // reaction will consume and produce molecules inside, outside,
    // or on the surface of the cell based on configured equations
    react according to molecular interaction equations
    produce ECM sub-units according to configured ECM production
      instructions
```

| | |
|---|---|
| transcribeGenome | // (see below) |

| | |
|---|---|
| accumulate internal molecules | // from reaction & transcription above |
| accumulate action molecules | // from reaction & transcription above |
| } | |

| | |
|---|---|
| decay action molecules | // at a constant rate |
| decay internal molecules | // at a constant rate |
| decay surface molecules | // at a constant rate |

```
  if alive
  {
    if flagged to die or reached threshold of death action molecule
    {
      alive ← FALSE
    }
  }
  if alive
  {
    position produced ECM sub-units into environment
    if reached threshold of growth action molecule, and
    if not already at configured maximum size
    {
      add a sub-unit sphere to cell
      reduce accumulated growth action molecule by the growth
        threshold amount
    }
    // rigidity, elasticity, plasticity adhesions are
    // added, removed, or amended according to applied forces
    apply adhesions to cell sub unit spheres
    if reached threshold of divide action molecule
    {
      reduce accumulated divide action molecule by the
      divide threshold amount
      divide cell sub unit spheres between the parent
        cell and a new daughter cell
      divide cell molecules between parent and daughter cells
      distribute and adjust adhesions between parent and daughter cells
    }
  }
}
```

F5. Narrative Pseudocode for the Function transcribeGenome:

The following function provides additional detail for metabolizeCell described under F5. See section E4 for the description of a Genome and its components. Each gene of the genome is compared for affinity and a corresponding promotion is calculated. If the promotion is sufficient to result in a concentration, the gene products specified in its structural region are produced and added to the cell's internal molecules, either as transfactors to be considered in future transcriptions or chemistry reactions or as action potentials accumulated for growth, division, et al.

The calculation of promotion, referred to in the pseudocode below, is referred to in Section C, in FIG. 5 at 100, specified per Section E.3.6.2, and further described in FIG. 20. One such calculation used in the preferred embodiment is

$$\frac{SpecifiedEffect}{1 + {e}^{- ( SpecifiedAffinity - SpecifiedPromotionMidpoint )}}$$

The updating of concentration, referred to in the pseudocode below, is described in Section E.3.6.2 and specified by the genome (see Section E.4). One such calculation used in the preferred embodiment is the product of the SpecifiedConcentration and the CalculatedPromotion from the promotion calculation.

```
// this function is called on a genome by its cell during simulation
function transcribeGenome
{
  for each GeneAssembly in Genome
  {
    calculate Promotion on GeneAssembly based on present
      transfactors and presented chemistry
    update Concentration from Promotion
    if Concentration > 0
    {
      for each Gene in GeneAssembly's structural region
          {
        if Specified-Gene-Product is a Transfactor
        {
          accumulate concentration of Transfactor specified in the
            GeneAssembly into Cell's store
              }
        else
        {
          accumulate concentration of Action-Molecule product
            specified in the GeneAssembly into Cell's store
        }
      }
    }
  }
}
```

### G. Applications of the System to Tissue Modeling

This section describes methods and strategies for generating multicellular virtual tissues having selected behavioral and morphological properties, and for testing such virtual tissues.

Essentially, three steps can be followed to develop a particular model:
1) Describe the model: identify the criteria that indicates how the model will be recognized;
2) Define cell states: identify the various cell states expected to be seen in the model;
3) Write configuration file: encode the cell state transitions into a configuration with virtual genes and chemical-interaction rules.

The following examples illustrate tissue modeling for three different tissue types and all assume a Free Space environment where cells can be shaped with the marbles-in-a-bag approach described under D7. The examples are intended to illustrate how the virtual genome and chemistry equations may be selected to achieve specific tissue behavior and morphology, but are in no way intended to limit the scope of the invention.

### G1. Example 1

### Simple Model of Cells Committed to Differentiation

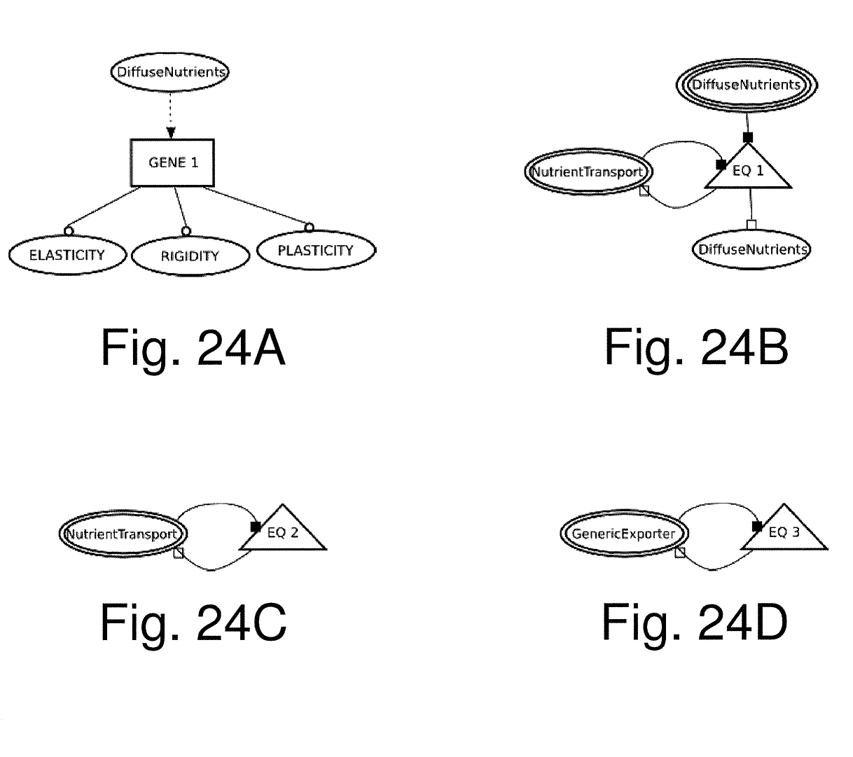

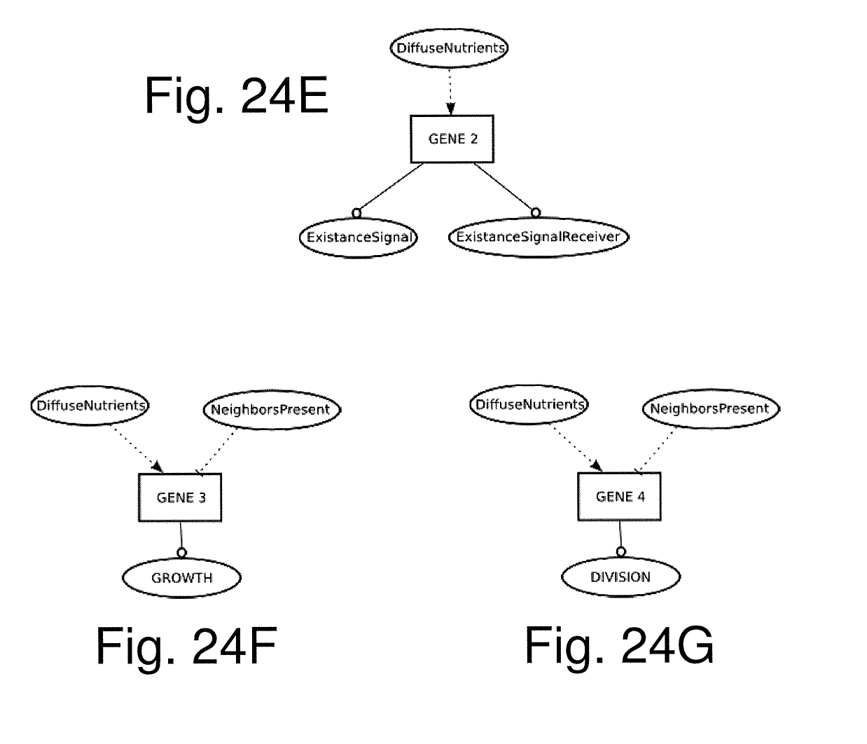

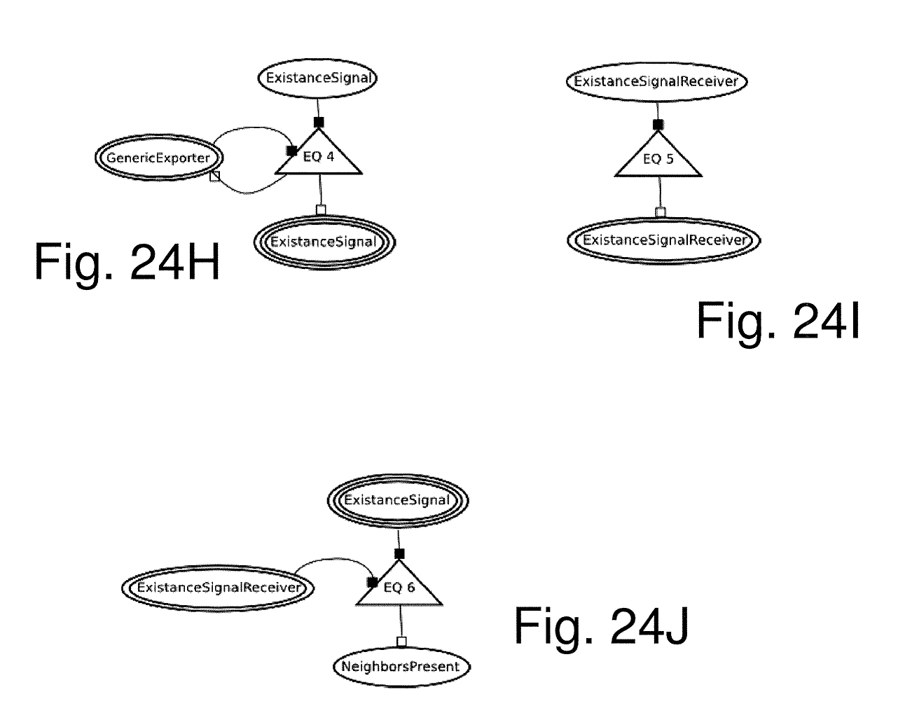

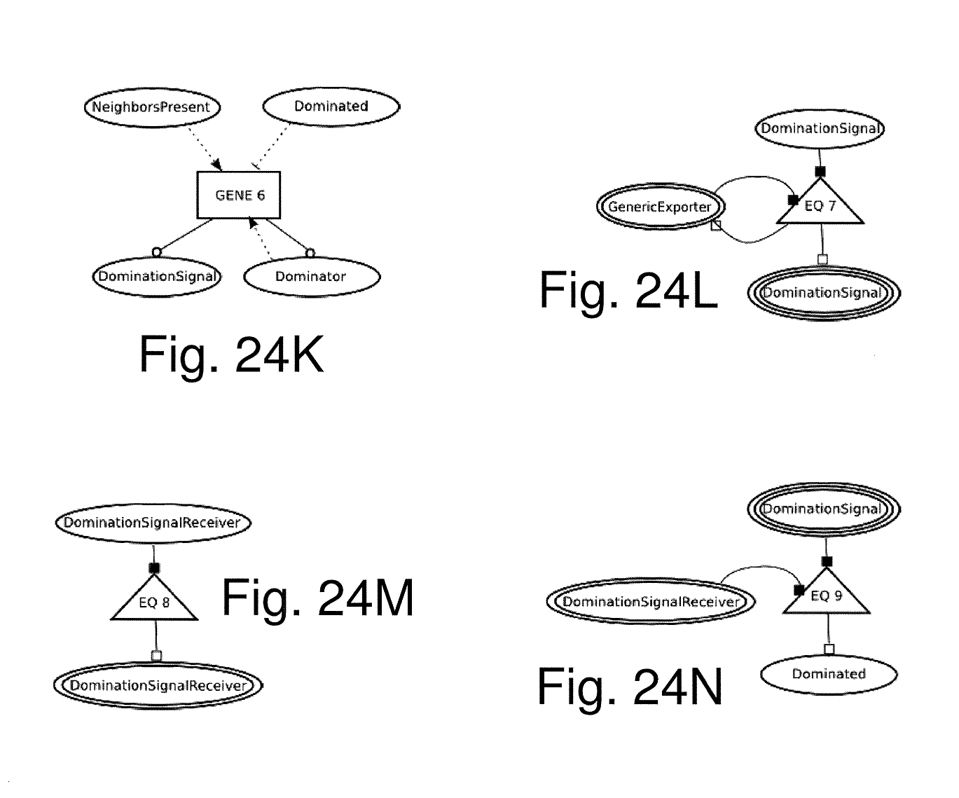

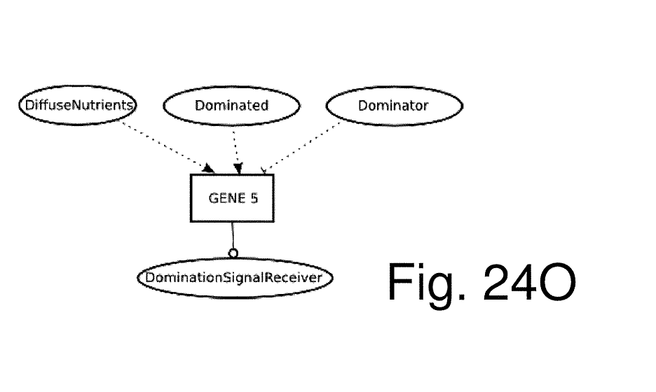

Introduced in Section D, the first example demonstrates how cells can develop a propensity to differentiate. This section describes an analysis and design approach with which to generate that example. The SGRN for this example is diagrammed in FIG. 9 and discussed above in Section C. Individual elements of this SGRN are described in Section G1.3 with respect to FIGS. 24A-24O.

G1.1. Describing the Model

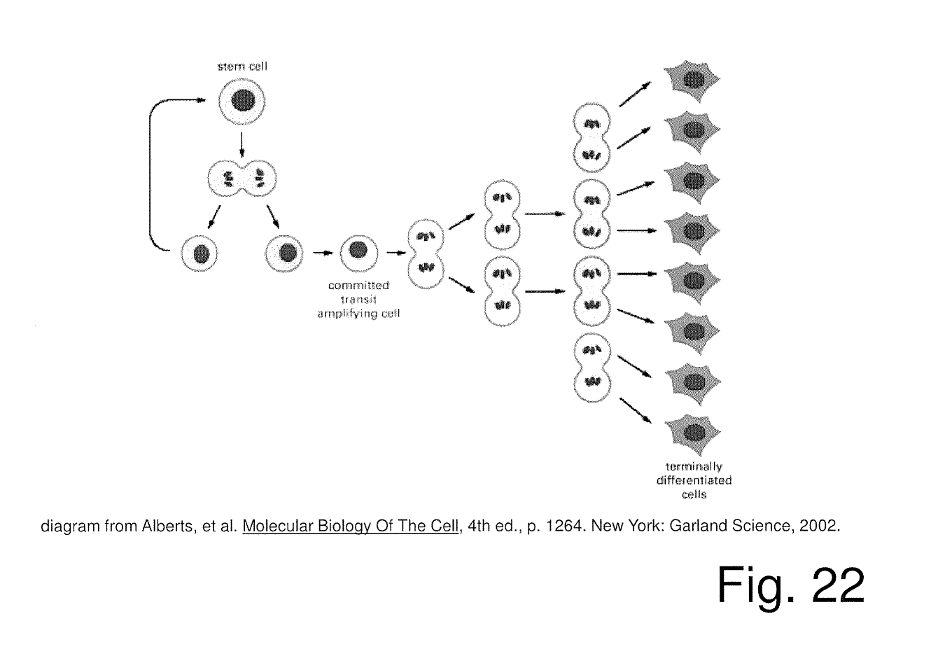

The object is to produce some kind of chemical disparity between two cells that can lead to a persistent or permanent difference between them. This mechanism closely resembles biological mechanisms of daughter cells from stem cells. Typically one daughter cell remains a stem cell and the other transitions to some other type, as illustrated in FIG. 22.

To generate this model with the preferred embodiment, the user starts with the initial cell. The intent is to have this cell grow and divide such that two cell types result: Dominator, similar to the initial cell state, and Dominated, distinct from Dominator. The cells are to have chemical differences resulting from signaling from neighbor cells. The initial cell will produce new cells that will signal one other. Due to the nature of the signaling, no two cells will receive the exact same amount of signal.

The goal is to build a metabolic pathway and adjust it to use this difference in signaling strength to produce the intended differences in the cells. The cells will be competing to reach the Dominator state: the first to reach that state will commit to the Dominator state, suppress the other cells from reaching that state, and actively signal them to instead transition to the Dominated state. Until a cell reaches the Dominator state, all cells will be uncommitted.

G1.2. Defining Cell States

First, a list of cellular states and their corresponding behaviors in different situations must be made from which to design a suitable genome. As appropriate, listed states may have mutual exclusivity with other states. For this example model, three cell states are listed:

| | |
|---|---|
| Neutral: | Neutral cells have not committed to any path but pursue |
| | reaching Dominator state when they detect enough |
| | neighbors around them. They can grow and divide, send |
| | and receive a “neighbor” signal, can receive “become |
| | Dominated” signal, and can attain either Dominator or |
| | Dominated states. |
| Dominator: | These cells pursue retention of the Dominator state |
| | and influence surrounding cells to reach Dominated state. |
| | Dominator cells cannot grow and divide. They can send and |
| | receive a “become Dominated” signal. |
| Dominated: | These cells have reached a terminal state and so |
| | cannot transition further. These cells cannot grow or divide. |

G1.3. Writing the Configuration File

A configuration file to submit to the ontogeny engine must be written. Section E describes key syntax. From an initial simulation configuration template, features and details are successively added until the desired outcome is reached.

Below is a simulation configuration template; it does not yet contain any model specific equations or genetic information. Its content is based primarily on previous practice that worked well in various models.

```
<CsIndividual>
  <Simulation>
    <Cell>
      <Chemistry><Smooth/></Chemistry>
      // Starting the Cell off with some surface molecules
      <InitialChemistry>
        (NutrientTransport) 50
              (GenericExporter) 50
              (ECMDetector) 50
      </InitialChemistry>
      <ChemistryEquations>
        { DiffuseNutrients } + (NutrientTransport) =
          .1 DiffuseNutrients + ( 1.11111111111111
          NutrientTransport );
        ( NutrientTransport ) =
          ( 1.111111111111111111 NutrientTransport );
        ( GenericExporter ) = ( 1.111111111111111111
        GenericExporter );
      </ChemistryEquations>
      // A pretty standard promotion curve
      <Promoter>
        <Smooth>
          <PromotionMidpoint> 10 </PromotionMidpoint>
          <ActiveConcentration> 1 </ActiveConcentration>
        </Smooth>
      </Promoter>
      //This large maximum size makes us be careful about
      regulating growth
      <MaximumSize>300</MaximumSize>
      // Size of the first cell, larger than a typical somatic
      // cell for this model, more like an egg
      <InitialSize>40</InitialSize>
      <MinimumSize>6</MinimumSize>
    </Cell>
    <Signal> // A very short range signaling scheme
      <Local>
        <Separation> .1 </Separation>
      </Local>
    </Signal>
    // These physics settings tend to work well, they're used in
    // lots of models
    <Physics>
      <IterationsPerStep>50</IterationsPerStep>
      <TimePerStep>.2</TimePerStep>
      <DampingMultiplier>0.99</DampingMultiplier>
      <NudgeMagnitude>1</NudgeMagnitude>
    </Physics>
    <MaxInterAdhesionLength>0.65</MaxInterAdhesionLength>
  </Simulation>
  <Genome>
  [
    [ DiffuseNutrients .3 ] [ Plasticity, Elasticity, Rigidity ]
  ]
  </Genome>
  // Our cells will live in an environment evenly covered with
  // DiffuseNutrients
  <Shade><UseRadius/><UseModifier/>
  [
    S DiffuseNutrients @ 0 1 0 5 1 1 1000
  ]
  </Shade>
</CsIndividual>
```

This initial configuration template includes one gene, three chemistry equations, and surface molecules that represent the state the cell is to start as. These surface molecules allow the cell to bring in DiffuseNutrients. The single gene, illustrated in FIG. 24A, is to produce structural molecules to give the cell a reasonable shape. The three chemistry equations, illustrated in FIGS. 24B-24D, are to maintain the initial surface molecules and facilitate transport of DiffuseNutrients. The coefficients of 1.1111 . . . are to help retain those nondecaying and unconsumed molecules; that is, surface transport molecules are replaced at a greater rate so as to offset their consumption or decay.

In practice, the template <Physics> settings produce a relatively stable environment; not all potential settings produce smooth results. The template <Smooth> promotion allows any molecule, no matter how poorly matched, to promote any gene, even at 0.0 affinity and concentration. For this reason, promotion midpoints for Smooth promotion are typically set relatively high to reduce the promotion at 0.0 affinity and concentration. With Smooth promotion, gene assemblies often include explicit inhibitors to cancel out interference from molecules that should not promote the assembly.

As is, a simulation run with this initial configuration would develop a single, reasonably shaped cell that does not grow or divide, consumes DiffuseNutrients, and maintains its shape. Genes and equations are added to generate the desired differentiation behavior.

First, the state of the cells should reflect how many neighbor cells are around: all cells need to be able to send and receive a general awareness signal. While each cell exists and can transcribe Diffuse Nutrients, it is to produce internal molecules for this purpose. ExistanceSignal is to be a signal to other cells of given cell's existence and ExistanceSignalReceiver is to be placed on the surface of the cell to receive such signals from other cells. FIG. 24E shows, as GENE 2, a gene that produces these molecules with the promoter and product designations shown below. This gene is added inside the square brackets subordinate to the <Genome> tag.

### [DiffuseNutrients 5] [ExistanceSignal, ExistanceSignalReceiver]

To be a signal, the surface molecule GenericExporter, established in <InitialChemistry>, must participate in a chemistry equation to transport the internally produced ExistanceSignal molecules out of the cell; see FIG. 24H. The equation must also restore GenericExporter to prevent its consumption. As with all chemistry interactions, the below text is to be added under the <ChemistryEquations> tag:

ExistanceSignal+(GenericExporter)=(GenericExporter)+{ExistanceSignal};

To receive similar signals from other cells, ExistanceSignalReceiver must be placed onto the cell surface. Again, this is done with a chemistry equation, see FIG. 24I and below:

### ExistanceSignalReceiver=(ExistanceSignalReceiver);

Finally, the actual reception of ExistanceSignal external to the cell requires its transport into the cell by the surface ExistanceSignalReciever. Such molecules transported into the cell will be represented by internal NeighborPresent molecules. Again, this is done with a chemistry equation, see FIG. 24J and below:

### {ExistanceSignal}+(ExistanceSignalReceiver)=NeighborPresent;

With the addition of the four previous configuration instructions, the signaling necessary for recognizing the presence of neighboring cells and broadcasting a cell's presence is complete, but cell response to such signaling is not.

To keep the overall model as a small cluster of cells, the cells are to grow and divide in the presence of nutrient only as long as there are not too many neighbors present. This does not preclude cells with a Dominated state from growing and dividing when they are isolated, but growth and division will stop when in a small cluster. This behavior is configured by the addition of Genes 3 and 4, illustrated in FIGS. 24F and 24G. The configuration instructions for inclusion in the genome are given below:

### [DiffuseNutrients 0.18, NeighborPresent −3] [Growth][DiffuseNutrients 0.18, NeighborPresent −3] [Division]

To establish the potential for cell differentiation, cells need to track their Dominator state and need to signal other cells of their progress to that state. This requires a gene to promote a Dominator state in response to the presence of neighboring cells. The NeighborsPresent molecule received from other cells will promote this gene to produce both Dominator molecule for internal accumulation and DominationSignal as a signal for negotiating the competition between cells to attain the Dominator state, FIG. 24K:

### [NeighborPresent 3, Dominated −10, Dominator 3]

[Dominator, DominationSignal]

As in the signaling to indicate neighbor presence, this signal must be transported out, via GenericExporter, as it is produced, FIG. 24L:

DominationSignal+(GenericExporter)=(GenericExporter)+{DominationSignal};

Likewise, similar signals from other cells must be received to complete the signal pathway. A surface molecule, DominationSignalReceiver, is necessary to transport the external signals into the cell. As the external signal molecules are brought in, they will accumulate as internal Dominated molecules, FIG. 24N:

{DominationSignal}+(DominationSignalReceiver)=Dominated;

DominationSignalReceivers require an origin: this is an opportunity for differentiation. By attenuating the production of the surface molecules for signal reception, cells can vary their response to signals from other cells. As cells accumulate internal Dominator molecule by their own signal production (see above), resistance to other cells' signal should increase until that attains the Dominator state. As cells accumulate internal Dominated molecule from other cells' signals, the cells will reduce their signaling until they become inert and no longer send or receive Domination signals from their neighbors.

See FIG. 24O and the configuration instruction to be added below. The “Dominator-10” in a new gene's control region will inhibit the expression of internal DominationSignalReceiver molecule. Conversely, as cells accumulate Dominated molecules from other cells, this expression is promoted. Cells reinforce the expression of this gene with DiffuseNutrients, further setting them on the path of terminal differentiation.

### [DiffuseNutrients 5, Dominator −10, Dominated 5]

[DominationSignalReceiver]

As before, a chemistry equation moves any produced DominationSignalReceiver to the cell surface, FIG. 24M:

### DominationSignalReceiver=(DominationSignalReceiver);

In practice, the design of configuration instructions to create necessary gene and chemistry equations requires trial and error of the involved coefficients to refine the model. If cells receive too much signal and transition too quickly, the signal receptor coefficient will require adjustment. If cell only partially transit to another state and continue uncommitted for longer than desired, it may be necessary to adjust the gene expression for state transitions to be more definite.

The following is the completed configuration file from the first example above:

```
<CsIndividual>
  <MoleculeCatalog></MoleculeCatalog>
  <Simulation>
    <ECMDefinitionRules></ECMDefinitionRules>
    <AdhesionRules>
      Dominator : Dominator ;
    </AdhesionRules>
    <Cell>
      <Axisifier><Random/></Axisifier>
      <Chemistry><Smooth/></Chemistry>
      <InitialChemistry>
        (NutrientTransport) 50
        (GenericExporter) 50
      </InitialChemistry>
      <ChemistryEquations>
        { DiffuseNutrients } + (NutrientTransport) =
          .1 DiffuseNutrients + ( 1.11111111111111
          NutrientTransport );
        ( NutrientTransport ) =
          ( 1.111111111111111111 NutrientTransport );
        ( GenericExporter ) = ( 1.111111111111111111
        GenericExporter );
        ExistanceSignal + ( GenericExporter ) =
          ( 1.1111111111111 GenericExporter ) + { ExistanceSignal };
        ExistanceSignalReceiver = ( ExistanceSignalReceiver );
        { ExistanceSignal } + ( ExistanceSignalReceiver ) =
          20 NeighborPresent;
        DominationSignal + ( GenericExporter ) =
          ( 1.1111111111111 GenericExporter ) + {
          DominationSignal };
        DominationSignalReceiver = ( DominationSignalReceiver );
        { DominationSignal } + ( DominationSignalReceiver ) =
          20 Dominated + 20 GrowABit;
      </ChemistryEquations>
      <Promoter>
        <Smooth>
          <PromotionMidpoint> 10 </PromotionMidpoint>
          <ActiveConcentration> 1 </ActiveConcentration>
        </Smooth>
      </Promoter>
      <MaximumSize>300</MaximumSize>
      <InitialSize>40</InitialSize>
      <MinimumSize>6</MinimumSize>
      <ECMProductionRules></ECMProductionRules>
    </Cell>
    <Signal>
      <Local>
        <Separation> .1 </Separation>
      </Local>
    </Signal>
    <Physics>
      <IterationsPerStep>50</IterationsPerStep>
      <TimePerStep>.2</TimePerStep>
      <DampingMultiplier>0.99</DampingMultiplier>
      <NudgeMagnitude>1</NudgeMagnitude>
    </Physics>
    <MaxInterAdhesionLength>0.65</MaxInterAdhesionLength>
  </Simulation>
  <DevelopmentEngine>
    <MaxSteps>10000</MaxSteps>
    <StableSteps>10000</StableSteps>
  </DevelopmentEngine>
  <Genome>
    [ DiffuseNutrients .3 ] [ Plasticity, Elasticity, Rigidity ],
    [ DiffuseNutrients 5 ] [ ExistanceSignal, ExistanceSignalReceiver ],
    [ DiffuseNutrients .18, NeighborPresent −3 ] [ Growth ],
    [ DiffuseNutrients .18, NeighborPresent −3 ] [ Division ],
    [ DiffuseNutrients 5, Dominator −10, Dominated 5 ]
      [ DominationSignalReceiver ],
    [ NeighborPresent 3, Dominated −10, Dominator 3 ]
      [ Dominator, DominationSignal ]
  </Genome>
  <Shade><UseRadius/><UseModifier/>
  [
  S DiffuseNutrients @ 0 1 0 5 1 1 1000
  ]
  </Shade>
</CsIndividual>
```

The resulting SGRN from this configuration is given by FIG. 9 and may be read as described in Section C.

### G2. Example 2

### Tissue Sheet with Stem Cell Niches

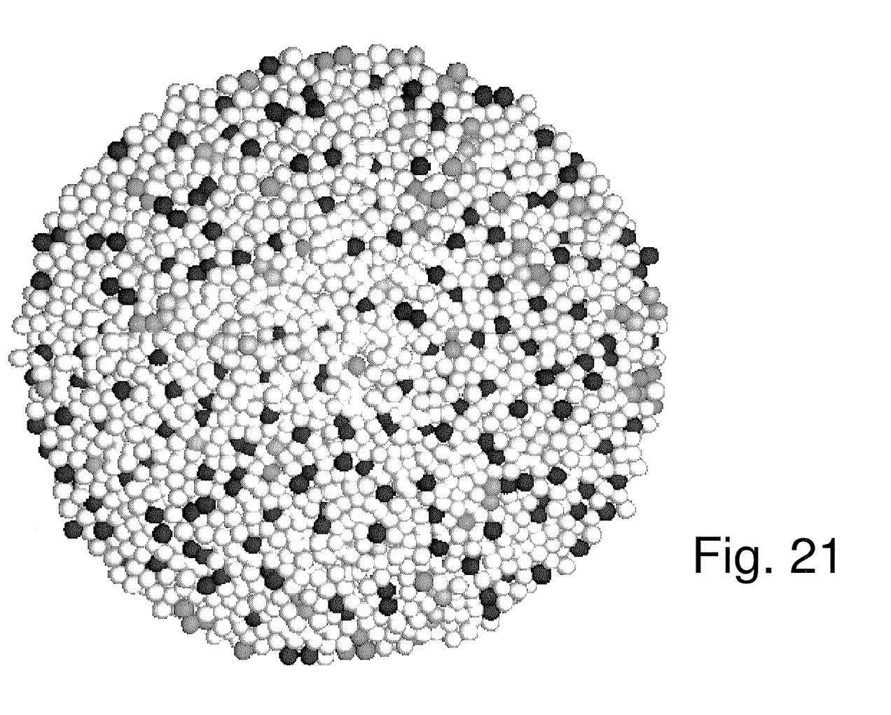

The second example is a flat sheet of cells with simple virtual stem cells, shown in FIG. 21. This example is more complex than the first, in section G1, and includes stem cell niches and cell differentiation, rather than just demonstrating the propensity for differentiation. The sheet is formed by placing two very large fixed spheres (see section E.3.5) about the initial cell to establish relatively flat, metabolically inert obstacles in the environment and so physically limit the growth to the sheet. The user may use the visualization engine to inhibit display of these large fixed spheres to allow unobstructed examination of the subject sheet.

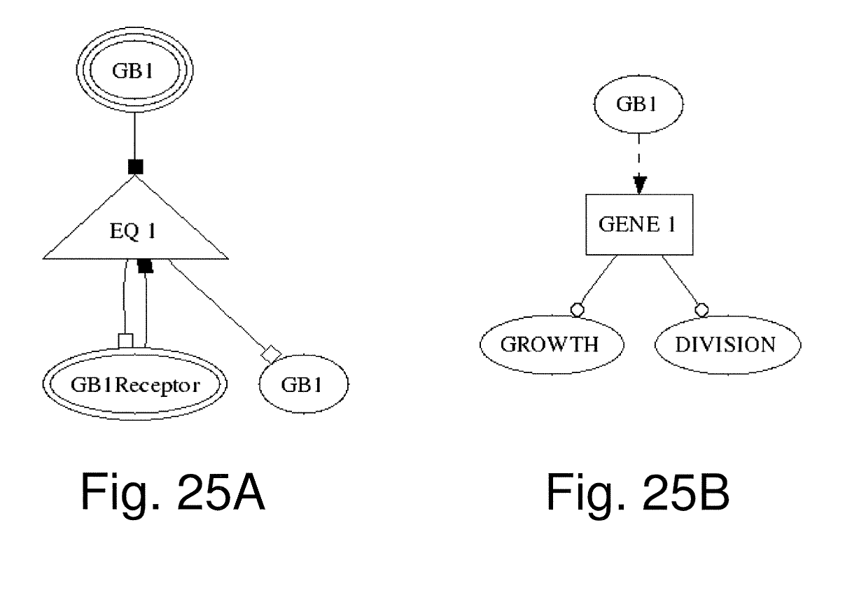

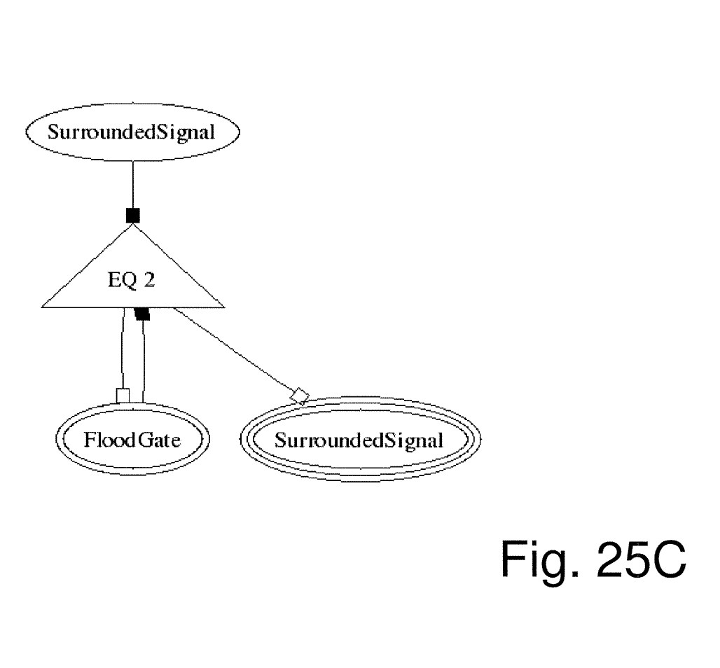

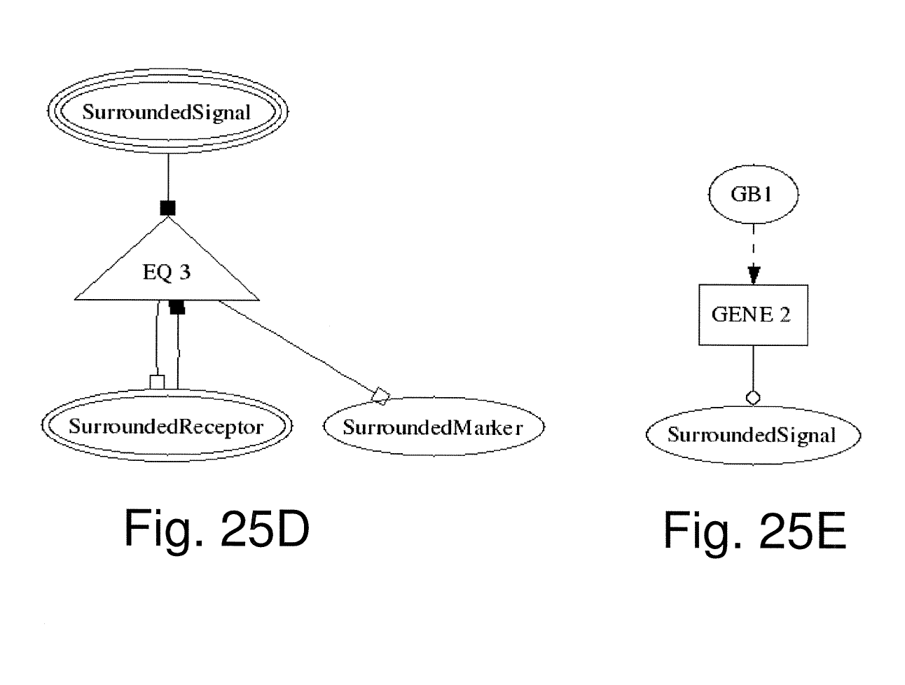

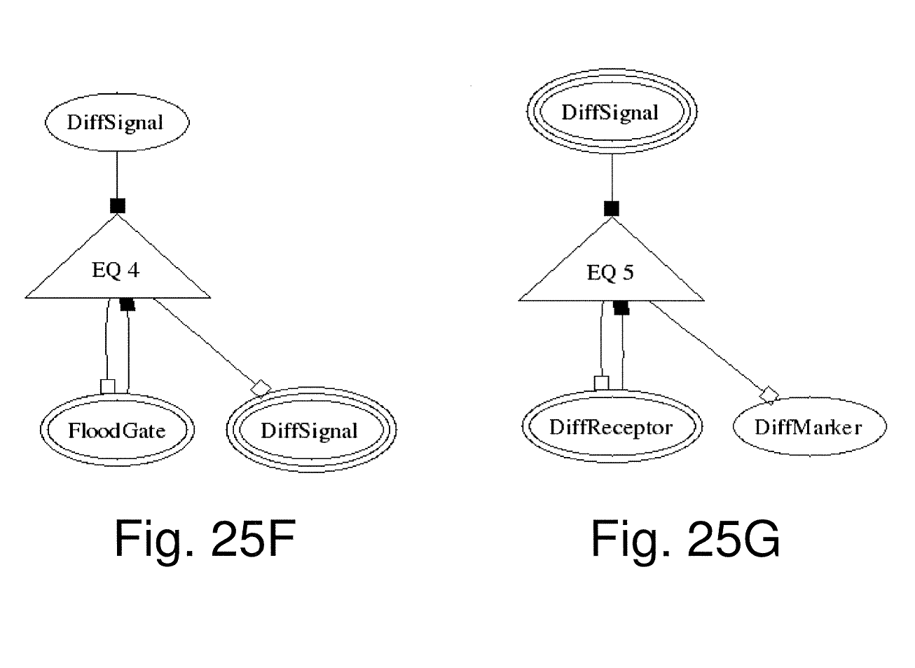

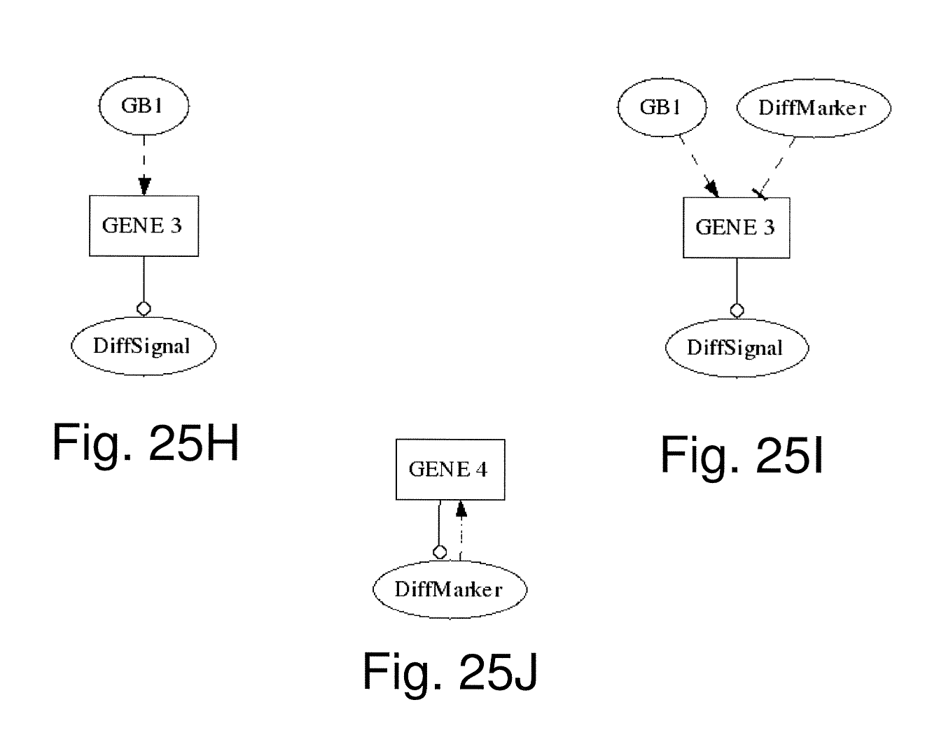

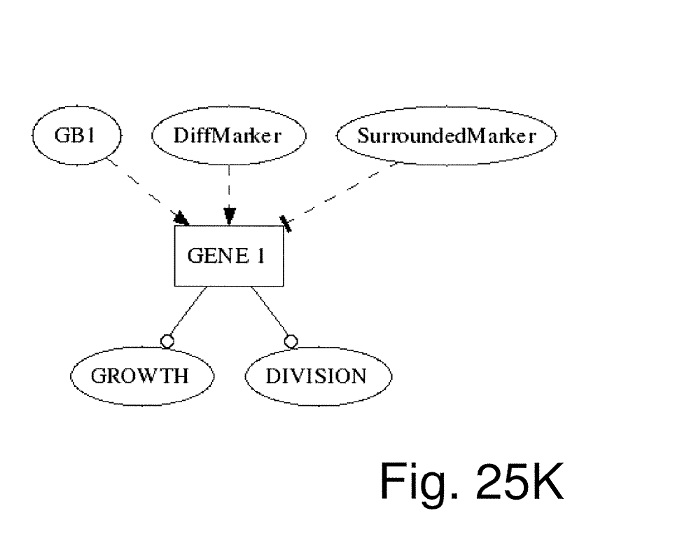

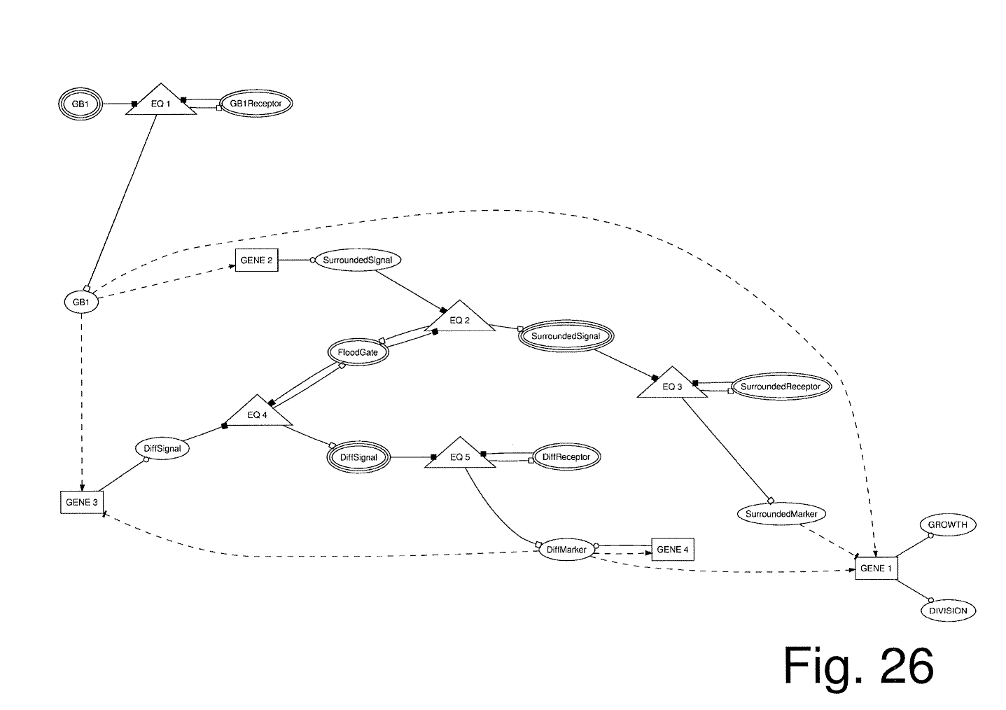

Signal isolation similar to that seen in Example 1 was used to establish cell differentiation leading to two types of cells: undifferentiated stem-cell-like cells and differentiated cells analogous to transit amplifying cells. The SGRN for this example is diagrammed in FIG. 26, with individual components of the system described below in Section G2.3 with respect to FIGS. 25A-25K.

G2.1. Describing the Model

This model is intended for exploration of a signaling mechanism to explain how stem cell niches might become evenly distributed within a tissue. In a physically constrained sheet of cells, slow-growing, isolated, stem-like cells are each surrounded by numerous, faster-growing, transit-amplifying cells.

G2.2. Decomposing the Problem to Identify Cell-Level Features

There are two basic cell conditions in this model: (1) the undifferentiated condition belonging to the initial cell and (2) a condition in which cells have been induced to commit by signals from an undifferentiated cell and remain committed to differentiating in the presence of minimal ongoing signal. These conditions loosely represent the relationship between stem cells and transit-amplifying cells in the basal layer of epidermis.

In general, stem cells are regulated by niches. In some tissues, these niches are clearly defined and precisely located. In others, they may be scattered throughout the tissue with no apparent specialized niche cells. Regardless, the number of stem cells is relatively small compared to the number of differentiating or differentiated cells and the stem niches are relatively isolated from one another. In this example, individual virtual stem cells are isolated, effectively representing an entire niche. When an undifferentiated cell divides, one of them is to remain undifferentiated and the other commits to differentiation: this dynamic keeps the density of stem-like cells nearly constant. This behavior implies a signaling competition or some kind of asymmetric division. This model explores a signal isolation mechanism to support the intended behavior.

In basal epidermis, transit-amplifying cells normally remain transit-amplifying cells until they are removed from the basal layer by population pressure or asymmetric division with respect to the basement membrane. However, in the event of injury where stem cell populations are damaged, some transit-amplifying cells may revert to stem cell conditions as part of the repair process. This implies that although commitment to differentiation is not trivial, at least some minimal signaling from stem cells may be required to keep transit-amplifying cells from reverting to stem cells.

G2.3. Writing the Configuration File

The configuration is designed starting from a minimal simulation template. A <MaxInterAdhesionLength> setting of 0.25 allows adhesions between cells to stretch up to half the radius of unit spheres (i.e., r=0.5) before breaking (see E.3.2). This allows some computational variance for physics resolution and acknowledges that unlike model spheres, cells are flexible.

```
<CsIndividual>
  <Simulation>
    <MaxInterAdhesionLength>0.25</MaxInterAdhesionLength>
    <SingleAdhesionRule>0</SingleAdhesionRule>
    <Cell>
      <Chemistry><Default/></Chemistry>
    </Cell>
  </Simulation>
</CsIndividual>
```

<Physics> settings from previous practice that worked well in various models are used to establish an initial configuration. Unlike the configuration of Example 1, <IterationsPerStep> is not specified. The simulation is left to dynamically adjust this parameter for each step based on the <MaxVelocityChange> and <TimePerStep> values and current calculated velocities. As in Example 1, the <DampingMultiplier> and <RepulsionMultiplier> values are close to one another—identical in this case. Practice with the preferred embodiment has shown that balanced values tend to work better and that absolute values tend to be less significant than the ratio.

```
<Physics>
  <MaxVelocityChange>2</MaxVelocityChange>
  <TimePerStep>0.5</TimePerStep>
  <DampingMultiplier>2</DampingMultiplier>
  <RepulsionMultiplier>2</RepulsionMultiplier>
</Physics>
```

Instead of the <Smooth> promotion from Example 1, <Smoother> promotion is used to yield 0.0 promotion at 0.0 affinity and concentration; this allows lower promotion midpoints to be chosen for developer convenience. In this example, <PromotionMidpoint> is set to 5 so that the effective range of promotion is covered by concentrations from 0 to 10. The <Slope> is set at 3 so that key promotion levels occur at convenient concentrations. 50% of the promotion range is covered between concentration 4, where promotion is 25%, and concentration 6, where promotion is 75%. Above concentration 10, promotion is asymptotically maximal.

<Promoter>

<Smoother>

<PromotionMidpoint>5</PromotionMidpoint>
<Slope>3</Slope>
<ActiveConcentration>1</ActiveConcentration>

</Smoother>

</Promoter>

The following is the resulting initial configuration from which to begin development of the second example:

<CsIndividual>

<Simulation>

<MaxInterAdhesionLength>0.25</MaxInterAdhesionLength>
<SingleAdhesionRule>0</SingleAdhesionRule>
<Physics>

<MaxVelocityChange>2</MaxVelocityChange>
<TimePerStep>0.5</TimePerStep>
<DampingMultiplier>2</DampingMultiplier>
<RepulsionMultiplier>2</RepulsionMultiplier>

</Physics>
<Cell>

<Chemistry><Default/></Chemistry>
<Promoter>

<Smoother>

<PromotionMidpoint>5</PromotionMidpoint>
<Slope>3</Slope>
<ActiveConcentration>1</ActiveConcentration>

</Smoother>

</Promoter>

</Cell>

</Simulation>

</CsIndividual>

To simplify the example, mechanisms for cell cohesion or division orientation are unwanted. The below instructions, under <Simulation>, constrain the model to grow between a pair of effectively infinite plates (see E3.5), limiting tissue growth to a single-layer sheet.

```
<FixedSpheres>
  [0, −1000, 0] 1000,
  [0, 1001, 0] 1000
</FixedSpheres>
```

For simplicity and speed, only a very short range Local signaling with Separation 0.2 is used (see E3.1). This requires cells to be touching or nearly touching for cell signals to be exchanged. The following is added under <Simulation>.

```
<Signal>
  <Local>
    <Separation>0.2</Separation>
  </Local>
</Signal>
```

To develop numerous cells quickly in minimal space, the minimum cell size is set to one subsphere and the maximum cell size to two subspheres. However, the initial cell will be larger than the maximum and have an odd number of subspheres to guarantee an asymmetrically-sized first division. As the initial 13-subsphere cell divides into thirteen individual cells in the first few steps, it will rapidly generate a mix of cells with different signaling environments and molecular concentrations. The following is added under <Cell>.

<InitialSize>13</InitialSize>
<MinimumSize>1</MinimumSize>
<MaximumSize>2</MaximumSize>

A cell nutrient molecule named GB1 is to be uniformly available throughout the environment. As a entry of <Shade> under <CsIndividual>, a gradient builder for GB1 is added (see E5) with a strength parameter of 1.0 and an exponent of 0.0. With an exponent of 0.0, the concentration of GB1 will be at the full strength of 1.0 everywhere in the environment; the location, modifier, and radius values are irrelevant.

<Shade><UseRadius/><UseModifier/>
[ S GB1 @ 0 0 0 1 0 1 1 ]
</Shade>

For reference ease, a <MoleculeCatalog> is established, under <CsIndividual>, with GB1 as its first entry. A high Sensitivity setting of 10 in the molecule signature effectively demands exact matching with regulatory genes.

<MoleculeCatalog>
GB1 [10, 10];
</MoleculeCatalog>

As in the first example, surface transport molecules are specified as both reactants and products so that they are not consumed or altered during molecule transport. To import external GB1 via surface GB1 Receptor, a chemistry equation is added, FIG. 25A:

<ChemistryEquations>
{ GB1 } + ( GB1Receptor ) = GB1 + ( GB1Receptor );
</ChemistryEquations>

So cells do not have to maintain surface transport molecules via gene expression as in the first example, all surface transport molecules in this model are configured with decay rates of 0.0. The instruction below is added to the <MoleculeCatalog>:

### GB1 Receptor [20, 10] 0.0;

GB1 is to be used to provide a reference concentration for gene promotion. To keep associated genes fully promoted, cells must be able to take in GB1 and maintain its concentration at or above 10. Therefore, the initial cell is primed with internal GB1 and surface GB1 Receptor by adding these molecules to <InitialChemistry> under <Cell>. The amounts of initial molecules are chosen so that the initial cell contains a GB1 concentration of 10 and the surface GB1 Receptor concentration is greater than the concentration of external GB1, making the signal the limiting factor and not the receptor.

To simplify searches for appropriate coefficients in signaling, it is often useful to explicitly make either the signal or the receptor the limiting factor by ensuring an abundance of the other factor. In this case, the cell should be initialized with enough GB1 Receptor so that the cell can take in all of the presented external GB1 and maintain an internal GB1 concentration at or above 10, where its effect on gene promotion is maximal.

```
<InitialChemistry>
  GB1 10
  ( GB1Receptor ) 5
</InitialChemistry>
```

All cells in this model are to grow and divide. In undifferentiated cells, only GB1 will internally promote growth and division. The <Genome>, under <Cell>, is established. Its first gene assembly, depicted in FIG. 25B, is written for production of Growth and Division molecules upon promotion by GB1. The promotion effect value is adjusted so that growth and division occur in the initial cell and continue in the daughter cells.

<Genome>
[
[ GB1 0.112 ] [ Growth, Division ]
]
</Genome>

To keep the tissue together and minimize drifting and shuffling of cells, cells must adhere to one another and so a non-decaying CellAdhesion molecule is needed. The molecule is defined in the <MoleculeCatalog>:

### CellAdhesion [90, 10] 0.0;

It is also added to the <InitialChemistry> as a surface molecule so that no production expression or equation is necessary:

### (CellAdhesion) 0.1

An <AdhesionRule> is added under <Simulation> to associate the surface CellAdhesion molecules of one cell to the surface CellAdhesion molecules of another cell.

<AdhesionRules>
( CellAdhesion ) : ( CellAdhesion );
</AdhesionRules>

Because of the high pressure situation created by the constrained environment and an intentionally rapidly growing tissue, surrounded cells should grow and divide more slowly than cells on the perimeter. The concept of “contact inhibition” in living tissues can be applied here. To accomplish contact inhibition, cells need to recognize how surrounded they are.

A chemistry equation is added to create internal SurroundedMarker in response to receiving external SurroundedSignal via surface SurroundedReceptor, FIG. 25D. The coefficient on SurroundedMarker (e.g., 2.0) is adjusted through experimentation so that a fully surrounded cell has a concentration of SurroundedMarker near 10, such that promotion of genes by SurroundedMarker will be high, while a cell with only 1 or 2 neighbors has a SurroundedMarker concentration below 2 or 3, such that promotion of genes by SurroundedMarker will be very low.

{SurroundedSignal}+(SurroundedReceptor)=2.0 SurroundedMarker+(Surrounded Receptor);

As always in this example, these molecules are added to the <MoleculeCatalog>. As with GB1 Receptor, SurroundedReceptor is not to decay.

### SurroundedSignal [30, 10];

### SurroundedReceptor [40, 10] 0.0;

### SurroundedMarker [50, 10];

Also as with GB1 Receptor, SurroundedReceptor is added to the <InitialChemistry> in sufficient quantity to guarantee that signal amounts will be the limiting factor in signaling:

### (SurroundedReceptor) 50

Another chemistry equation is added to export internal SurroundedSignal to the environment via a general-purpose surface exporter molecule, FloodGate, FIG. 25C:

SurroundedSignal+(FloodGate)={SurroundedSignal}+(FloodGate);

FloodGate, as a surface transporter, is added to the <MoleculeCatalog> so as not to decay:

### FloodGate [100, 10] 0.0;

As with the other surface transporters, FloodGate is added to the Initial Chemistry in sufficient quantity to guarantee that signal amounts will be the limiting factor in signaling.

### (FloodGate) 50

All cells will send the SurroundedSignal, so a gene assembly promoted by GB1 is added to the <Genome> to produce SurroundedSignal, FIG. 25E. The promotion effect value is set to something large enough that signals produced each step will be detectable by neighboring cells, but not so large as to require neighbors to sustain a high concentration of receptors. Practice with the preferred embodiment has indicated that values near 0.125 meet these requirements given these other initial configuration settings.

### [GB1 0.125] [SurroundedSignal]

By the Kepler conjecture regarding maximum packing density of spheres in any three dimensional space, a maximally-surrounded single-sphere cell can receive contact signal from at most twelve single-sphere neighbors [Hales, 2005]. Therefore, for such a cell to be able to distinguish between, say, the maximum number of neighbors and one less than the maximum number of neighbors, its concentration of SurroundedReceptor must be at least 12 times greater than the maximal signal concentration. Internally, the range of SurroundedMarker concentration sustained by receiving from minimum to maximum SurroundedSignal should be between 0 and 10, the effective range of the simulation's configured promotion curve.

To reduce the rate of Growth and Division in surrounded cells, an inhibitory region matching SurroundedMarker is added to the already existing gene assembly producing Growth and Division. The promotion and inhibition effect values may need to be balanced so that surrounded cells are still capable of growth and division at a very low rate while perimeter cells grow and divide at a noticeably higher rate. The changed gene assembly is now as follows:

### [GB1 0.112, SurroundedMarker −0.001] [Growth, Division],

The configuration written thus far will grow a sheet of adhered cells where the edge cells of the sheet grow and divide more rapidly than those surrounded within:

```
<CsIndividual>
  <MoleculeCatalog>
    GB1 [10, 10];
    GB1Receptor [20, 10] 0.0;
    SurroundedSignal [30, 10];
    SurroundedReceptor [40, 10] 0.0;
    SurroundedMarker [50, 10];
    CellAdhesion [90, 10] 0.0;
    FloodGate [100, 10] 0.0;
  </MoleculeCatalog>
  <Simulation>
    <MaxInterAdhesionLength>0.25</MaxInterAdhesionLength>
    <SingleAdhesionRule>0</SingleAdhesionRule>
    <Physics>
      <MaxVelocityChange>2</MaxVelocityChange>
      <TimePerStep>0.5</TimePerStep>
      <DampingMultiplier>2</DampingMultiplier>
      <RepulsionMultiplier>2</RepulsionMultiplier>
    </Physics>
    <FixedSpheres>
      [0, −1000, 0] 1000,
      [0, 1001, 0] 1000
    </FixedSpheres>
    <Signal>
      <Local>
        <Separation>0.2</Separation>
      </Local>
    </Signal>
    <Cell>
      <Chemistry><Default/></Chemistry>
      <InitialSize>13</InitialSize>
      <MinimumSize>1</MinimumSize>
      <MaximumSize>2</MaximumSize>
      <InitialChemistry>
        GB1 10
        ( GB1Receptor ) 5
        ( FloodGate ) 50
        ( SurroundedReceptor ) 50
        ( CellAdhesion ) 0.1
      </InitialChemistry>
      <ChemistryEquations>
        { GB1 } + ( GB1 Receptor ) = GB1 + ( GB1Receptor );
        SurroundedSignal + ( FloodGate ) =
          { SurroundedSignal } + ( FloodGate );
        { SurroundedSignal } + ( SurroundedReceptor ) =
          2.0 SurroundedMarker + (Surrounded Receptor );
      </ChemistryEquations>
      <Promoter>
        <Smoother>
          <PromotionMidpoint>5</PromotionMidpoint>
          <Slope>3</Slope>
          <ActiveConcentration>1</ActiveConcentration>
        </Smoother>
      </Promoter>
    </Cell>
    <AdhesionRules>
      ( CellAdhesion ) : ( CellAdhesion );
    </AdhesionRules>
  </Simulation>
  <Genome>
  [
    [ GB1 0.112, SurroundedMarker −0.001 ] [ Growth, Division ],
    [ GB1 0.125 ] [ SurroundedSignal ]
  ]
  </Genome>
  <Shade>
    <UseRadius/><UseModifier/>
    [ S GB1 @ 0 0 0 1 0 1 1 ]
  </Shade>
</CsIndividual>
```

From this base model, the signal isolation and differentiation relevant to stem cell formation can now be implemented. Undifferentiated cells are to behave as stem cells and so should not have undifferentiated neighbors but should signal their neighbors to differentiate. Where two or more undifferentiated cells are together, a signaling competition similar to that in the first example should result in only one of the cells remaining undifferentiated.

All cells should be capable of receiving signals to differentiate. A chemistry equation is added to produce DiffMarker in response to receiving external DiffSignal via surface DiffReceptor, FIG. 25G:

{DiffSignal}+(DiffReceptor)=DiffMarker+(DiffReceptor);

The three molecules are added to the Molecule Catalog with the receptor marked to not decay:

DiffSignal [60, 10];
DiffReceptor [70, 10] 0.0;
DiffMarker [80, 10];

As with previous receptors, DiffReceptor is added to the Initial Chemistry:

### (DiffReceptor) 50

Another equation is added to export internal DiffSignal via surface FloodGate, FIG. 25F:

DiffSignal+(FloodGate)={DiffSignal}+(FloodGate);

An instruction to produce DiffSignal is not yet written and so this signal pathway will not yet be exercised. Undifferentiated cells need to signal neighbors to differentiate, but differentiated cells should not signal their neighbors. A gene assembly producing DiffSignal is added, promoted by GB1, FIG. 25H:

### [GB1 0.4] [DiffSignal]

An inhibiting gene matching DiffMarker is still necessary to prevent differentiated cells from signalling. Similar to the way SurroundedSignal and SurroundedMarker were balanced, the effect value promoting DiffSignal in the genome and the coefficient of DiffMarker in the chemistry equation for response to DiffSignal need to be balanced so that a fully surrounded cell has a concentration of DiffMarker near 120:12 (again, maximum contacting cells) times the concentration of 10 desired in response to signal from a single undifferentiated cell.

The following instruction amends the gene assembly for the balanced inhibition, FIG. 25I. The magnitude of the inhibitory effect should be larger than the promotion effect to ensure that a differentiated cell will not produce and send DiffSignal.

### [GB1 0.4, DiffMarker −0.5] [DiffSignal]

The previously added chemistry equation for importing the signal from the environment is amended to complete the balance:

{DiffSignal}+(DiffReceptor)=3.0 DiffMarker+(DiffReceptor);

At this point, the model produces isolated undifferentiated cells with low concentrations of DiffMarker surrounded by differentiated cells with high concentrations of DiffMarker. Four factors are balanced to produce the central feature of signal isolation: promotion and inhibition effect values controlling DiffSignal expression, promotion effect of DiffMarker on expression of DiffMarker, and the coefficient on DiffMarker in the Chemistry Equation responding DiffSignal. This is sufficient to meet the basic design requirements, but two more refinements will improve the model's fidelity.

To reinforce the distinction between differentiated and undifferentiated cells and to reduce the likelihood of differentiated cells reverted to an undifferentiated state, a positive reinforcement gene assembly for DiffMarker, FIG. 25J, can be added to the <Genome>. The promotion effect value should be as high as possible without allowing a differentiated cell to maintain its concentration of DiffMarker through expression of this gene alone.

### [DiffMarker 0.25] [DiffMarker]

As a demonstration of a tangible potential behavioral effect of differentiation and to complete the model requirements from G2.1, differentiating cells in the model can be made to grow and divide more rapidly than undifferentiated cells, analogous to transit-amplifying cell division rates versus stem division rates. This is accomplished by amending the gene assembly controlling growth and division to include DiffMarker as a promoter with its effect magnitude similar to the inhibition magnitude of SurroundedMarker, FIG. 25K. In general, all effect values in the assembly are adjusted as necessary to yield the slowest growth by internal undifferentiated cells, slightly faster growth by internal differentiated cells, and the fastest growth by perimeter differentiated cells.

### [GB1 0.112, DiffMarker 0.006, SurroundedMarker −0.001] [Growth, Division],

Once this simple model is working as intended, it can be used as-is or enhanced to explore patterns of signal isolation within a tissue given different signaling ranges and distributions.

The final configuration is below:

```
<CsIndividual>
  <MoleculeCatalog>
    GB1 [10, 10];
    GB1Receptor [20, 10] 0.0;
    SurroundedSignal [30, 10];
    SurroundedReceptor [40, 10] 0.0;
    SurroundedMarker [50, 10];
    DiffSignal [60, 10];
    DiffReceptor [70, 10] 0.0;
    DiffMarker [80, 10];
    CellAdhesion [90, 10] 0.0;
    FloodGate [100, 10] 0.0;
  </MoleculeCatalog>
  <Simulation>
    <MaxInterAdhesionLength>0.25</MaxInterAdhesionLength>
    <SingleAdhesionRule>0</SingleAdhesionRule>
    <Physics>
      <MaxVelocityChange>2</MaxVelocityChange>
      <TimePerStep>0.5</TimePerStep>
      <DampingMultiplier>2</DampingMultiplier>
      <RepulsionMultiplier>2</RepulsionMultiplier>
      <NudgeMagnitude>3</NudgeMagnitude>
    </Physics>
    <FixedSpheres>
      [0, −1000, 0] 1000,
      [0, 1001, 0] 1000
    </FixedSpheres>
    <Signal>
      <Local>
        <Separation>0.2</Separation>
      </Local>
    </Signal>
    <Cell>
      <Chemistry><Default/></Chemistry>
      <Promoter>
        <Smoother>
          <PromotionMidpoint>5</PromotionMidpoint>
          <Slope>3</Slope>
          <ActiveConcentration>1</ActiveConcentration>
        </Smoother>
      </Promoter>
      <InitialSize>13</InitialSize>
      <MinimumSize>1</MinimumSize>
      <MaximumSize>2</MaximumSize>
      <InitialChemistry>
        GB1 10
        ( GB1Receptor ) 5
        ( FloodGate ) 50
        ( DiffReceptor ) 50
        ( SurroundedReceptor ) 50
        ( CellAdhesion ) 0.1
      </InitialChemistry>
      <ChemistryEquations>
        { GB1 } + ( GB1Receptor ) = GB1 + ( GB1Receptor );
        SurroundedSignal + ( FloodGate ) =
          { SurroundedSignal } + ( FloodGate );
        { SurroundedSignal } + ( SurroundedReceptor ) =
          2.0 SurroundedMarker + ( SurroundedReceptor );
        DiffSignal + ( FloodGate ) = { DiffSignal } + ( FloodGate );
        { DiffSignal } + ( DiffReceptor ) =
          3.0 DiffMarker + ( DiffReceptor );
      </ChemistryEquations>
    </Cell>
    <AdhesionRules>
      ( CellAdhesion ) : ( CellAdhesion );
    </AdhesionRules>
  </Simulation>
  <Genome>
  [
    [ GB1 0.125 ] [ SurroundedSignal ],
    [ GB1 0.112, DiffMarker 0.006, SurroundedMarker −0.001 ]
      [ Growth, Division ],
    [ GB1 0.4, DiffMarker −0.5 ] [ DiffSignal ],
      [ DiffMarker 0.25 ] [ DiffMarker ]
  ]
  </Genome>
  <Shade>
    <UseRadius/><UseModifier/>
    [ S GB1 @ 0 0 0 1 0 1 1 ]
  </Shade>
</CsIndividual>
```

The resulting SGRN from this configuration is given by FIG. 26 and may be read as follows:

Nutrient for this model is provided by the external GB1 molecule which is moved to the interior of a cell via “EQ 1” with surface GB1 Receptors.

Once inside the cell, GB1 promotes each of genes “GENE 1”, “GENE 2”, “GENE 3”, and “GENE 4”. Genes “GENE 2” and “GENE 3” directly promote division and growth of cells and in the beginning of development provide stimulus for the model to expand.

However, “GENE 1” is also promoted by GB1 to produce SurroundedSignal. When moved to the outside of a given cell by “EQ 2” using surface FloodGate molecules, other cells may receive it. In this way, a cell can signal to others that it exists and so contributes to how surrounded the receiving cell is. The receiving cell accepts SurroundedSignal with “EQ 3” and its own surface SurroundedReceptor. It is received as SurroundedMarker which in turn inhibits “GENE 3” and “GENE 4” and so counteracts the influence of the nutrient.

GB1's promotion of “GENE 4” leads to the production of DiffSignal which also combines with surface FloodGate in “EQ 4” to be transported outside the cell. Other cells receive this through their DiffReceptor surface molecules in “EQ 5” as DiffMarkers. Once in a cell, “GENE 5” amplifies these DiffMarker molecules which go on to contribute to the promotions of “GENE 3” and “GENE 4”.

The more a cell is signaled to differentiate, the more it is likely to grow and divide; those cells not so differentiated are essentially rudimentary stem cells. Independent of that dynamic, the more a cell is signaled that it is surrounded, the less it will grow and divide.

### G3. Example 3

### Virtual Epithelium

The third example applies principles from the previous examples to model epithelial tissue. With the preferred embodiment, several approaches with varying fidelity and complexity can be taken to model more complex subjects such as epithelial tissue: the present example describes only one such solution. It will be appreciated that by practicing development principles applied in this and the previous examples, a range of such solutions can be generated.

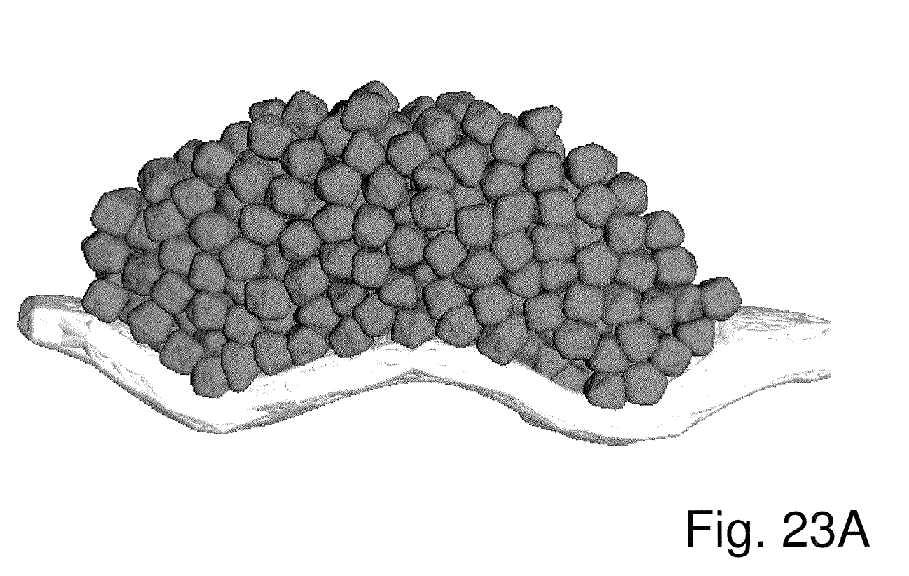

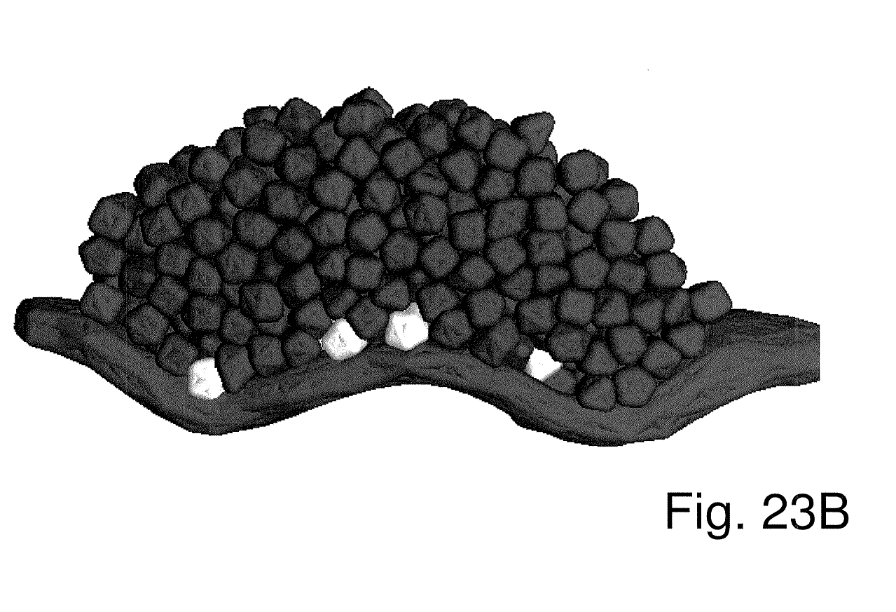

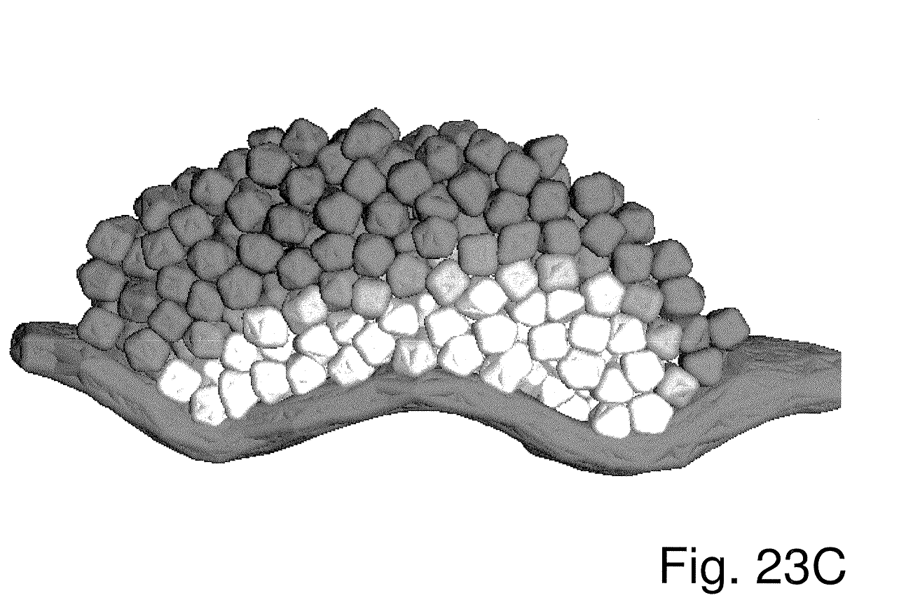

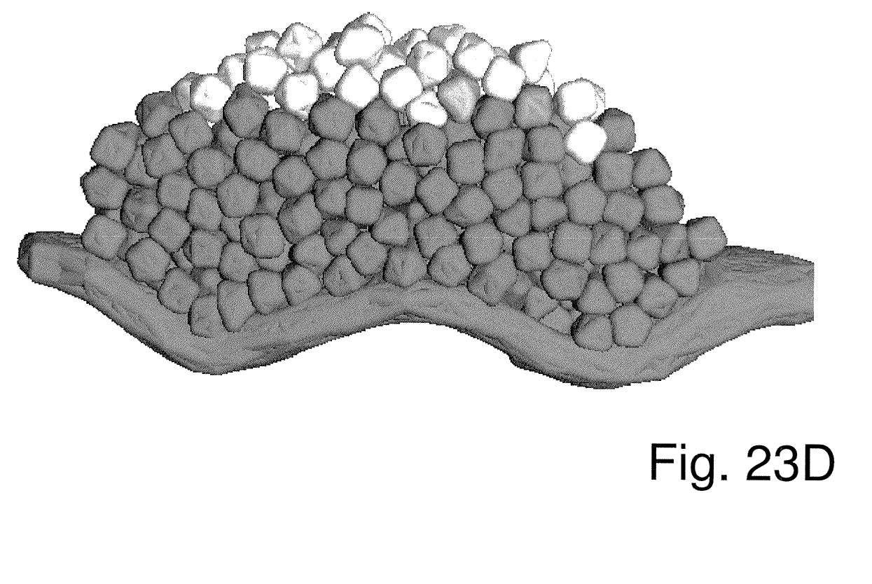

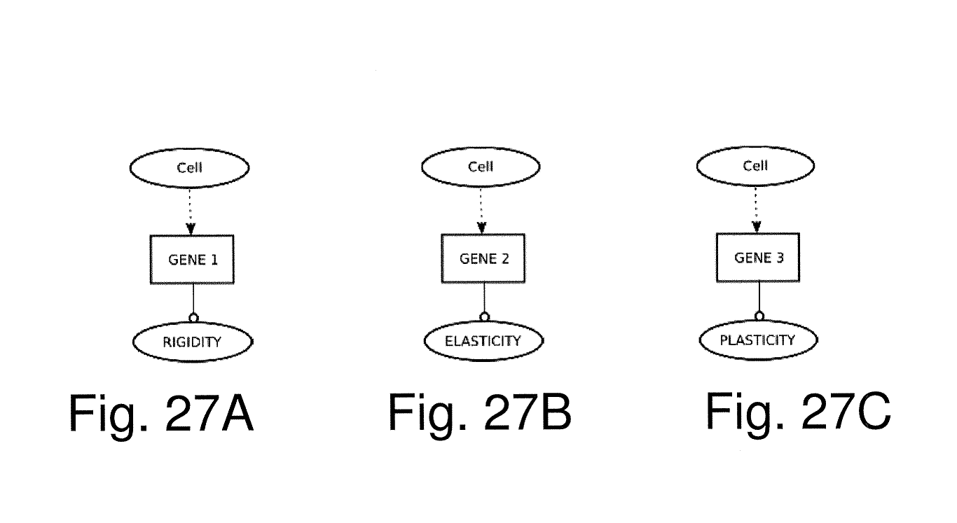

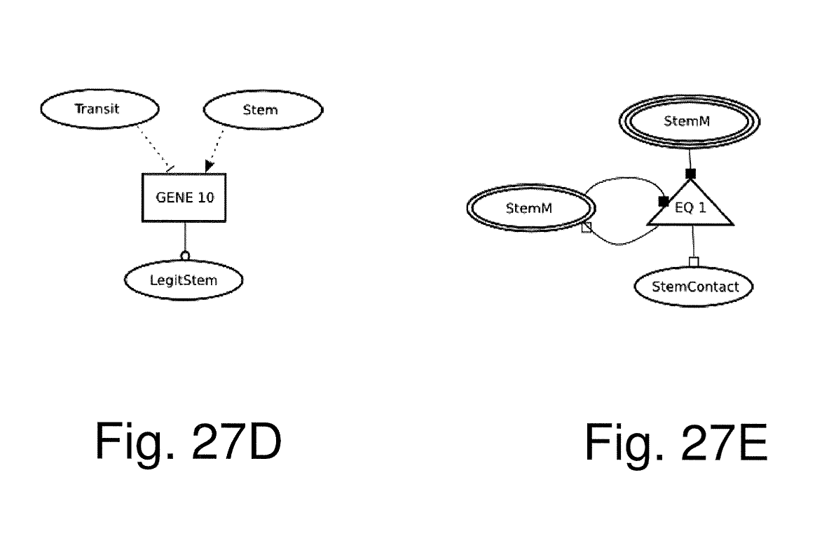

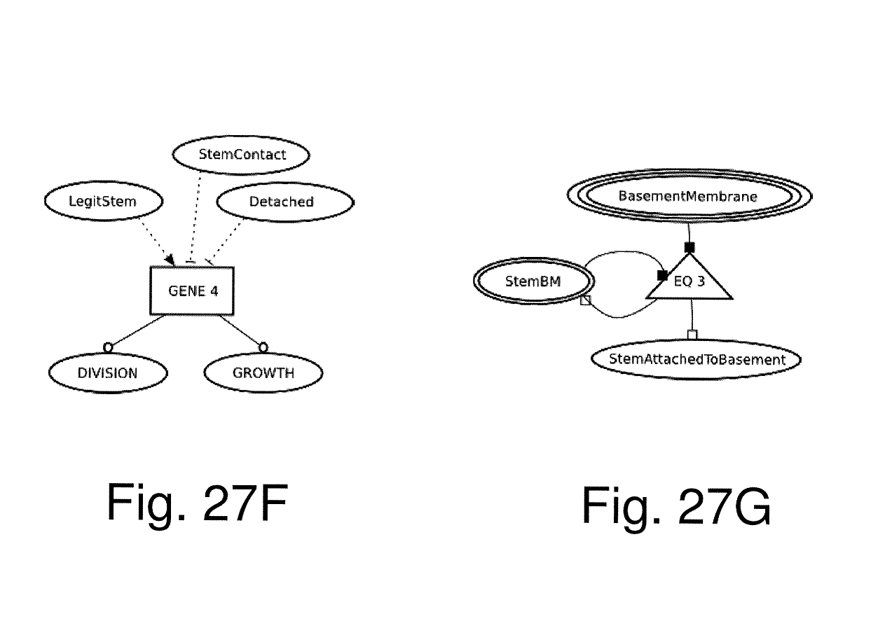

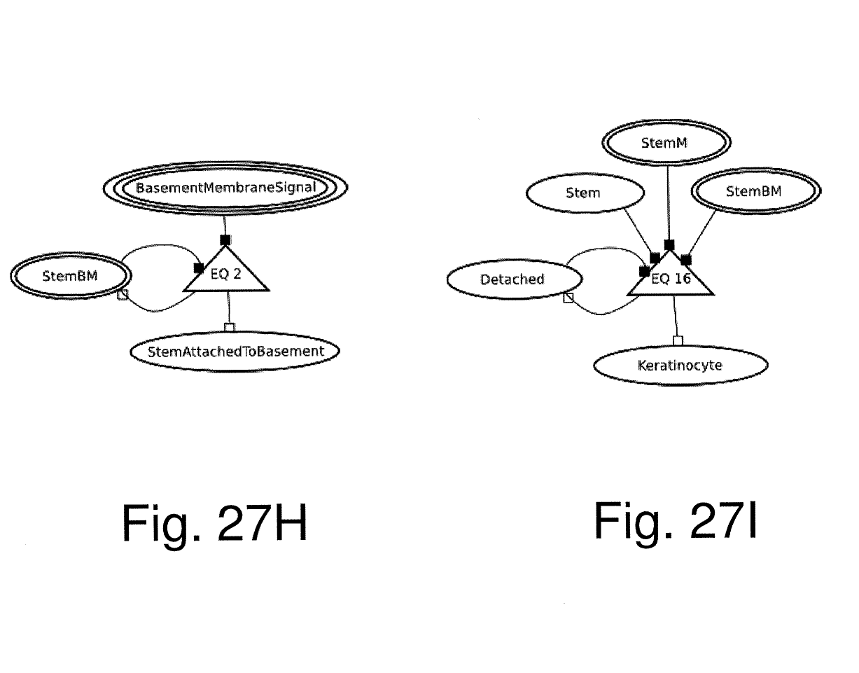

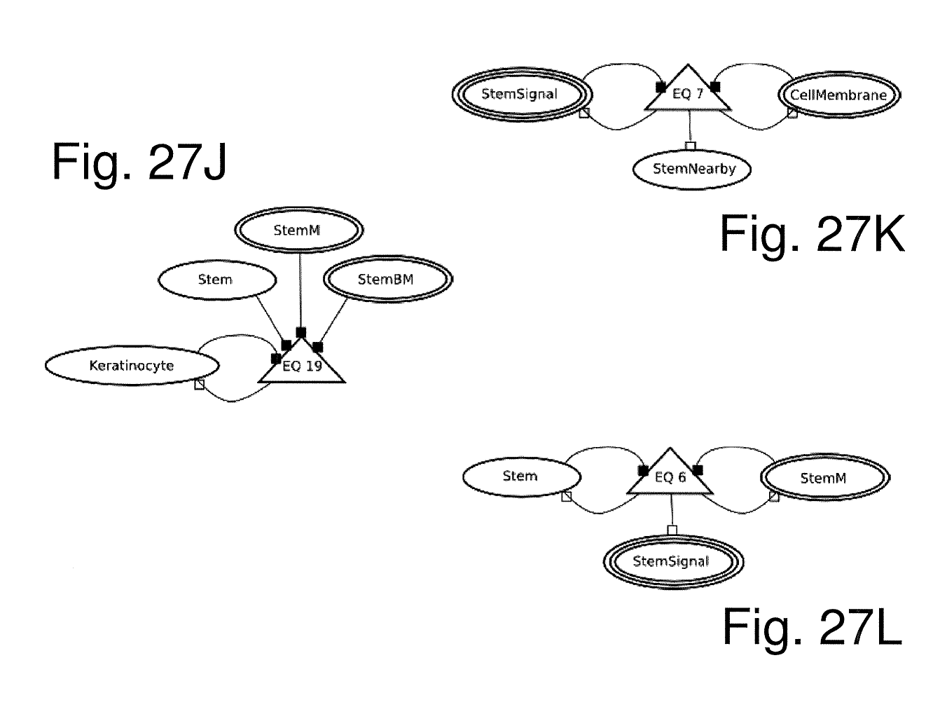

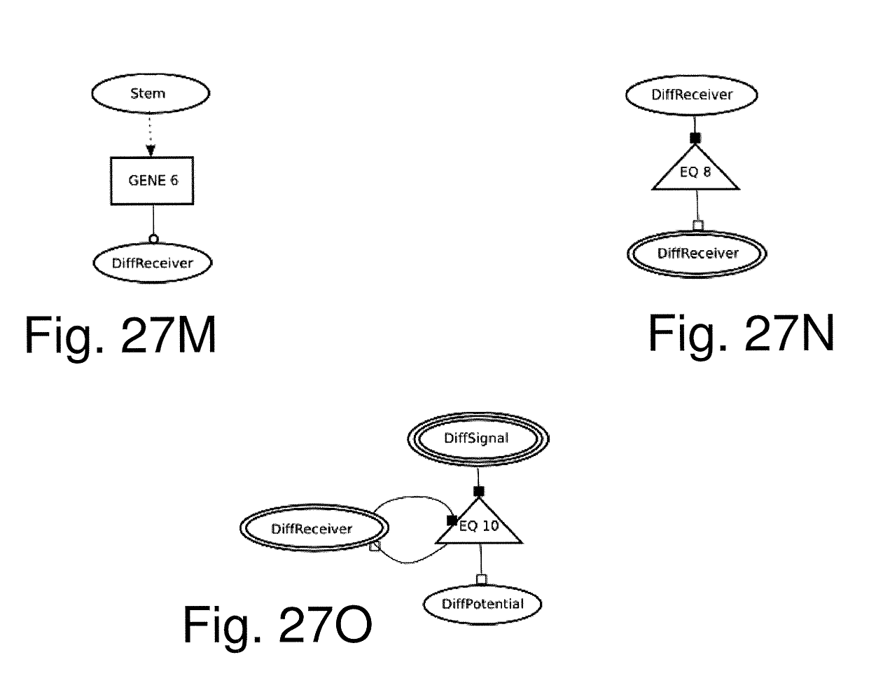

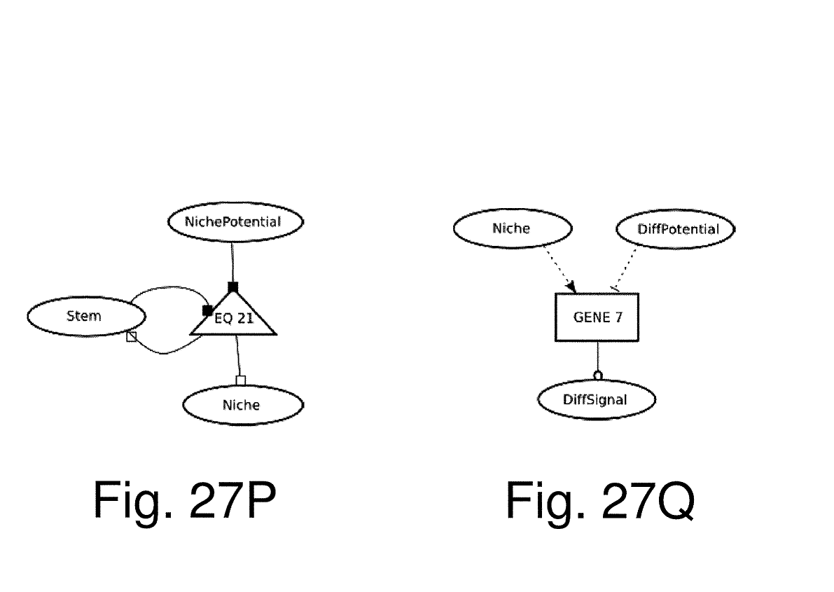

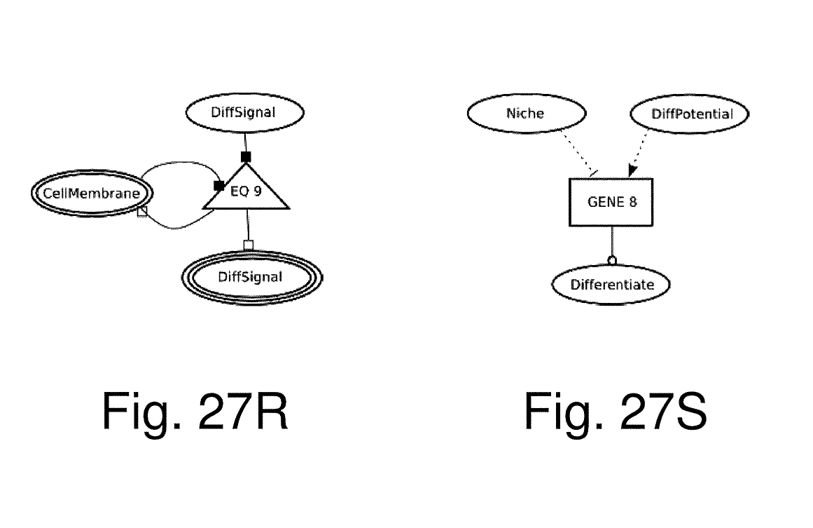

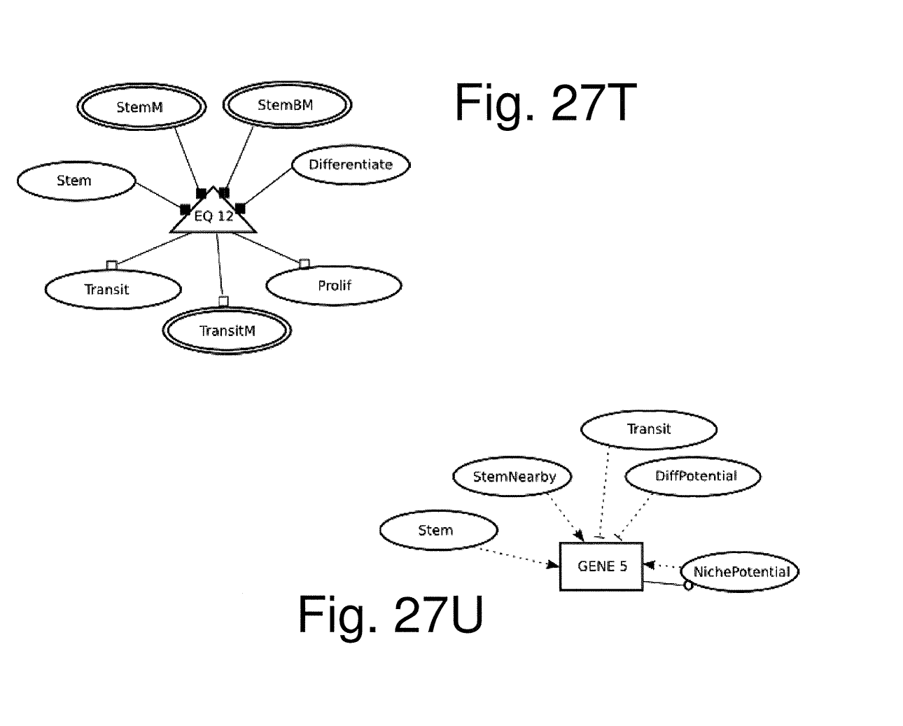

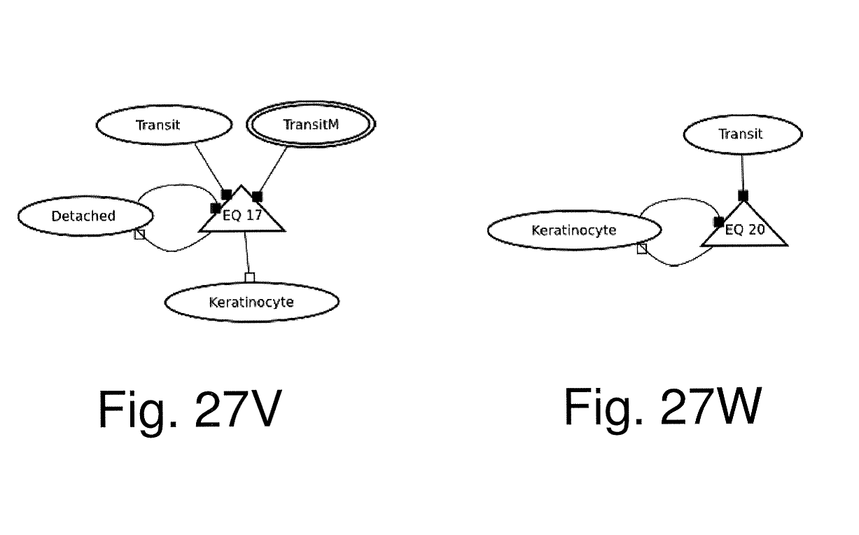

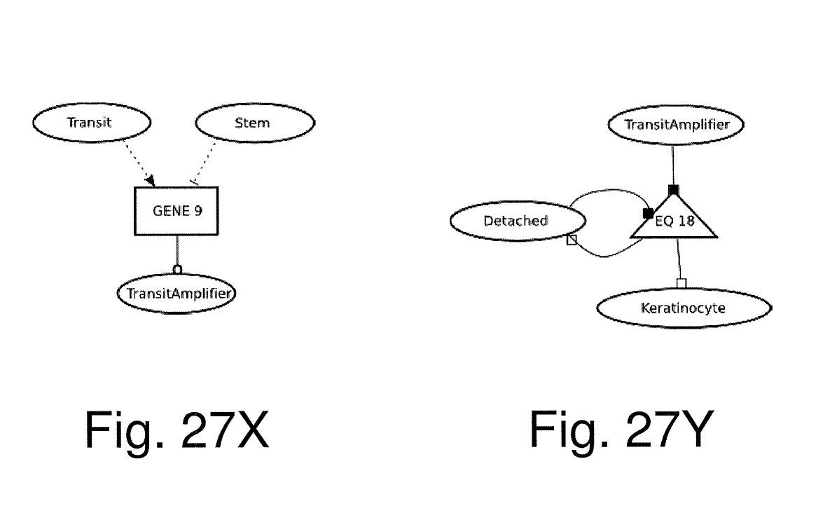

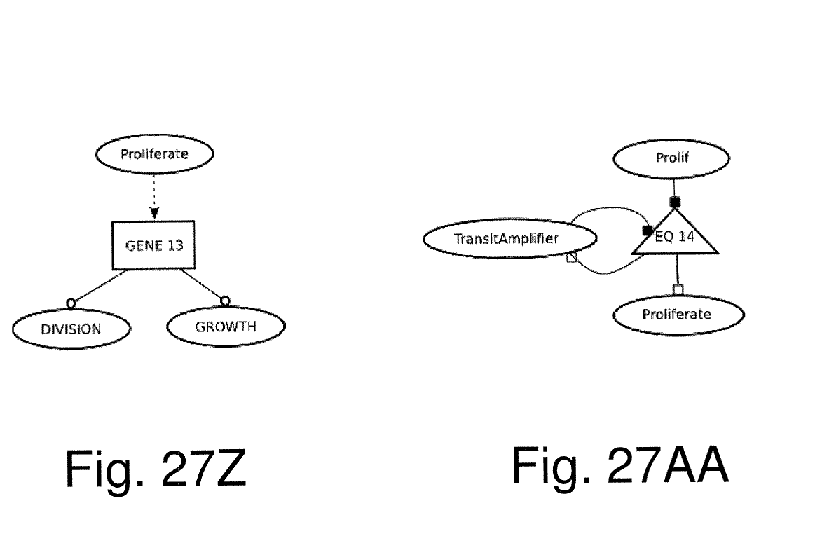

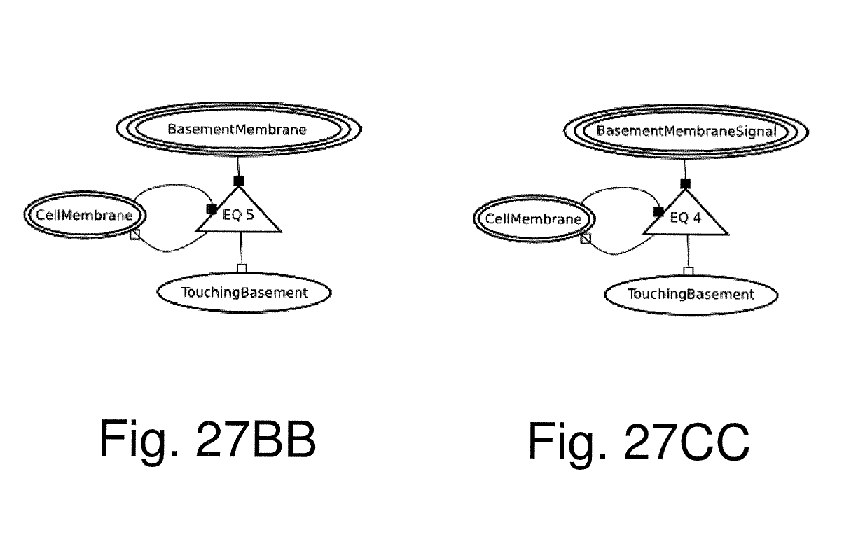

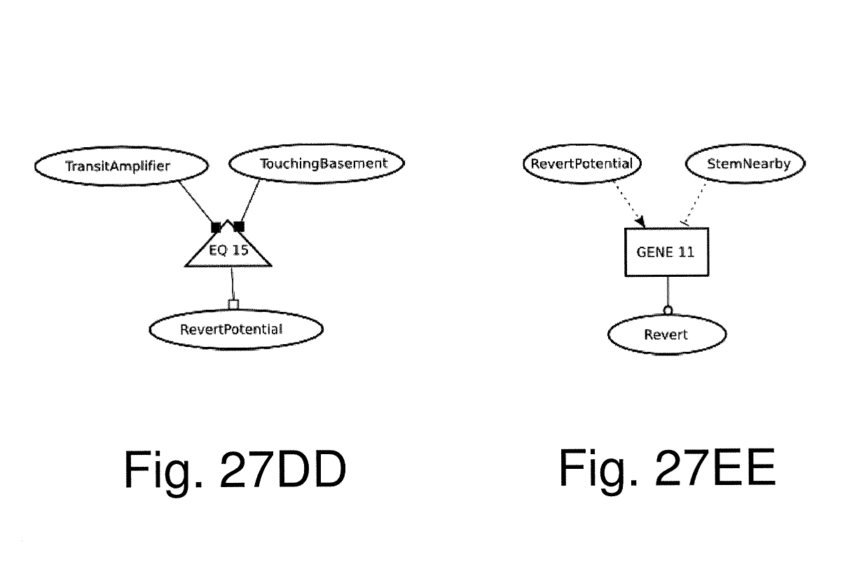

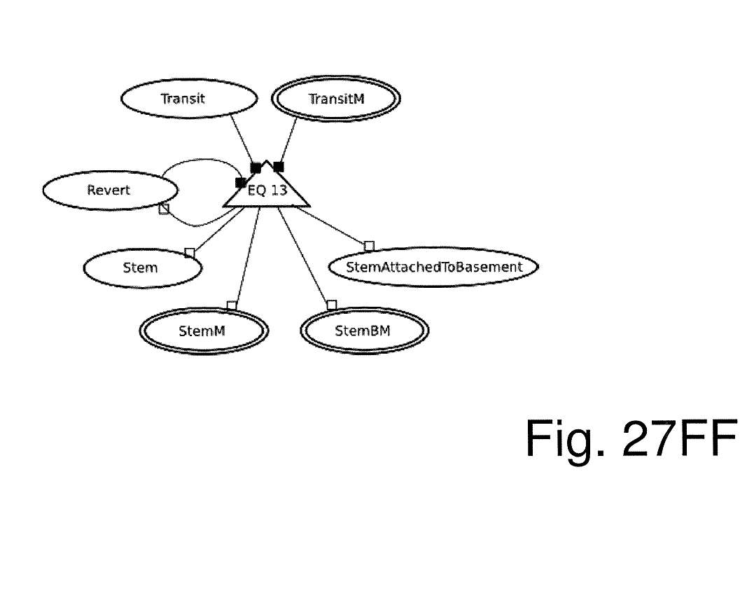

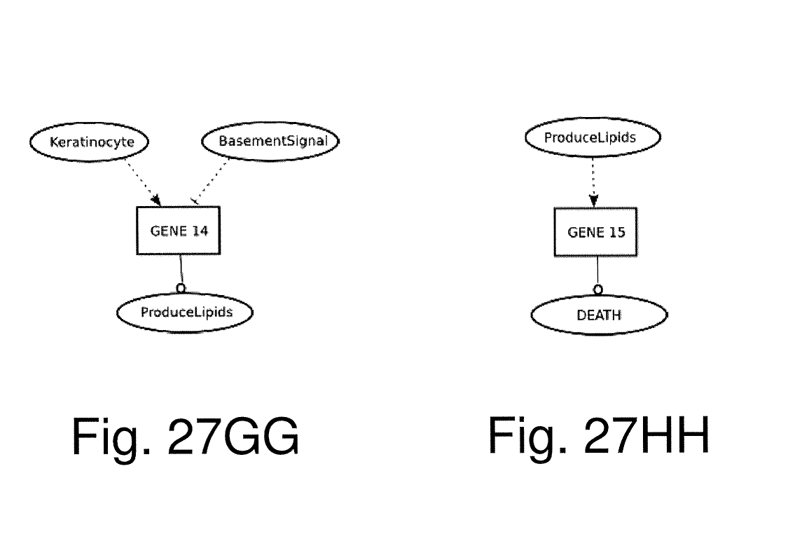

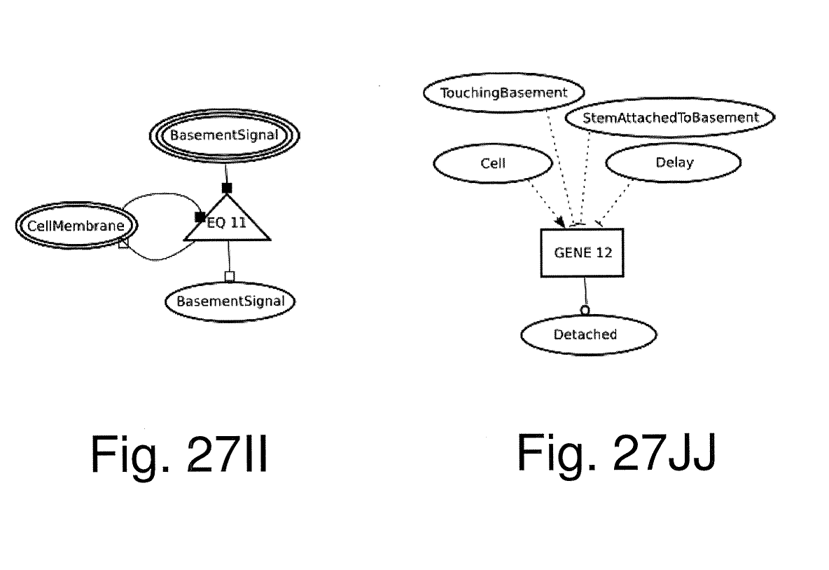

FIG. 23A represents a virtual epithelial tissue developed by the preferred embodiment. This small cross-section of epithelial tissue rests on a slightly irregular basement membrane, highlighted in the figure. From the same simulation moment as FIG. 23A, the tissue's stem cells are highlighted in FIG. 23B. In FIG. 23C, again from the same simulation moment as FIGS. 23A and 23B, all cells near the stem cells are highlighted. This indicates that any highlighted stem or transit amplifying cells are influenced to suppress their stem character. From a later simulation moment, FIG. 24D highlights the virtual cells producing molecules corresponding to lipids. The components of the SGRN for this example are described in Section G3.3.3 below with reference to FIGS. 27A-27JJ.

G3.1. Describing the Model

Living epithelial tissue is characterized by a constant generation and flow of cells from a basement membrane to its surface. Across the basement membrane, stem cells and transit amplifier cells proliferate. As they do so, they become physically pressured to detach from the membrane. Stem cells adhere most strongly to the basement membrane; as cells differentiate, their attachment to the membrane weakens. Thus, most cells that detach are transit amplifier cells. Cells that detach from the basement continue to differentiate into keratinized cells; these keratinocytes eventually produce fatty oils, called lipids.

The stem cells exist in small groups called niches. As a niche enlarges, the cells on its periphery become transit amplifying cells. Not yet committed to differentiation, these cells retain some stem cell character and so can revert to stem cells. This reversion can happen if the cells stay attached to the basement membrane and find themselves sufficiently far from already established stem cell niches. The establishment and maintenance of stem cell niches is consistent with living stem cell formation in epithelial tissue. Peripheral stem cells are not able to become transit amplifier cells unless there is a sufficiently large population of stem cells nearby. In this model, the niches arise from such stem cells. The stem cells most likely to retain their stem character are those at the center of the niche. Once the niche is reduced in size by peripheral attrition to transit amplifying cells, the central stem cells divide and the process continues.

As the population of keratinocytes increases, they are pushed away from the basement membrane. As they move farther away, they receive less signal from the membrane and begin to produce lipids.

G3.2. Decomposing the Problem to Identify Cell-Level Features

As in the previous examples, intended cell states are listed:

| | |
|---|---|
| Stem: | Undifferentiated cell attached to the basement membrane. |
| | The initial cell of the simulation is a stem cell. |
| Transit | Cells differentiated from stem cells by detachment from |
| Amplifier: | the basement membrane proliferate to produce |
| | most of the cells in the simulation. |
| | These cells cannot revert to stem cells once detached |
| | from the basement membrane. |
| Keratinocyte: | Cells that were Transit Amplifier cells will differentiate |
| | further when a sufficient distance from the basement |
| | membrane. These cells cannot grow or divide nor revert |
| | to Transit Amplifier cells. |
| Lipid | Keratinocytes beyond the signaling range of the |
| Producing | basement membrane produce lipids. |

Dead cells are simply removed from the simulation to optimize computation. These dead cells are interpreted as those sloughed off in the normal cycle of living epithelial development.

The initial cell starts on a special construct called a Basement Membrane, described further below. The basement membrane is to be the anchor point for the virtual epithelium and corresponds to the basal lamina in vivo. Virtual stem cells are to proliferate in the simulation and produce more cells that can fit on the basement membrane. The cells that detach from the membrane undergo several stages of changes as they are pushed up by younger cells from the basement membrane.

For simplicity and to avoid having to grow a basement membrane, which would have led to growing yet other anatomical structures, a special construct is supported by the preferred embodiment of the ontogeny engine for specification of a basement membrane. This example <BasementMembrane> construct is treated as a large cell of numerous subspheres arranged as a sheet. It is specified with its own genome and chemistry equations and so may be considered as a special initial cell.

G3.3. Writing the Configuration File

The configuration is designed starting from a simulation configuration template, with details interpreted in previous examples and in section E.

```
<CsIndividual>
  <MoleculeCatalog>
  </MoleculeCatalog>
  <Simulation>
    <Physics>
      <TimePerStep>.2</TimePerStep>
      <DampingMultiplier>1</DampingMultiplier>
      <RepulsionMultiplier>2</RepulsionMultiplier>
      <NudgeMagnitude>3</NudgeMagnitude>
    </Physics>
    <Signal>
      <Local>
        <Separation>.3</Separation>
      </Local>
    </Signal>
    <ECMDefinitionRules></ECMDefinitionRules>
    <Cell>
      <Chemistry><Default/></Chemistry>
      <Promoter>
        <Smoother>
          <PromotionMidpoint>5</PromotionMidpoint>
          <Slope>10</Slope>
          <ActiveConcentration>1</ActiveConcentration>
        </Smoother>
      </Promoter>
      <MaximumSize>50</MaximumSize>
      <InitialSize>8</InitialSize>
      <MinimumSize>6</MinimumSize>
      <ECMProductionRules></ECMProductionRules>
      <InitialChemistry>
      </InitialChemistry>
      <ChemistryEquations>
      </ChemistryEquations>
    </Cell>
  </Simulation>
  <Genome>
  [
  ]
  </Genome>
</CsIndividual>
```

G3.3.1. Establishing a Basement Membrane and Initial Environment

The special <BasementMembrane> construct in the preferred embodiment includes subordinate <Cell> (see E3.6) and <Genome> (see E4) sections separate from those of other cells in the simulation to supply special genome and chemistry equations sufficient to keep its shape and supply it with the desired adhesive and signaling characteristics of an epithelial basement membrane. It also supports a special <Bounds> tag to specify its size and location in the environment. The <Bounds> describes two opposing “corners” of the membrane sheet to be filled with subspheres.

The following adds an inert basement membrane:

```
<BasementMembrane>
  <Bounds>[−22, −2.5, −5][28, −1.0, 7]</Bounds>
  <Cell>
    <Chemistry><Default/></Chemistry>
    <Promoter>
      <Smooth>
        <PromotionMidpoint>6</PromotionMidpoint>
        <ActiveConcentration>1</ActiveConcentration>
      </Smooth>
    </Promoter>
    <InitialChemistry>
    </InitialChemistry>
    <ChemistryEquations>
    </ChemistryEquations>
  </Cell>
  <Genome>
  [
  ]
  </Genome>
</BasementMembrane>
```

The initial shape and physical responsiveness of the membrane is given by specifying initial values for Rigidity and Elasticity under <InitialChemistry> for the <BasementMembrane>:

### Rigidity 10

### Elasticity 10

As Rigidity and Elasticity are special adhesion factors, the preferred embodiment of the ontogeny engine imposes a constant decay. Therefore, these adhesion molecules must be replenished throughout the simulation. One technique is genetic production of Rigidity and Elasticity. This requires some undecaying internal molecule to promote the production.

First, this internal molecule is defined in the simulation's<MoleculeCatalog>:

### BasementMembrane [8000, 10] 0;

The molecule is then established in the <InitialChemistry> for the <BasementMembrane>:

### BasementMembrane 10

Finally, it is used to constantly promote production of Rigidity and Elasticity by the <Genome> of the <BasementMembrane>:

### [BasementMembrane 2.8][Rigidity],

### [BasementMembrane 0.2] [Elasticity]

For this example, a basement membrane is critical for cell signaling so that basal cells can recognize attachment. As with all signals, this is done by moving molecules into the environment with a surface molecule. The following reuses the undecaying BasementMembrane molecule to supply surface molecule in the <InitialChemistry> of the <BasementMembrane>. Since metabolism of a basement membrane is not the subject of the present example and has no analogy in living membranes, there is no need for a mechanism to move an internal molecule to the surface: the molecule can simply be reused.

### (BasementMembrane) 10

The above surface molecule will be directly seen as an external molecule by any contacting cell. To allow portions of a cell in contact to the membrane recognize contact proximity, a spontaneous, constant signal from the membrane itself is established. Given that the simulation's local signal distance is less than subsphere radii (see initial configuration template, G3.3), a cell must be in or near contact to receive this signal. The following instruction is added to the <ChemistryEquations> of the <BasementMembrane>:

(BasementMembrane)=(BasementMembrane)+{50 BasementMembraneSignal};

<FixedSpheres> are added below the basement membrane to give it an undulated shape similar to skin epithelium:

```
<FixedSpheres>
  [0,−5,0] 7,
  [17,−5,0] 7,
  [−17,−5,0] 7,
</FixedSpheres>
```

Large fixed spheres are added around the basement membrane to the above <FixedSpheres> as a virtual container to prevent cells from going beyond the edge of the basement membrane surface:

[−10000,0,0] 9975,
[10000,0,0] 9975,
[0,0,−10000] 9997.5,
[0,0,10000] 9997.5,
[0, −10000, 0] 9996

To produce a gradient consistent with that of dermal tissue under an undulating basement membrane, new source points must be added below the membrane. This is done by adding a gradient Shade to the simulation with gradient builders:

```
<Shade>
  <UseRadius/>
  <UseModifier/>
  [
    S [6000,10] @ 17 −6 0 10 0.8 1 10,
    S [6000,10] @ 0 −6 0 10 0.8 1 10,
    S [6000,10] @ −17 −6 0 10 0.8 1 10
    ]
</Shade>
```

For ease of reference later, an entry matching this new signal's molecular signature is made to the simulation's<MoleculeCatalog> as BasementSignal:

### BasementSignal [6000, 10];

The configuration so far produces an undulated, signaling basement membrane draped over three large spheres with large spheres on its sides to keep the cells from falling off the membrane's edge. Below is the intermediate configuration from which to begin developing epithelial form and behavior:

```
<CsIndividual>
  <MoleculeCatalog>
    BasementMembrane [8000, 10] 0;
    BasementSignal [6000, 10];
  </MoleculeCatalog>
  <Simulation>
    <Physics>
      <TimePerStep>.2</TimePerStep>
      <DampingMultiplier>1</DampingMultiplier>
      <RepulsionMultiplier>2</RepulsionMultiplier>
      <NudgeMagnitude>3</NudgeMagnitude>
    </Physics>
    <Signal>
      <Local>
        <Separation>.3</Separation>
      </Local>
    </Signal>
    <ECMDefinitionRules></ECMDefinitionRules>
    <BasementMembrane>
      <Bounds>[−22, −2.5, −5][28, −1.0, 7]</Bounds>
      <Cell>
        <Chemistry><Default/></Chemistry>
        <Promoter>
          <Smooth>
            <PromotionMidpoint>6</PromotionMidpoint>
            <ActiveConcentration>1</ActiveConcentration>
          </Smooth>
        </Promoter>
        <InitialChemistry>
          Rigidity 10
          Elasticity 10
          BasementMembrane 10
          (BasementMembrane) 10
        </InitialChemistry>
        <ChemistryEquations>
          (BasementMembrane) =
            (BasementMembrane) + {50 BasementMembraneSignal };
        </ChemistryEquations>
      </Cell>
      <Genome>
        [
          [ BasementMembrane 2.8 ][ Rigidity ],
            [ BasementMembrane .2 ] [ Elasticity ]
        ]
      </Genome>
    </BasementMembrane>
    <Cell>
      <Chemistry><Default/></Chemistry>
      <Promoter>
        <Smoother>
          <PromotionMidpoint>5</PromotionMidpoint>
          <Slope>10</Slope>
          <ActiveConcentration>1</ActiveConcentration>
        </Smoother>
      </Promoter>
      <MaximumSize>50</MaximumSize>
      <InitialSize>8</InitialSize>
      <MinimumSize>6</MinimumSize>
      <ECMProductionRules></ECMProductionRules>
      <InitialChemistry>
      </InitialChemistry>
      <ChemistryEquations>
      </ChemistryEquations>
    </Cell>
    <FixedSpheres>
      [0,−5,0] 7,
      [17,−5,0] 7,
      [−17,−5,0] 7,
      [−10000,0,0] 9975,
      [10000,0,0] 9975,
      [0,0,−10000] 9997.5,
      [0,0,10000] 9997.5,
      [0, −10000, 0] 9996
    </FixedSpheres>
  </Simulation>
  <Genome>
    [
    ]
  </Genome>
  <Shade>
    <UseRadius/>
    <UseModifier/>
    [
      S [6000,10] @ 17 −6 0 10 0.8 1 10,
      S [6000,10] @ 0 −6 0 10 0.8 1 10,
      S [6000,10] @ −17 −6 0 10 0.8 1 10
    ]
  </Shade>
</CsIndividual>
```

G3.3.2. Initial Epithelial Stem Cell

For a cell to be considered a stem cell, a cell will be required to have sufficient Stem molecule. This must be added to the <InitialChemistry> of the starting cell in a sufficient amount to promote genes to be added later in this example:

### Stem 50

It then must also be added to the <MoleculeCatalog> to not decay:

### Stem [100, 10] 0;

A division rule (see Section E.3.6.7.8.) is added under <Cell> to assure that stem cells divide along the basement membrane; that is, perpendicular to the line between the centers of the contacted membrane subsphere and the contacting cell. Because it is a single rule, the coefficient is arbitrary. To avoid conflicts with tracking the cell state, a new surface molecule, StemBM, is introduced solely for support of this division:

<DivisionRules>
.1 Stem perpendicular (StemBM);
</DivisionRules>

The new molecule StemBM is added to the <MoleculeCatalog> and set to not decay:

### StemBM [180, 10] 0;

Because the initial cell should have this property, StemBM is added to <InitialChemistry> as a surface molecule:

### (StemBM) 50

Since an undifferentiated cell must be attached to the basement membrane for it to be considered a stem cell, adhesion rules must be established, under <Simulation>, to attach the initial cell to the basement membrane. Alternatively, the adhesion could equivalently involve Stem molecules moved to the surface instead of the special surface StemBM.

<AdhesionRules>
( BasementMembrane ) : ( StemBM );
</AdhesionRules>

G3.3.3. Production of Stem Cells and Terminally Differentiated Keratinocytes

To promote regular cell shaping, three genes are added to the <Genome>, depicted in FIGS. 27A, 27B, and 27C. Since the Stem and StemBM molecules will not exist in differentiated cells, a new molecule Cell is made present in all cells for shaping.

[ Cell .4 ][ Rigidity ],
[ Cell .2 ][ Elasticity ],
[ Cell .6 ][ Plasticity ],

The Cell molecule is now added to the <MoleculeCatalog> to not decay so as to be perpetuated in all cells:

### Cell [400, 10] 0;

For this, the <InitialChemistry> must include Cell in the initial cell:

### Cell 10

Stem cells have the ability to grow and divide and so a gene is added to support stem cell growth and division. However, as stem cells differentiate, the Stem molecule will be lost. Therefore, a molecule LegitStem is introduced to control growth and division of stem cells:

### [LegitStem 1] [Division, Growth],

LegitStem's production then is promoted by the presence of Stem and inhibited by transition away from a stem cell. The following gene promotes the production of LegitStem molecule when Stem molecule is present and inhibits it in the presence of a Transit molecule, FIG. 27D. The production of the Transit molecules is discussed later in this example.

### [Stem 2, Transit −4] [LegitStem],

In this example model, stem cells can not divide if surrounded by other stem cells. Therefore, the gene added earlier can be amended to inhibit growth and division upon contact with other stem cells. For this, the molecule StemContact is introduced. As is typical in this example with the preferred embodiment, the final coefficient for StemContact in this gene is determined from iterative experimentation throughout this configuration's development.

### [LegitStem 1, StemContact −0.87] [Division, Growth],

Contact with another stem cell can be determined through detection of a surface molecule that exists on both the subject and contacting stem cells. For this, a chemistry equation using a dedicated molecule StemM is added to produce internal StemContact molecule, FIG. 27E. Again, iterative experimentation establishes its coefficient.

{StemM}+(StemM)=(StemM)+0.2 StemContact;

Since StemM is to be present in all stem cells, it is added as a non-decaying molecule to the <MoleculeCatalog>:

### StemM [150, 10] 0;

The initial cell is also imbued with StemM as a surface molecule, under <InitialChemistry>:

### (StemM) 50

An epithelial stem cell can not grow and divide if it is detached from the basement membrane. The gene promoting growth and division is amended once again to be inhibited if the cell has detached, recognized through a Detached molecule. The gene controlling growth and division is now complete with three conditions, FIG. 27F:

### [LegitStem 1, StemContact −0.87, Detached −2] [Division, Growth],

The production of Detached is dependent on attachment to the basement membrane. As long as a cell is attached, the molecule should not be produced. When a cell gets pushed off the basement membrane, it produces Detached molecule.

### [StemAttachedToBasement −3.2] [Detached],

Without promotion, Detached will never be produced. The gene can be amended with the common Cell molecule to always produce Detached in the absence of attachment to be basement membrane. Later in this example description other amendments to this gene are discussed.

### [Cell 1.5, StemAttachedToBasement −3.2-] [Detached],

Production of StemAttachedToBasement is produced from contact of a stem cell to the basement membrane. The chemistry equation below establishes a contact signal between the membrane and the cell, FIG. 27G:

{BasementMembrane}+(StemBM)=(StemBM)+StemAttachedToBasement;

If a portion of the cell (i.e., one or more subspheres) is not in contact with the membrane, then its reception of signal is dramatically reduced compared to a cell in more complete contact with the membrane. The chemistry equation below moderates this by relying on a signal direct from the membrane to even out the production when portions of a cell are very near to the membrane, FIG. 27H:

{BasementMembraneSignal}+(StemBM)=(StemBM)+StemAttachedToBasement;

As stem cells divide and fill the basement membrane, daughter cells are forced by physics to detach from the membrane and so begin to differentiate permanently into keratinocytes. From the earlier gene producing Detached, such cells produce Detached molecule and so promote stem cells to transition. This is implemented with a chemistry equation, FIG. 27I:

Stem+(StemBM)+(StemM)+Detached=Detached+5 Keratinocyte;

Since the keratinocytes are terminally differentiated, the internal molecule should not decay; the Keratinocyte molecule is added under the <MoleculeCatalog>:

### Keratinocyte [2000, 10] 0;

Further, as the cells make this transition, they lose their stem cell characteristics. The following chemistry equation consumes the stem cell molecules to implement this loss, FIG. 27J:

Keratinocyte+Stem+(StemBM)+(StemM)=Keratinocyte;

G3.3.4. Stem Niches and Transit Amplifier Cells

To this point, the model produces only stem cells and keratinocytes. The production of the keratinocytes is limited by the production of the stem cells to produce detached cells. This approach is insufficient to generate the volume of cells needed for model fidelity and does not recognize how living epithelial tissue leverages stem cell production to produce many more cells. Therefore, the mechanisms associated with stem cell niches and transit amplifying cells need to be added to the model configuration.

As described previously in this example and in the second example under G2, stem niches are isolated clusters of stem cells. Potential for stem niches arise and are reinforced as stem cells acquire and keep stem cell neighbors through the following gene:

### [Stem 0.7, StemNearby 0.4, NichePotential 0.25] [NichePotential],

The internal molecule StemNearby is the product of a signal from other stem cells. A portion of StemSignal is passed along by a receiving cell to adjoining cells and so is dampened as it travels. A general surface molecule, CellMembrane, acts as a receiver for the StemSignal to produce the internal StemNearby molecule. This chemistry equation is depicted in FIG. 27K:

{StemSignal}+(CellMembrane)=(CellMembrane)+0.7 StemNearby+{0.5 StemSignal};

From iterative experimentation with the preferred embodiment during the development of the configuration, an adjustment to the decay of StemNearby is suggested. It is specified in the <MoleculeCatalog>.

### StemNearby [2600, 10] 0.5;

As is typical in this example for transport molecules, CellMembrane is marked as nondecaying in the <MoleculeCatalog>:

### CellMembrane [300, 10] 0;

Likewise, CellMembrane is added as a surface molecule to the <InitialChemistry>:

### (CellMembrane) 50

For stem cells to broadcast their proximity, the following chemistry equation, FIG. 27L, causes stem cells to externally produce StemSignal molecule:

Stem+(StemM)=Stem+(StemM)+{StemSignal};

Stem cells in this example use a similar approach as the previous examples to promote differentiation of other stem cells based on signal competition, and so further separate stem niches. As long as a cell remains a stem cell it produces differentiation receiver molecules via the following gene, FIG. 27M:

### [Stem 2] [DiffReceiver],

A chemistry equation moves the receiver molecule to the cell surface, FIG. 27N:

### DiffReceiver=(DiffReceiver);

Signals received from other cells increase the potential for cell differentiation through a chemistry equation, FIG. 27O:

{DiffSignal}+(DiffReceiver)=(DiffReceiver)+2 DiffPotential;

As a cell maintains its stem cell state and gains NichePotential, it gains internal Niche molecule through a chemistry equation, FIG. 27P.

NichePotential+Stem=Stem+Niche;

As a cell maintains its membership in a stem niche and resists reception of DiffSignal from other cells, it produces more DiffSignal through the following gene, FIG. 27Q, to signal neighbor cells to differentiate.

### [Niche 1, DiffPotential −2] [DiffSignal]

Produced DiffSignal is exported by chemistry equation, FIG. 27R, as a signal through the cell membrane's transport molecule, CellMembrane:

DiffSignal+(CellMembrane)=(CellMembrane)+{DiffSignal};

As a cell loses membership in a stem niche, accepts more DiffSignal and so gains DiffPotential, it produces more internal Differentiate molecule through the following gene, FIG. 27S:

### [DiffPotential 4, Niche −6] [Differentiate]

Increasing DiffPotential should also inhibit a cell's potential to stay with a stem niche. This is done by amending the gene for NichePotential added earlier in this section:

### [Stem 0.7, StemNearby 0.4, DiffPotential −3, NichePotential 0.25] [NichePotential],

Transit amplifying cells are proliferating cells still attached to the basement membrane but not part of a stem niche. The transition from a stem cell to a transit amplifying cell is not immediate. Before a cell reaches the transit amplifying state and begin proliferating as in FIG. 22, any internal molecules from its stem cell state must be disposed and so a mechanism is required by which the cell progressively gains the potential to proliferate while consuming any remaining molecules related to its prior stem cell state.

Transit molecule represents a cell's state of transition from a stem cell to a transit amplifying state. Transit molecule is configured to not decay with an entry in the <MoleculeCatalog>.

### Transit [1400, 10] 0;

The following chemistry equation, FIG. 27T, converts stem cell molecules to produce transit molecules. The internal Stem molecule, its associated surface StemM and adhesive surface StemBM molecules are consumed with Differentiate to produce internal Transit molecules. TransitM surface molecules, with a coefficient of 0.5, replace StemBM to maintain a weaker adhesion to the membrane. Prolif, discussed later, is also produced and accumulated to support cell proliferation once the transitioning cell becomes a transit amplifier.

Stem+(StemM)+(StemBM)+Differentiate=Transit+(0.5 TransitM)+0.3 Prolif;

A new <AdhesionRule>, under <Simulation>, establishes TransitM as adhering to the basement membrane:

### (BasementMembrane): (TransitM);

Cells in transition should not continue or establish membership in a stem niche and so the gene previously added is amended to its final configuration, FIG. 27U:

### [Stem 0.7, Transit −3, StemNearby 0.4, DiffPotential −3, NichePotential 0.25] [NichePotential],

Cells that are in the transition process are still subject to differentiation should they detach from the basement membrane. The following equation, FIG. 27V, supports that transition, similar to the equation of FIG. 27I in Section G3.3.3:

Transit+(0.5 TransitM)+Detached=Detached+5 Keratinocyte;

The cell should be both in transition and a keratinocyte and so will not tolerate the presence of both Transit and Keratinocyte; differentiating cells consume away the Transit molecule, FIG. 27W:

Keratinocyte+Transit=Keratinocyte;

Once a cell has sufficiently transitioned from a stem cell, it has reached a transit amplifying state exhibiting production of TransitAmplifier molecule, FIG. 27X:

### [Transit 2, Stem −4] [TransitAmplifier]

Like other cells (see FIG. 27I and FIG. 27V), transit amplifying cells differentiate into keratinocytes upon detachment, FIG. 27Y:

TransitAmplifier+Detached=Detached+5 Keratinocyte;

Upon reaching a transit amplifier state, a cell begins to proliferate. With sufficient Proliferate molecule, the cell rapidly grows and divides, FIG. 27Z. The growth and division continues until the decay of the Proliferate molecule; in the preferred embodiment, this typically lasts three or four rounds of division.

### [Proliferate 2] [Division, Growth]

While in transition, the cell produced Prolif molecule to prepare for this prolific state (see FIG. 27T). The <MoleculeCatalog> includes an entry to prevent decay of the Prolif molecule:

### Prolif [1450, 10] 0;

Once a TransitAmplifier, all of the previously produced Prolif molecule can become Proliferate molecule with the following equation, FIG. 27AA:

TransitAmplifier+Prolif=TransitAmplifier+Proliferate;

This example began with a single stem cell on the basement membrane. With the pathways described thus far, daughter cells from the initial cell either continue as stem cells in the same initial niche or differentiate to transit amplifying cells or keratinocytes. Therefore, only a single stem cell niche would form for the whole epithelium, yet the model should have some niches at intervals along the membrane. These niches form from transit amplifying cells that revert to stem cells when they are sufficiently far from other stem cells and have not yet detached from the basement membrane.

So far in the configuration file, only the StemAttachedToBasement molecule supports internal recognition of attachment and is only produced will the cell is a stem cell. One solution is to allow all cells to recognize contact with the basement membrane. Similar to those of FIG. 27G and FIG. 27H, these chemistry equations, FIG. 27BB and FIG. 27CC, allow all cells to produce TouchingBasement when in contact with the basement membrane:

{BasementMembrane}+(CellMembrane)=(CellMembrane)+TouchingBasement; {BasementMembraneSignal}+(CellMembrane)=(CellMembrane)+TouchingBasement;

Just as with StemAttachedToBasement molecule, the production of Detached should be inhibited by TouchingBasement. The gene controlling production of Detached, added in Section G3.3.3, is amended:

### [Cell 1.5, StemAttachedToBasement −3.2, TouchingBasement −3.2] [Detached],

TouchingBasement is given a high (0.5) decay rate in the <MoleculeCatalog>, so that it only exists in the cell while in contact:

### TouchingBasement [2900, 10] 0.5

While a transit amplifier cell is still touching the basement membrane, it gains some potential to revert to stem cells, FIG. 27DD:

TransitAmplifier+TouchingBasement=10 RevertPotential;

If a cell has sufficient RevertPotential and is far enough away from another stem cell, the following gene will cause the cell to begin reversion, FIG. 27EE:

### [RevertPotential 2, StemNearby −4] [Revert]

The reversion process converts a cell's transition molecules (Transit and TransitM) to their stem cell counterparts (Stem, StemM, and StemBM) while maintaining Revert molecule, FIG. 27FF:

Revert+Transit+(0.5 TransitM)=Stem+(StemM)+(StemBM)+Revert+10 StemAttachedToBasement;

The example configuration now supports stem cell niches and transit amplifying cells. Further, while cells are in transition but still attached, they can establish new stem cell niches if sufficiently distant from other stem cells by reverting.

G3.3.5. Lipid Production and Cell Death

As differentiated cells rise to the surface of the epithelia, the model requires that they begin to produce lipids, eventually die, and slough off.

When the basement membrane was defined in section G3.3.1, gradient signals were added as a <Shade> to represent a general signal from the dermis layer. This signal can be used by cells to recognize their distance from the basement membrane and so begin to produce lipids when sufficiently far.

As keratinocytes are pushed further away from the basement membrane they begin to produce lipids, FIG. 27GG, and eventually die to be sloughed off, FIG. 27HH:

### [Keratinocyte 3, BasementSignal −3] [ProduceLipids], [ProduceLipids 0.3] [Death]

The cell's reception of the basement signal determines the range of lipid production. This reception can be attenuated as desired by either adjusting the signal gradients under <Shade> or by adjusting the coefficient of the signal received in the cell. The equation below uses the latter technique, FIG. 27II:

{BasementSignal}+(CellMembrane)=(CellMembrane)+0.9 BasementSignal;

### G3.3.6. Completed Example

In practice with the preferred embodiment, the configuration so far works but the initial cells differentiate too quickly to allow a critical mass of stem cells to form. This can be attenuated by adding a new Delay molecule to the structural region of the gene that produces Detached molecule upon cell detachment. FIG. 27JJ depicts the final configuration for this gene.

[Cell 1.5, StemAttachedToBasement −3.2, TouchingBasement −3.2, Delay −5] [Detached],

This new Delay molecule must then be added to the <InitialChemistry>:

### Delay 100

With Delay not included in the <MoleculeCatalog>, the default decay rate of 10% will be applied to act as a countdown in the initial cells before they begin to detach. This can be further attenuated by either changing the initial value of the molecule under <InitialChemistry> or adding it under the <MoleculeCatalog> with a different decay rate.

The final configuration is below:

<CsIndividual>
<MoleculeCatalog>

| | |
|---|---|
| Stem | [100, 10] 0; |
| StemM | [150, 10] 0; |
| StemBM | [180, 10] 0; |

CellMembrane [300, 10] 0;

| | |
|---|---|
| Cell | [400, 10] 0; |
| Transit | [1400, 10] 0; |
| Prolif | [1450, 10] 0; |

```
    Keratinocyte [2000, 10] 0;
    StemNearby [2600, 10] 0.5;
    TouchingBasement [2900, 10] 0.5;
    BasementMembrane [8000, 10] 0;
    BasementSignal [6000, 10];
  </MoleculeCatalog>
  <Simulation>
    <Physics>
      <TimePerStep>.2</TimePerStep>
      <DampingMultiplier>1</DampingMultiplier>
      <RepulsionMultiplier>2</RepulsionMultiplier>
      <NudgeMagnitude>3</NudgeMagnitude>
    </Physics>
    <Signal>
      <Local>
        <Separation>.3</Separation>
      </Local>
    </Signal>
    <ECMDefinitionRules></ECMDefinitionRules>
    <BasementMembrane>
      <Bounds>[−22, −2.5, −5][28, −1.0, 7]</Bounds>
    <Cell>
      <Chemistry><Default/></Chemistry>
      <Promoter>
        <Smooth>
          <PromotionMidpoint>6</PromotionMidpoint>
          <ActiveConcentration>1</ActiveConcentration>
        </Smooth>
      </Promoter>
      <InitialChemistry>
        Rigidity 10
        Elasticity 10
        BasementMembrane 10
        (BasementMembrane) 10
      </InitialChemistry>
      <ChemistryEquations>
        (BasementMembrane) =
          (BasementMembrane) + { 50 BasementMembraneSignal };
      </ChemistryEquations>
    </Cell>
    <Genome>
    [
      [ BasementMembrane 2.8 ][ Rigidity ],
      [ BasementMembrane .2 ][ Elasticity ]
    ]
    </Genome>
  </BasementMembrane>
  <Cell>
    <Chemistry><Default/></Chemistry>
    <Promoter>
      <Smoother>
        <PromotionMidpoint>5</PromotionMidpoint>
        <Slope>10</Slope>
        <ActiveConcentration>1</ActiveConcentration>
      </Smoother>
    </Promoter>
    <MaximumSize>50</MaximumSize>
    <InitialSize>8</InitialSize>
    <MinimumSize>6</MinimumSize>
    <ECMProductionRules></ECMProductionRules>
    <InitialChemistry>
      Delay 100
      Cell 10
      (CellMembrane) 50
      Stem 50
      (StemM) 50
      (StemBM) 50
    </InitialChemistry>
    <ChemistryEquations>
      { StemM } + (StemM) = (StemM) + .2 StemContact;
      { BasementMembraneSignal } + (StemBM) =
        (StemBM) + StemAttachedToBasement;
      { BasementMembrane } + (StemBM) =
        (StemBM) + StemAttachedToBasement;
      { BasementMembraneSignal } + (CellMembrane) =
        (CellMembrane) + TouchingBasement;
      { BasementMembrane } + (CellMembrane) =
        (CellMembrane) + TouchingBasement;
      Stem + (StemM) = Stem + (StemM) + { StemSignal };
      { StemSignal } + (CellMembrane) =
        (CellMembrane) + .7 StemNearby + { .5 StemSignal };
      DiffReceiver = (DiffReceiver);
      DiffSignal + (CellMembrane) = (CellMembrane) + { DiffSignal };
      { DiffSignal } + (DiffReceiver) =
        (DiffReceiver) + 2 DiffPotential;
      {BasementSignal} + (CellMembrane) =
        (CellMembrane) + .9 BasementSignal;
      Stem + (StemM) + (StemBM) + Differentiate =
        Transit + (.5 TransitM) + .3 Prolif;
      Revert + Transit + (.5 TransitM) =
        Stem + (StemM) + (StemBM) + Revert +
        10 StemAttachedToBasement;
      TransitAmplifier + Prolif = TransitAmplifier + Proliferate;
      TransitAmplifier + TouchingBasement = 10 RevertPotential;
      Stem + (StemBM) + (StemM) + Detached = Detached +
      5 Keratinocyte;
      Transit + (.5 TransitM) + Detached = Detached + 5 Keratinocyte;
      TransitAmplifier + Detached = Detached + 5 Keratinocyte;
      Keratinocyte + Stem + (StemBM) + (StemM) = Keratinocyte;
        Keratinocyte + Transit = Keratinocyte;
        NichePotential + Stem = Stem + Niche;
      </ChemistryEquations>
      <DivisionRules>
        .1 Stem perpendicular (StemBM);
      </DivisionRules>
    </Cell>
    <AdhesionRules>
      ( BasementMembrane ) : ( StemBM );
      ( BasementMembrane ) : ( TransitM );
    </AdhesionRules>
    <FixedSpheres>
      [0,−5,0] 7,
      [17,−5,0] 7,
      [−17,−5,0] 7,
      [−10000,0,0] 9975,
      [10000,0,0] 9975,
      [0,0,−10000] 9997.5,
      [0,0,10000] 9997.5,
      [0, −10000, 0] 9996
    </FixedSpheres>
  </Simulation>
  <Genome>
  [
    [ Cell .4 ][ Rigidity ],
    [ Cell .2 ][ Elasticity ],
    [ Cell .6 ][ Plasticity ],
    [ LegitStem 1, StemContact −0.87, Detached −2 ] [ Division,
    Growth ],
    [ Stem 0.7,
      Transit −3,
      StemNearby 0.4,
      DiffPotential −3,
      NichePotential .25 ]
      [ NichePotential ],
    [ Stem 2 ] [DiffReceiver ],
    [ Niche 1, DiffPotential −2 ] [ DiffSignal ],
    [ DiffPotential 4, Niche −6 ] [ Differentiate ],
    [ Transit 2, Stem −4 ] [ TransitAmplifier ],
    [ Stem 2, Transit −4 ] [ LegitStem ],
    [ RevertPotential 2, StemNearby −4 ] [ Revert ],
    [ Cell 1.5,
      StemAttachedToBasement −3.2,
      TouchingBasement −3.2,
      Delay −5 ]
      [ Detached ],
    [ Proliferate 2 ] [ Division, Growth ],
    [ Keratinocyte 3, BasementSignal −3 ] [ ProduceLipids ],
    [ ProduceLipids .3 ] [ Death ]
  ]
  </Genome>
  <Shade>
    <UseRadius/>
    <UseModifier/>
    [
      S [6000,10] @ 17 −6 0 10 0.8 1 10,
      S [6000,10] @ 0 −6 0 10 0.8 1 10,
      S [6000,10] @ −17 −6 0 10 0.8 1 10
    ]
  <Shade>
</CsIndividual>
```

Although the invention has been described with respect to particular examples, embodiments, and application, it will be appreciated how various changes and modification may be made without departing from the claims. In particular, it will be appreciated how one can modify prepared models of tissue type and tissue development, such as the three detailed above, or prepare new models to computationally simulate cellular tissues having a desired shape, cell composition, and properties.

What is claimed is:

1. A method for computer modeling, in a virtual environment, a virtual multicellular tissue having the emergent properties of self-repair, adaptive response to an altered environment or cellular differentiation, comprising the steps:
(a) assigning to a virtual biological cell, a heritable virtual genome containing a set of virtual genes, each gene having a gene-control region that specifies the activity of the gene in response to virtual molecules in the virtual environment, and a structural region that specifies the type of molecule or molecules produced by the gene, where the molecules produced by the genes include at least one related to each of (a1) intercellular adhesion, (a2) cell division, (a3) cell growth, (a4) intercellular signaling, and (a5) cell differentiation;
(b) assigning (b1) chemical-interaction rules that govern the extra-genetic behavior of one or more molecules placed or produced in the virtual cells or in the extra-cellular environment of the cells, (b2) action rules that specify a cell's adhesion, growth, or division condition, in response to one or more molecules produced by a cell's gene relating to intercellular adhesion, cell growth, or cell division, respectively, and (b3) physical-interaction rules that govern how a cell will move in response to its own growth or division or the growth or division of neighboring cells,
(c) placing at least one such virtual cell in an environment optionally containing at least one molecule capable of activating a gene within the cell, through interaction with the control region of that gene;
(d) updating the state of each virtual cell in said environment, by (d1) updating the status of molecules produced by the genes in the cell, (d2) applying said chemical-interaction rules to update the status of the molecules present in the cell and, optionally, in the environment, (d3) applying said action rules to update the actions taken on or by each cell relating to cellular adhesions, growth, and division, and (d4) applying said physical-interaction rules to update the positions of the cell; and
(e) repeating step (d) until a virtual tissue having one or more desired emergent properties develops.

2. The method of claim 1, wherein each cell's genome contains genes whose gene products, either by themselves or acting through a chemical-interaction rule, function to
(a1) trigger an action rule relating to intercellular adhesion properties of the cell;
(a2) trigger an action rules relating to division,
(a3) trigger an action rule relating to cell growth,
(a4) produce molecules that are transmitted and received, to support intercellular signaling between cells, and
(a5) trigger cell differentiation.

3. The method of claim 2, wherein said action rules include rules relating to the plasticity, elasticity, and rigidity of a cell adhesion, and at least one gene whose gene product triggers said action rules relating to intercellular adhesion properties includes at least one of (a1i) a single gene that produces multiple molecules relating to plasticity, elasticity, and rigidity, or (a1ii) multiple genes that produce single molecules relating plasticity, elasticity, and rigidity.

4. The method of claim 2, wherein said genome includes (a4i) at least one gene whose gene product is a signaling molecule capable of being transported by said chemical-interaction rules to the extracellular environment and (a4ii) at least one gene whose gene product is a receptor capable of being transported by said chemical-interaction rules to the cell surface, where it can interact with signaling molecules in the extracellular environment through the chemical-interaction rules.

5. The method of claim 2, wherein said genome includes (a5i) at least one gene that produces a molecule transported by said chemical-interaction rules to the extracellular environment and (a5ii) at least one gene that produces a molecule transported by said chemical-interaction rules to the cell surface to act as a receptor, where it can interact with molecules in the extracellular environment, through the chemical-interaction rules, to further promote the production of additional molecules to act as similar receptors and optionally inhibit the production of molecules that act as dissimilar receptors and so promote cell differentiation.

6. The method of claim 5, wherein a cell containing said gene is specialized through cell differentiation such that it can no longer revert to a non-specialized state even without the continued reception of molecules from the extracellular environment.

7. The method of claim 2, wherein said action rules include a rule relating to cell death, and each cell's genome also includes a gene whose gene product can, either by itself or acting through a chemical-interaction rule, trigger said action rules relating to cell death.

8. The method of claim 1, wherein the cells are not constrained to occupy specific coordinates in space, and said physical interaction rules include rules for calculating intercellular forces, based on the degree of overlap between or among the cells or the extent of separation of cells and the properties of the adhesion connections between or among the cells, and step (d) includes, for each updating step, performing a selected number of cell-movement steps designed to resolve intercellular overlaps or separations.

9. The method of claim 8, wherein each cell is assigned a spherical shape that is preserved through cell growth and cell division, and the intercellular forces are applied between the centers of cells having intercellular adhesions.

10. The method of claim 1, wherein the cells are not constrained to occupy specific coordinates in space, and each cell is treated as a bag of spherical subcells that have intracellular adhesions between or among adjacent subcells of the same cell, and intercellular adhesions between or among subcells contained in different cells, and said physical interaction rules include rules for calculating intracellular and intercellular forces between or among subcells that are connected by intracellular or intercellular adhesions, respectively, based on the degree of overlap between the subcells or the extent of separation of the subcells, and the properties of the adhesion connections between or among the subcells, and step (d) includes, for each updating, performing a selected number of subcell-movement steps designed to resolve intersubcell overlaps or separations.

11. The method of claim 9, wherein said action rules that govern cell division function to (i) divide the subcells making up a cell into non-interadhering sets of one or more subcells each, and (ii) separate the sets into separate cells, each composed of one or more subcells where any multiple subcells have intracellular adhesions.

12. The method of claim 10, wherein a cell may be predisposed toward adopting a new cell differentiation state in accordance with the spatial arrangement or location of subcells making up the cell.

13. The method of claim 1, which further includes employing a visualization module to allow user visualization of a developing tissue and adjustment of the model by changing one of more inputs selected from the group consisting of: (i) the types or gradients of molecules in the environment; (ii) one or more chemical-interaction rules; (iii) one or more action rules, (iv) one or more physical-interaction rules, and (v) a change in the control or molecule(s) produced by a gene.

14. The method of claim 1, which can generate a multi-cellular tissue at a state of maturity in which (i) the status of the cells is invariant over time, (ii) the condition of at least some of the cells is oscillating around a stable cell condition, or (iii) cells that are dying are being replaced by newly dividing cells.

15. The method of claim 1, which further includes one of:
(a) perturbing the shape of the tissue at homeostasis, and applying steps (d) and (e) until the tissue returns to its state of homeostasis;
(b) changing the signals present in the environment, with the tissue at homeostasis, and applying step (d) and (e) until the tissue return to its state of homeostasis, and
(c) killing or removing cells from the tissue, with the tissue at homeostasis, and applying steps (d) and (e) until the tissue return to its state of homeostasis;

16. A multi-cellular virtual tissue having the emergent properties of self-repair, adaptive response to an altered environment, or tissue differentiation, comprising
(a) a plurality of virtual cells, each having a heritable virtual genome containing a set of virtual genes, each gene having a gene-control region that specifies the activity of the gene in response to virtual molecules in the virtual environment, and a structural region that specifies the type of molecule or molecules produced by the gene, where the molecules produced by the genes include at least one related to each of (a1) intercellular adhesion, (a2) cell division, (a3) cell growth, (a4) intercellular signaling, and (a5) cell differentiation, where
(b) the operation and actions of the genes are guided by (b1) chemical-interaction rules that govern the extra-genetic behavior of one or more molecules placed or produced in the virtual cells or in the extra-cellular environment of the cells, (b2) action rules that specify a cell's adhesion, growth, or division condition, in response to one or more molecules produced by a cell's gene(s) relating to intercellular adhesion, cell growth, or cell division, respectively, and (b3) physical-interaction rules that govern how a cell will move in response to its own growth or division or the growth or division of neighboring cells, and where
(c) the tissue is produced by iteratively updating the state of each cell by applying said gene control and molecule production, chemical-interaction rules, action rules, and physical-interaction rules to the existing state of each said cell.

17. The tissue of claim 16, which is formed by the steps of placing at least one such virtual cell in an environment optionally containing at least one molecule capable of activating a gene within the cell; updating the state of each virtual cell in said environment, by (c1) updating the status of products produced by the genes in the cell, (c2) applying said chemical-interaction rules to update the status of the molecules present in the cell and, optionally, in the environment, (c3) applying said action rules to update the actions taken on or by each cell relating to cellular adhesions, growth, and division, and (c4) applying said physical-interaction rules to update the positions of the cell; and repeatedly updating until a virtual tissue having one or more desired emergent properties develops.

18. The tissue of claim 16, which contains at least one pluripotent cell capable of division and differentiation toward non-pluripotent cell types, and at least one or more non-pluripotent cell types.

19. The tissue of claim 18, composed of different layers of cells, where the cells in a given layer are specialized differently than those in another layer of the tissue.
